(19) United States
(12) Patent Application Publication
(10) Pub. No.: US 2013/0266380 A1
(43) Pub. Date: Oct. 10, 2013

(54) Systems and methods for off-shore energy production and CO2 sequestration

(71) Applicants: Mark E. Capron, Oxnard, CA (US); Frank W. Sudia, Washington, DC (US); James R. Stewart, Los Angeles, CA (US); Mohammed A. Hasan, Ventura, CA (US)

(72) Inventors: Mark E. Capron, Oxnard, CA (US); Frank W. Sudia, Washington, DC (US); James R. Stewart, Los Angeles, CA (US); Mohammed A. Hasan, Ventura, CA (US)

(73) Assignee: PODenergy, Inc., Ventura, CA (US)

(21) Appl. No.: 13/781,597

(22) Filed: Feb. 28, 2013

Related U.S. Application Data
(63) Continuation-in-part of application No. 11/985,196, filed on Nov. 13, 2007.
(60) Provisional application No. 61/673,483, filed on Jul. 19, 2012.
(60) Provisional application No. 61/718,155, filed on Oct. 24, 2012.

(51) Int. Cl. F16L 1/24

(52) U.S. Cl. CPC F16L 1/24
USPC 405/184.4

(57) ABSTRACT

The present invention is directed to aquatic systems and methods for off-shore energy production, and particularly to systems and methods for generating large amounts of methane via anaerobic digestion, purifying the methane produced, and sequestering environmentally deleterious by-products such as carbon dioxide. The energy production systems contain one or more flexible, inflatable containers supported by water, at least one of which is an anaerobic digester containing bacteria which can produce energy sources such as methane or hydrogen from aquatic plants or animals. The containers of the present invention can be large enough to provide adequate amounts of energy to support off-shore activities yet are relatively easy to manufacture and ship to remote production sites. The systems can also be readily adapted to sequester carbon dioxide or recycle nutrients for growing feedstocks on site.

### 1. PRIORITY

This application is a Continuation-in-Part of pending U.S. patent application Ser. No. 11/985,196 filed Nov. 13, 2007, and is a non provisional of multiple US Provisional Patent Applications listed on the Application Data Sheet filed herewith, both expired and non-expired, each of which is hereby incorporated by reference in its entirety.

### 2. OWNERSHIP

This application, its parent case, and all other applications cited herein are owned by or will be assigned to PODenergy, Inc., a California corporation. All inventors have been under a written invention agreement with PODenergy, Inc. at all applicable times

### 3. BACKGROUND

The technical background for this application is provided in its parent case, U.S. patent application Ser. No. 11/985,196 filed Nov. 13, 2007, published as Publication No. 20100284749, which is hereby incorporated by reference in its entirety.

When operating a process immersed in water, the support of the water allows for relatively thin and inexpensive materials to contain the process. This is especially important for the PODenergy's systems, where the valves may be tens of meters in diameter and the underwater containers may be hundreds of meters in diameter.

Thin and inexpensive implies an anaerobic digestion container can be more like a jellyfish than a steel tank. In addition to the container, chemical and biologic process equipment consists of valves, pipe, fittings, pumps, and the like. The material below will explain new equipment and processes designed specifically for the in-water situation.

### BRIEF DESCRIPTIONS OF THE DRAWINGS

FIGS. 1-3 [these numbers were skipped]

FIG. 4 is an elevation of a system for condensing CO2 to a pure liquid while recovering pure CH4 gas.

FIGS. 5a-c show an elevation of a container being lined while floating below the ocean surface.

FIGS. 6a-c show longitudinal and transverse sections showing the action of a tube valve.

FIGS. 7a-c show transverse sections of drawstring valve.

FIGS. 8a-c show longitudinal and transverse sections of a flexible bladder valve.

FIGS. 9a-b show cross sections of a Python Waterlock in operation moving BoB.

FIGS. 10a-b show cross sections of a Python Waterlock in operation dewatering a BoB.

FIGS. 11a-c show cross sections of Inflate-a-lock Joints during pipeline construction.

FIGS. 12a-c show cross sections of Inflate-a-ziplock pipe joining operations.

FIGS. 13a-c show cross sections of forward osmosis in flexible container showing flow direction reversal.

FIGS. 14a-b show cross sections of BoB and BoN bobbing in a digestion container.

FIG. 15 is a cross section showing balloons recovering dissolved gas energy with a cable.

FIG. 16 is an elevation of tow-rope algae harvest and nutrient dispersal.

FIGS. 17a-c show plan views of three tow-rope locations in order to harvest the quadrant of a circle.

FIG. 18 is a cross section of a self-repairing liquid CO2 container on the sea floor.

FIG. 19A is a cross section showing the start of construction of the liquid skin.

FIG. 19B is a cross section showing deployed liquid skin and filling with liquid CO2.

FIG. 19C is a cross section showing multi-eon containment of liquid CO2 with cover of new ooze.

FIG. 20 is a cross-section of a tube dam supporting a liquid CO2 container.

FIGS. 21a-b present an overview of a liquid CO2 tube filling transition on the sea floor.

FIG. 22 shows a cross section of robots (AUVs) repairing a container from inside and outside.

FIGS. 23a-c show side views of a waterlock port for AUVs with docking connections on each side.

FIG. 24 shows longitudinal elevation and transverse sections of thin pipe with bar valves.

FIG. 25 is a schematic diagram of a segment of an underwater pipeline.

FIG. 26 is a schematic diagram of a pipeline segment with a redundant telecom line.

FIG. 27 shows plan and end-on views of sealing bar valves, open and closed.

FIG. 28 is a carbon dioxide phase diagram showing a portion of its supercritical region.

FIG. 29 is a cross section of process of extracting oil from algae with submerged supercritical CO2.

FIG. 30 is a profile of two-part container with internal upwelling current for minimum CO2.

FIG. 31 is a cross section of in-vessel liquid CO2 harvesting with CH4 bubbles.

FIG. 32 is a cross section of in-vessel liquid CO2 harvesting with seawater spray.

FIG. 33 is a chart portraying CO2 solubility depending on pressure and temperature.

FIG. 34 is a chart portraying pressure-temperature of CO2 gas-liquid phase change.

FIG. 35 is an elevation of pressure-temperature degassing of dissolved CO2.

FIGS. 36a-b show profiles of floating kelp forests at different anchor root-rock depths.

FIG. 37 shows a plan and elevation of geogrid kelp root netting.

FIG. 38 is a map of the five major oceanic gyres.

FIG. 39 is a map of ocean currents around the Sargasso Sea.

FIG. 40 is a map of Sargasso Sea, rendered figuratively as a region of seaweed.

FIG. 41 is a map of worldwide ocean conveyor-belt currents.

FIG. 42 is an overview of an inverted ski-jump type current barrier on the ocean floor.

FIG. 43 is a vertical cross section of a sine wave type current barrier on the ocean floor.

FIG. 44 is an isometric view of a current barrier supported by non-rolling water-filled tubes.

FIGS. 45a-b show a profile of moving a submerged process.

FIG. 46 is a schematic diagram of a prior art synthetic fuels manufacturing process.

FIG. 47 is a schematic of an F-T process integrated within an underwater PODenergy process.

FIGS. 48a-b show a cross-section of glass spheres in a matrix and elevation of completed cylinder.

FIGS. 49a-c are sections showing stages of honeycomb structure insulation.

FIGS. 50a-c show vertical cross-sections of submerged compressor with 3 stages of gas compression.

FIG. 51 shows a vertical section of reverse osmosis tubes in ocean based desalination.

FIG. 52 shows an elevation of a suspension structure (inverted suspension bridge) for submerged gas pipeline.

FIGS. 53a-c show cross sections of pipe break points with repair tees.

FIGS. 54a-d show longitudinal and transverse sections of placing pipe in seafloor ooze.

FIG. 55 shows a vertical section of a prior art mechanical root.

FIG. 56 shows a profile of mechanical root horizontal installation.

FIG. 57 shows a cross section of a worm with boring machine.

FIG. 58 shows transverse sections of procedures using water pressure to stiffen structure walls.

FIG. 59 shows a transverse section of seafloor ooze being compacted with hydrostatic pressure.

FIG. 60 shows a transverse section of Venturi current water pump.

FIG. 61 is a qualitative phase diagram for nitrogen.

FIG. 62 shows longitudinal and transverse sections of a supercritical, superconducting cable/pipeline.

FIG. 63 is a chart depicting liquid CO2 negative buoyancy zone (NBZ).

FIG. 64 shows multi-layered components of a prior art green roof system.

FIG. 65 shows a vertical cross-section of a liquid CO2 containing cell.

FIG. 66a shows a vertical cross-section of a vertical tube containing liquid CO2.

FIG. 66b shows a vertical cross-section of a near-constant hoop stress tank.

FIGS. 67a-b show a transverse section (a) and longitudinal section (b) of double-walled non-rolling tube.

FIG. 68 is a chart showing predictions (and experimental data) of equilibrium pressure of CO2 hydrate CO2-H2O.

FIG. 69 is a chart showing predictions (and experimental data) of equilibrium pressure of CH4 hydrate CH4-H2O.

FIGS. 70a-b are transverse sections showing the use of hydrostatic pressure to stiffen walls.

FIG. 71 is a cross section of water-swimming mechanical root guide on a cable, installing a pipe or cable under water.

FIGS. 72a-d are cross sections of ooze-swimming mechanical root, installing a container.

FIGS. 73a-d are cross sections of self-anchoring mechanical root guide with spoils pipe.

FIG. 74 is a schematic diagram of the prior art SIMTECHE process.

FIG. 75 is an overview of an array of sonar emitters supported above the seafloor by floats.

FIG. 76 is an overview of an array of sonar emitters on a deep platform.

FIG. 77 is an overview of a single seafloor attachment of an intermediate depth sonar array.

FIG. 78 is an overview of a sonar emitter array around and beside undersea facilities.

FIG. 79 is a photo of methane actively dissociating from a hydrate mound.

FIG. 80 is a phase diagram of methane hydrate phases.

FIG. 81 is a phase diagram of specific hydrate stability for arctic permafrost.

FIG. 82 is a phase diagram of typical occurrence of the gas hydrate stability zone.

FIG. 83 is a phase diagram showing that methane hydrates are unstable at sub-polar latitudes.

FIG. 84 is a vertical cross section of seafloor sediments containing methane hydrate.

FIG. 85 is a vertical cross section of removing ice and harvesting hydrates with an HHH process.

FIG. 86 is a vertical cross section of removing ice and harvesting hydrates with an HHH process

FIG. 87 is a vertical cross section of forming ice and CO2-hydrate with an HHCC process.

FIG. 88 is a chart showing formation and stability criteria for CO2 liquid, CO2-hydrate and CH4-hydrate.

FIG. 89 is a vertical cross section of harvesting CH4-hydrate while forming CO2-hydrate, via the HHWSC process.

FIGS. 90a-b show vertical cross sections of hydrostatic process equipment construction.

FIG. 91 shows a vertical cross section of a potential heat exchanger design with a flexible encasement.

FIG. 92 shows a cross section of potential heat exchanger design when process fluids are below ambient pressure.

FIG. 93 shows a cross section of a single membrane tube, with changes in water composition.

FIG. 94 shows a system schematic of nutrient processing with single pass filtrate and a multiple pass burner.

FIG. 95 shows a system schematic of nutrient processing with double-pass filtrate.

FIG. 96 is a chart showing approximate material densities as a function of depth.

FIG. 97 is a chart showing conditions for CO2 hydrate formation (Rui 2005).

FIG. 98 is a chart showing gas barrier properties of EVOH vs. HDPE.

FIG. 99 is a chart showing oxygen transmission rates for potential container materials.

FIG. 100 is a photo of Bentomat ST, a reinforced geosynthetic clay liner.

FIG. 101 is a photo of Bentomat CLT, a reinforced geosynthetic clay liner.

FIG. 102 shows a cross section and schematic of carbonate cycle via fish intestines (from Wilson et. al.)

FIG. 103 is a chart providing a comparison of chemical and physical characteristics of portland cement, fly ash, slag cement, and silica fume (from Wikipedia).

### 4. SEPARATING CH₄ AS CO₂ LIQUEFIES

### Capron, 61/280,280

Because CH₄ dissolves in seawater, although only a tenth as much as carbon dioxide, the captured CO₂ will have some CH₄. That is, some residual CH₄ will also come out of solution along with CO₂ as pressure is reduced.

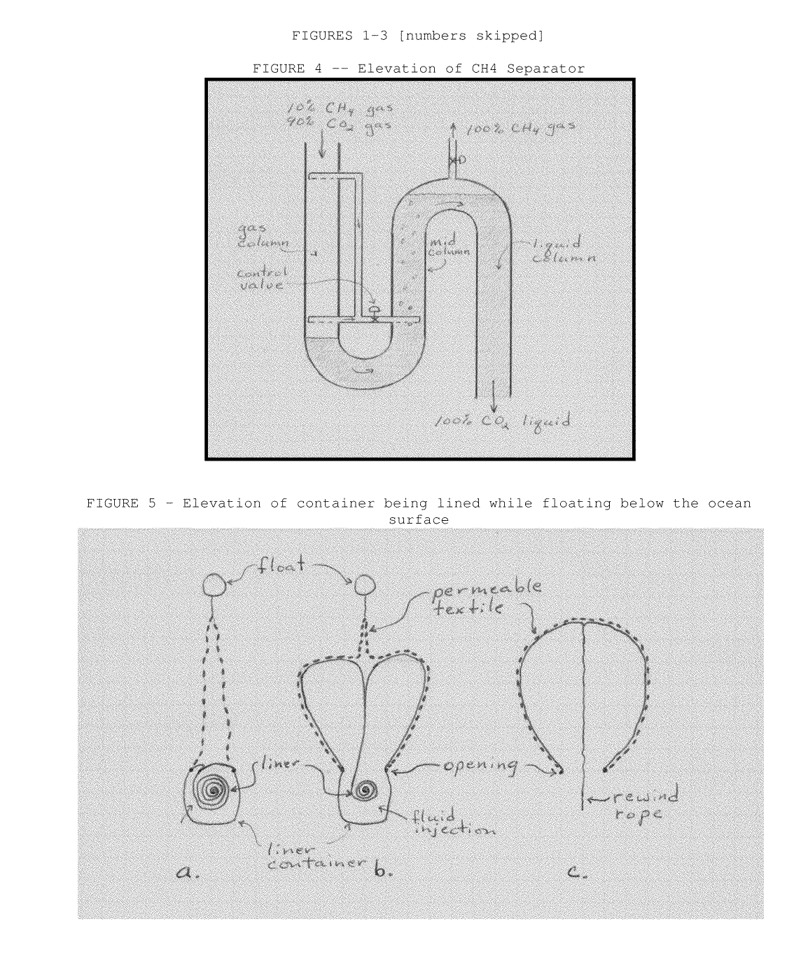

When this 90% CO₂ gas is compressed to the pressure and temperature typical of 500 meters deep in the ocean, it will convert to a liquid. FIG. 4 shows one way to capture the remaining CH₄. (Note that FIGS. 1-3 have been skipped.)

The 90% CO₂ with 10% CH₄ is compressed into the gas column. As the CO₂ liquefies, the gas column become rich in CH₄. The CH₄ rich gas is allowed to migrate into the mid column through a control valve. In the mid column, the CH₄ rich gas bubbles through liquid CO₂, which scrubs the CO₂ from the CH₄. The gas is driven from the gas column to the mid column by allowing the pure methane to escape through a control valve at a rate that keeps mid column pressure below gas column pressure.

TABLE A
Conditions for liquid CO₂

| Cooling water | | |
|---|---|---|
| temperature | Pressure | Pressure |
| (deg C.) | (bar) | (psi) |
| 25 | 59 | 861 |
| 20 | 54 | 792 |
| 15 | 49 | 723 |
| 10 | 44 | 652 |
| 5 | 39 | 581 |

The operation of a 10,000 hectare algae forest would generate approx. 3,000 cubic feet per minute of the 90% CO₂ gas. The gas would be pressurized and conveyed to depth with a 6-inch diameter pipe that is 500 meters long. The liquid occupies less space and may need only 4-inch diameter pipe for conveyance to depths below 2,500 meters, where the liquid CO₂ is denser than seawater. For either gas or liquid pipe, the pipe wall supports the difference in pressure between inside and outside; therefore the pipe wall can become thinner with depth.

The device of FIG. 4 may be located at the depth of the desired pressure and temperature, which is about 500 meters deep. Or it can be located at the surface or any depth. Also, one may convey deeper and cooler water to the device in order to improve the efficiency of the compressor, reduce the required pressure, or reduce the diameter of the pipe.

Note that CO₂ is sometimes used as a refrigerant, meaning energy can be recovered from the phase change. The condensing CO₂ will warm the surrounding (or conveyed) seawater. Low-temperature versions of geothermal heat engines such as those produced by United Technologies or Electratherm would be appropriate for recovering energy to assist powering the gas compression.

CO₂ is being considered as a working fluid for Ocean Thermal Energy Conversion (OTEC). While OTEC is less sustainable than the PODenergy process because it mines deep ocean cool water and incidentally moves nutrients, OTEC may be operated in coordination with the PODenergy process.

Also, high concentrations of CO2 in seawater may be converted into a solid using the Calera, www.calera.biz, process. The Calera product can be a cement, as of October 2009, it is being produced as sand (small particles that are the aggregate in cement).

### 5. ADDING AN IMPERVIOUS LINER

### Capron, 61/280,280

Remarkable economic and structural efficiency for an impermeable tensile container is obtained with a permeable strength textile and a thin impervious liner. One way to install a thin liner is to turn the liner inside out into the container as the liner comes off a reel or unfolds. The process is similar to the Insituform sewer pipe lining inversion method as shown at http://www.insituform.com/content/190/insituform_cipp_process.aspx.

FIG. 5 depicts the process of lining a porous textile container while the container is in the ocean. The float is several meters below the ocean surface, which is not shown. A mooring system, also not shown, restrains the container and float from rising. The stored liner (inside the liner container) is either folded or rolled at its point of manufacture. The liner is prefabricated as a closed tube or balloon with one opening to roughly fit the permeable textile container, once inverted into place. The liner container is an impermeable bag surrounding the stored liner.

In FIG. 5a, opening of the liner and the opening of the liner container are attached to the opening in the permeable textile container. When seawater is injected into the liner container, the higher pressure in the liner container forces the liner to invert into the permeable textile container. In FIG. 5b the lining process is half complete. The fluid that was inside the permeable textile container exits through the permeable textile. FIG. 5 does not show restraint, but the stored liner that remains within the liner container is restrained within the liner container. The restraint may be a friction brake the axis of the roll of stored liner or by exiting the fold-stored liner through a pair of pinching rollers. The restraint “meters” the liner so it does not move into the permeable textile container too fast.

After the liner is completely installed, a “rewind rope” shown in FIG. 5c can be left attached to the end of the liner. At some time in the future, pulling on the rewind rope would reverse the entire process. That is pulling on the rewind rope and winding up or folding the liner will extricate and invert the liner while emptying the contents of the container.

Inserting and extricating the liner can occur in any orientation or container shape. That is the liner container may be attached to the side of a horizontal tube, or to the top of a horizontal tube, or the top of a container and inverted downward. The liner may also be inserted into the container using air as the working fluid. Air-as-fluid may be more appropriate when the liner is inserted at the factory so that the completed assembly arrives at the point of use ready to “inflate.” The factory prefabrication may occur with the permeable textile container lying on the ground or suspended with cables in air.

This inversion process makes multiple liners in the same container for multiple tasks relatively easy. For example, one could install a liner that is primarily impermeable to water. Then follow with a liner that provides insulation. Then follow with a liner that is less permeable to methane. Or follow with a liner that has a top portion of methane impermeable material bonded to a less expensive material.

### 6. IN-WATER PROCESS VALVES

### Capron, 61/335,811

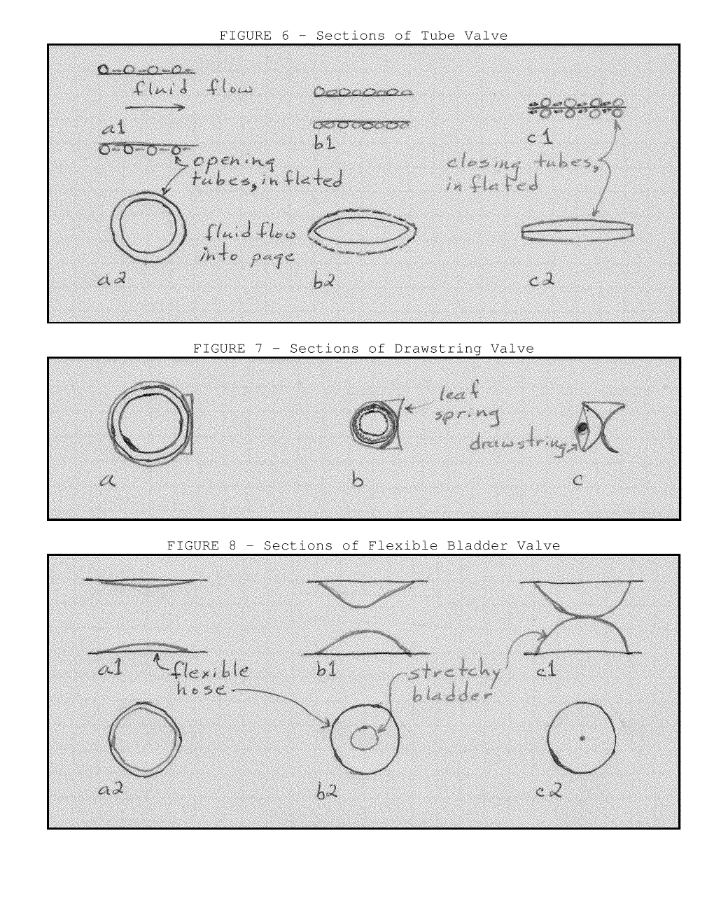

FIG. 6 shows a Tube Valve. Series a1-c1 is a side view series of three stages from full open in a1 to full closed in c1. The corresponding “head on” views are a2-c2. In a1 and a2, a flexible hose is held open by one or more inflated tori. That is, the hose is cylindrical in shape. The opening tori are like bicycle tubes. There are closing tubes adjacent to the opening tori. In b1 and b2, both the opening torus and the closing tube have some pressure that results in a partially closed valve. In c1 and c2, the closing tubes contain pressurized fluid and the opening tori are relaxed. That is, the hose is flattened, like an empty sack. In order to provide a tighter seal, the closing tubes may be tapered, with the largest diameter at the mid-point of the closing tube.

FIG. 7 shows a Drawstring Valve in “head on” view, with the fluid flowing into or out of the page. The valve is shown full open in a. and fully closed in c. The same kind of inflated tori from the Tube Valve holds the drawstring valve open in a. As the pressure inside the tori decreases, a drawstring cinches the hose closed. Any of several means may be employed to cinch the drawstring, including: a leaf spring (shown in FIG. 7), a coil spring, an elastic string, a compressed gas or hydraulic piston, a reel powered by a torsion spring, a reel powered by any rotary motor, etc.

FIG. 8 shows a Flexible Bladder Valve. Series a1-c1 is a side view series of three stages from full open in a1 to full closed in c1. The corresponding “head on” views with fluid flow into and out of the page are a2-c2. The hose is cylindrical in shape. The bladder is a flexible material, such as rubber or spandex, which stretches in order to close and contracts when open. Closing is accomplished by increasing the pressure in the volume between the flexible hose and the bladder. When the pressure is higher than that of the fluid in the flexible hose, the valve will be closed.

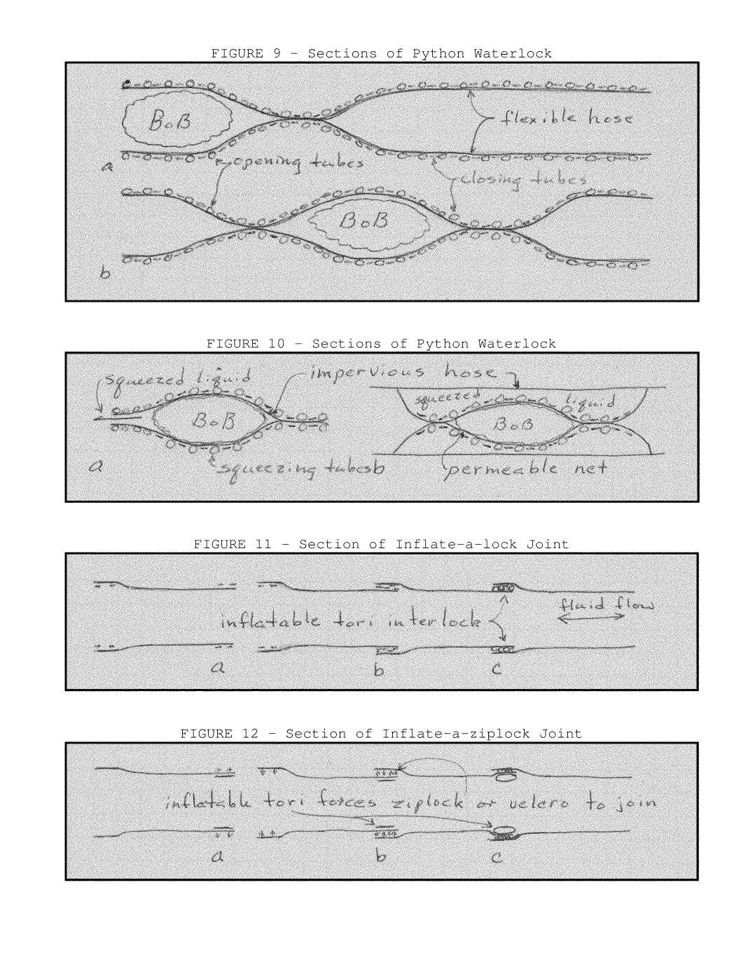

FIG. 9 is a side view of a series of flexible valves arranged along a flexible hose to form a Python Waterlock. The water or material flow is left to right. The valves may be any of those mentioned above or any valve with similar action. Series a-b show how alternating contraction and opening would move a bale of material with surrounding fluid along the flexible hose. Note that in addition to providing a waterlock, this arrangement of flexible valves provides:
A long series of valves;
A pump;
Dewatering of porous bales of pre- or post-digestion biomass or biosolids;
A sub-container for pre-treating biomass with low pH or other chemicals. In the PODenergy ecosystem, the low pH may be provided by dissolved CO₂; and
A plug flow anaerobic digestion process.
The squeezing action may be employed to mix the dissolved CO₂ throughout the biomass. The dewatering action would be employed to conserve the CO₂ by squeezing the low pH water into the following zone.

FIG. 10a shows dewatering with the Python Waterlock in side view. In this arrangement, a porous bale of biomass (BoB) is squeezed inside the Python Waterlock. The fluid that was surrounding or in the BoB is allowed to escape either behind or in front of the BoB. If the removed fluid can be returned to the surrounding environment, the valves may be contracting around a pervious tube (not shown).

FIG. 10b shows dewatering in a side view with a variation on Python Watertube. In this case, a stretchable netting is a permeable material surrounding a BoB or loose particles of biomass. An impermeable tube surrounds the stretchable netting, if the removed fluid is to be captured. Any of the contracting components of the valves mentioned above first seal off the front and back of the biomass containing fluid volume. Subsequent contractions around the biomass will force fluid from the BoB or the loose biomass. The removed fluid will be captured in the space between the impervious tube and stretchable netting.

### 7. IN-WATER TUBE EXTENDING OR CONTAINER EXPANDING

### Sudia, Capron

FIG. 11 shows the inflate-a-lock joint method for connecting two flexible hoses employing inflatable tori while in the water. The tori operate much like the Tube Valve of FIG. 6. Series a-c is a time-lapse side view starting with a pair of flexible hoses or rings of container wall. Once the hoses are generally positioned as in b, the interlocking tori are inflated as in c. The inflated tori also serve to maintain a circular cross-section for the flexible hose.

FIG. 12 shows inflate-a-ziplock joint method for connecting two flexible hoses employing a ziplock or Velcro. Series a-c is a side view. In this case, the inflatable tori might be partially inflated in step b. to maintain the shape of the flexible hose during mating. After positioning in step b, an inner torus is inflated which pushes the ziplock or Velcro together all around the “bell.” An exterior torus to push against the interior torus is optional. Both tori could be either permanent or portable, moving from joint to joint in the time between joint matings.

One can also envision stiffening the flexible hose or container walls by attaching inflatable tubes which are parallel to the direction of fluid flow, combined with a few shape-maintaining tori. These inflatable features would provide temporary stiffness for stabbing hoses or rings together or permanent stiffness for higher velocity fluid flow.

One can also envision mating the hoses and rings in a “deflated” situation. Deflated mating may be in or out of the water. The mating would be made with a large version of a ziplock zipping device.

### 8. IN-WATER FORWARD OSMOSIS EQUIPMENT

### Capron

The opposite of forward osmosis, reverse osmosis, uses mechanical pressure to overcome the osmotic pressure. Osmotic pressure is caused by water molecules seeking to further dilute a saline solution. If a water (but not salt) permeable membrane “balloon” full of saltwater solution is placed in a container of fresh water, the “balloon” will eventually explode as the fresh water permeates through the membrane into the balloon. The equipment for reverse osmosis must resist high pressures and therefore requires strong and stiff materials.

Forward osmosis relies on an abundance of some other dissolved molecules, like carbon dioxide or ammonia, to cause net osmotic pressure forcing the water from the seawater into the high CO₂ water. The dissolved CO₂ is easily removed by relieving pressure, leaving one with pure water. When the forward osmosis equipment is housed at one atmosphere, it might employ a pressure vessel to improve the maximum dissolved CO₂ concentration. When the forward osmosis process is performed in-water the only pressure difference between the inside and outside of the osmosis membrane is caused by the osmotic pressure. The osmotic pressure difference between the inside of the membrane and the outside of the membrane can be held near zero by draining off the fresh water as fast as it accumulates.

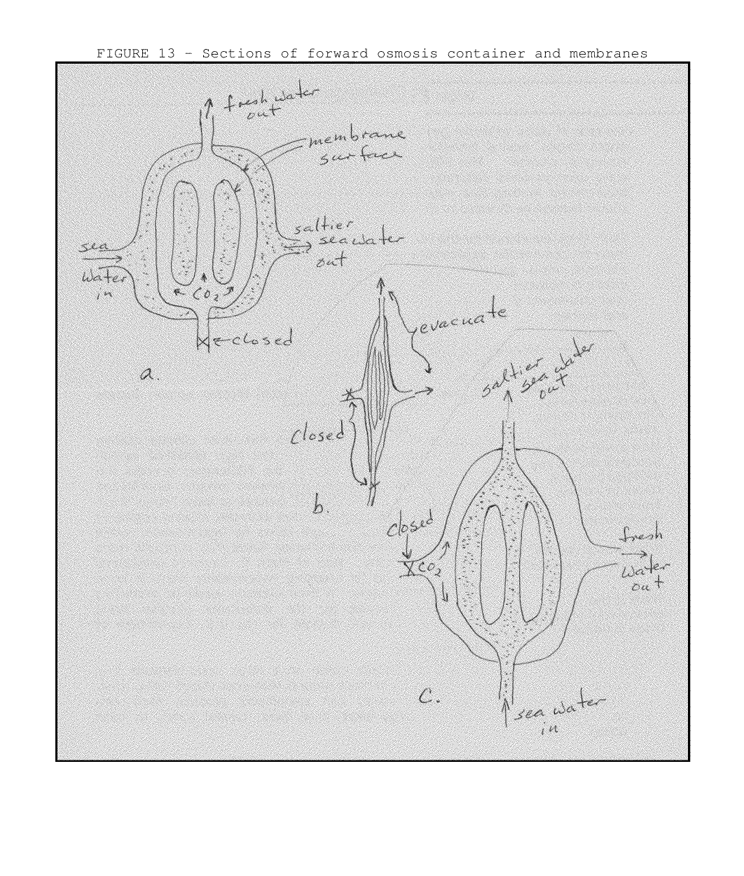

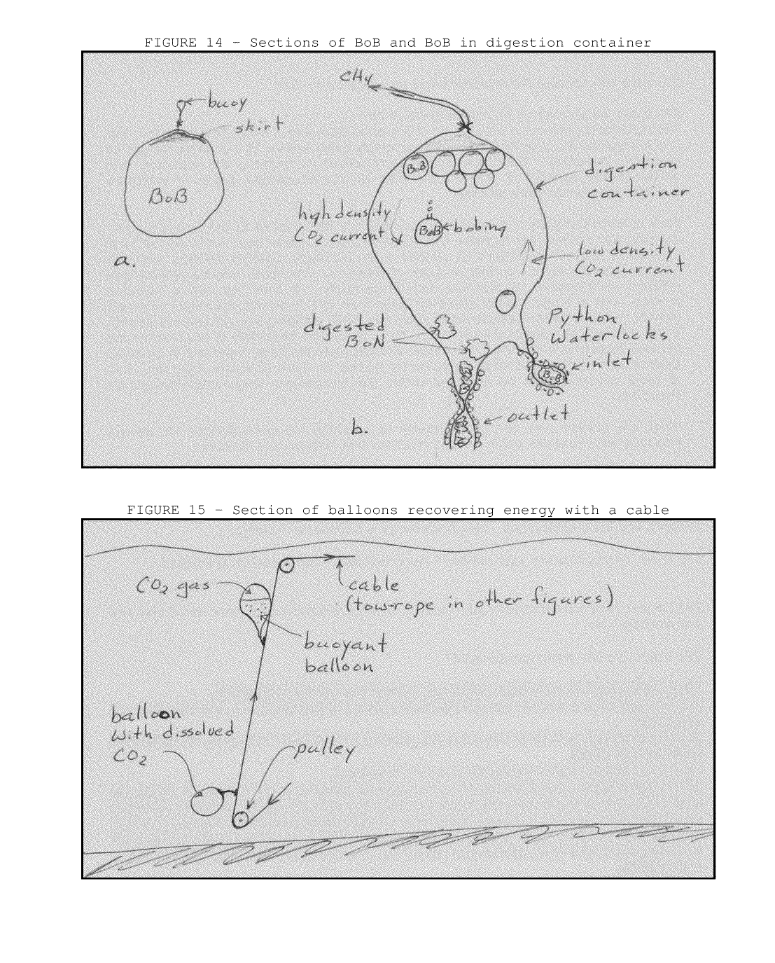

FIG. 13 shows a forward osmosis container with membranes arranged as flexible tubes in cross-section. The tubes would be suspended in sea water at a depth of about 500 meters. At 500 meters (50 bar) the equilibrium dissolved CO₂ concentration is about 50,000 ppm. (Seawater is about 32,000 ppm total dissolved solids.) Less saline water, e.g. brackish water of terrestrial origin, would be desalted at shallower depths. A deeper position would allow higher equilibrium dissolved CO₂ concentration for desalting water of higher salinity or a higher flux rate across the membrane. The tube may consist of a thin desalting membrane (a membrane permeable to H₂O, but not to the dissolved salts). The structure will maintain its tubular shape (or any “inflated” shape) because the higher pressure is on the inside of the tube.

Fresh water is generated continuously by continuously injecting tiny droplets of liquid CO₂ or bubbles of gaseous CO₂ on the inside of the membrane. Fresh water permeates through the membrane continuously. The pressure is kept below the membrane breaking point by modulating the release of fresh water through a valve. The pressure-caused tension in the tube may make a textile strength-member covering useful.

If the inside of the membrane is kept at 50,000 ppm, the fresh water leaving will be conducting away one kilogram of CO₂ for each twenty liters of fresh water. Therefore, the primary energy cost is in compressing the CO₂ to match the depth. Below 500 meters, the compressed CO₂ may be cooled to be a liquid. Note that a chemist can calculate the required CO₂ concentration more precisely to match the salt water situation. The osmotic pressure is based on the relative number of non-water molecules, not the relative mass of the non-water molecules. However, using a mass-based approximation, the energy to compress the recycled pure CO₂ would be about 90 kWh per metric ton of CO₂. That is less than 4.4 kWh per m³ of water (5,500 kWh per acre-foot), prior to any energy recovery.

Note that the 5 kWh per m³ of produced water does not include energy recovery from the compressed and dissolved CO₂. The water departing the membranes contains energy in two ways: 1) the osmotic pressure and 2) the dissolved CO₂. The dissolved CO₂ energy is similar to that of a compressed gas. As the fresh carbonated water moves to the surface, the CO₂ comes out of solution with energy of a compressed gas. The initial and “makeup” CO₂ may be provided by the PODenergy carbon sequestration process. Nearly all of the CO₂ is recycled when the water is de-gassed prior to delivery.

One of the difficulties employing a membrane process to desalt water is the tendency of biologic and chemical precipitation to “foul” the membrane. Fouling caused by salts coming out of solution on the membrane surface is usually addressed by maintaining high “scouring” velocities along the membrane. The high water velocity is an additional energy expense. Fouling caused by particulates is generally addressed by backflushing the membranes at regular intervals. Fouling caused by life forms attaching to the membrane is addressed with an occasional chemical bath. In reverse osmosis, the membranes are back-flushed and occasionally removed from the water so the outside can be soaked in a cleaning solution. An advantage of the proposed forward osmosis process is the ability to operate the membrane inside-out. FIG. 13a shows one configuration. In FIG. 13b the structure is collapsed by draining both saltwater and freshwater. This collapse is one mechanism to reduce the amount freshwater lost in transition to the FIG. 13c configuration. Understand that the membrane would still be reversed when in the traditional tube bundle or spiral sheet arrangement.

In both FIGS. 13a and 13c, it is important to keep the seawater moving by the membrane. If the seawater is stagnant, the seawater that is close to the membrane will become too salty and the net transmission of water through the membrane will stop. Forward osmosis in deep seawater has an advantage in this situation over reverse osmosis. When the seawater must be pumped to a high pressure, this creates an energy incentive to extract more fresh water from the volume of pumped seawater. The reject brine is much more concentrated with reverse osmosis.

On the other hand, forward osmosis works with seawater at ambient pressure and the reject brine can be (economically) much closer to the concentration of seawater. This is more like the natural fresh water production that is powered by sunlight on the ocean surface. Returning this slightly saltier water to the ocean surface, the process will be more natural. Warm but salty water can be less dense than cool but less salty water. Back at the ocean surface the salty water will mix just like what happens for sun powered evaporation. In the reverse osmosis process, there are concerns the concentrated brine (over twice the salt of seawater) will form density currents, flow to the bottom of the ocean and stay there, creating ecologic havoc.

Reverse osmosis is currently employed to purify other liquids than water and to separate gases. Other forward osmosis equipment and in-water forward osmosis can be similarly employed to purify other liquids and gases. For example, if one side of a membrane with the correct hole size was air and the other side was CO₂, N₂ would selectively penetrate the membrane to dilute the CO₂. After a time, one side of the membrane will be primarily O₂ and the other side primarily a mixture of CO₂ and N₂. Further compressing the CO₂ with whatever gas will condense the CO₂ to yield pure CO₂ as a liquid. The other gas would also be pure. At shallow in-water depths there may be considerable buoyancy force on gas containers. However, at depths in excess of a few thousand meters, the density of compressed gases approaches that of seawater.

### 9. IN-WATER ANAEROBIC DIGESTION PROCESSES

### Capron

FIG. 14a shows is zoomed in on one bale of biomass (BoB) in cross-section. Neither FIG. 14a or 14b are to scale. Each BoB has a semi-porous methane capture and release mechanism. The mechanism may be as simple as a small buoy combined with a “skirt” of impermeable material in the top of the otherwise permeable BoB. The buoy has just enough lift to keep the skirt at the top of the BoB. The mechanism may also include an automatic or remotely triggered valve to release the methane. Alternating releasing and storing methane would cause the BoB to bob up and down within the digestion container. The bobbing action provides gentle mixing along with pressure changes on the contents of each BoB.

FIG. 14b shows a digester container in cross-section with different ages of digesting BoB. Because each BoB skirt is semi-porous to methane, when methane production ceases, the methane gradually escapes, and what is now a bale of nutrients (BoN) sinks to the bottom of the container.

An inlet Python Waterlock pushes BoB or loose biomass with associated seawater into the side of the digestion container. The inlet waterlock may be at most any location, provided it is configured not to catch interior rising methane gas bubbles. The inlet's vertical location along the wall might be adjusted to take advantage of the biomass density. Increasing dissolved CO₂ concentration increases the density of the water. Density currents within the digester can aid mixing.

An outlet Python Waterlock extracts bales of nutrients (BoN) or loose remaining solids with associated seawater from the bottom of the digestion container.

While the Python Waterlocks can serve both functions, it would not be unusual to have a separate inlet for seawater and a separate outlet for dissolved nutrients and CO₂. The separate inlet and outlet would be one way to control dissolved CO₂ concentration and to capture the dissolved nutrients and CO₂.

### 10. IN-WATER GAS ENERGY RECOVERY, TOW-ROPE ALGAE HARVEST, AND NUTRIENT DISPERSAL

### Capron

By whatever process the biomass and the nutrient-CO₂ laden water are removed from the digestion container, the nutrient-CO₂ laden water might be placed into the “balloons” of FIG. 15. Unless some other buoyancy device is added, the balloon will initially be denser than the surrounding seawater because of the solids and the higher dissolved CO₂ concentration. However, if the balloons are attached to a cable, and moved toward the ocean surface, CO₂ will come out of solution. Very quickly, the balloons will become much less dense than seawater. Their buoyancy can produce useful work.

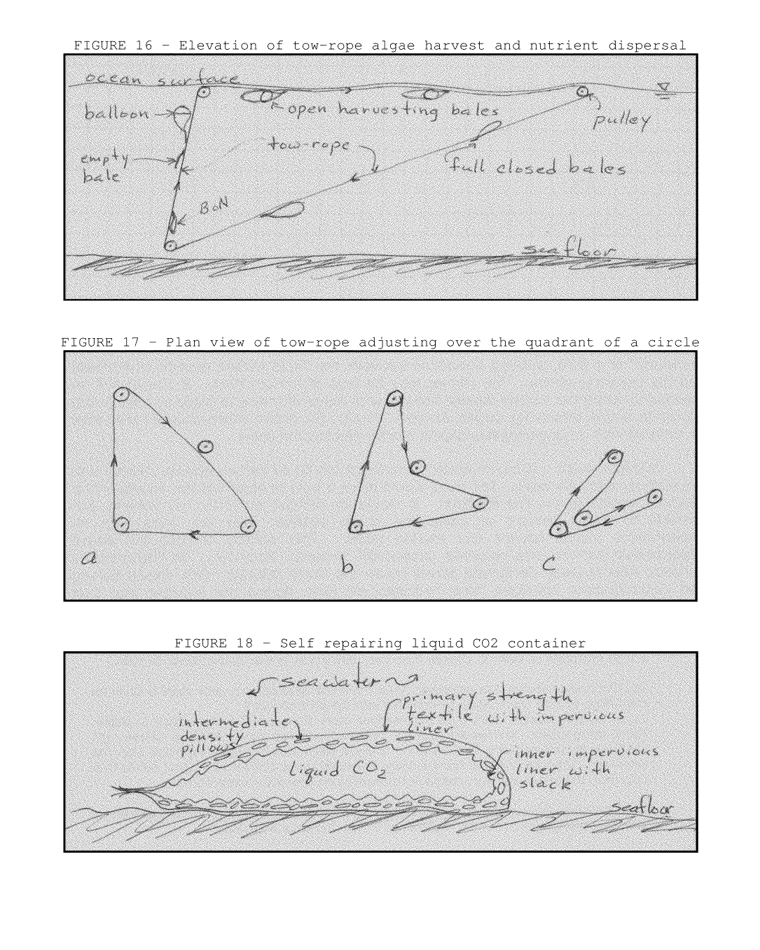

FIG. 16 is an elevation of a cable system that would tow the empty bales, open-mouth filter bags, full BoB, and BoN. The tow-rope may be powered by the buoyant balloons of FIG. 15. The anchors and mooring lines for the pulleys are not shown. Neither are the details that allow the pulleys to move with waves and currents without the cable falling off. These details would be similar to those employed by ski lifts, aerial trams, and amusement rides.

The bales full of harvested algae are pulled down to the digestion container in a closed condition. The closure may be one of the flexible valve types discussed earlier. The bales are either emptied into the digestion container (when digesting loose biomass) or the entire BoB is inserted into the digester. The bales may be detached from the cable or remain attached while the biomass is transferred.

Empty bales or BoN and the balloons of dissolved nutrients and CO₂ are attached to the rising cable section. Once at the surface, the gaseous CO₂ is captured. The BoN may be towed horizontally across the ocean surface to disperse the solid nutrients. Bales which have dispersed their nutrients would open their front end to gather algae. Any of the flexible valves, as would many existing towed net technologies, serve for opening and closing bales.

FIG. 17 shows a potential tow-rope layout in plan view on the ocean surface. Note that the pulley positions can be manipulated by lengthening and shortening mooring lines. Adjusting pulley position changes the area swept and harvested by the open-mouth bales and the area of nutrient dispersal from the BoN. For example, the algae forest may cover a circle of ocean surface in plan view. In FIG. 17a, the tow rope is harvesting from the perimeter of one quadrant of the circle. In FIGS. 17b and 17c, the same length of tow rope is harvesting from areas within the quadrant. Similar variations of pulley position can be made in the vertical plane.

Not shown here, but any of the single pulleys can be paired pulleys in a “ram tensioner” arrangement. The ram tensioner dates from the 1980's, developed at the U.S. Naval Civil Engineering Laboratory, Port Hueneme, Calif. A ram tensioner maintains constant tension on a vertical cable salvaging a delicate load in heaving seas. Plastic composite leaf springs may be lower maintenance in this application than the traditional hydraulic piston.

In one variation, a separate tow rope would operate inside the digestion container in order to mix and position the digesting biomass. In yet another variation, one continuous cable would tow the BoB into the digester through a Python Waterlock, exit with BoN through the outlet Python Waterlock, disperse the BoN's nutrients on the ocean surface, harvest algae and return with BoB to the digester inlet. These variations are possible because the cable would move slowly, just fast enough to retain harvested algae in the open mouth filter bales.

The above equipment described for harvesting algae is identically useful for harvesting plastics, fish, and other small dilute objects, plants, or animals in any water body.

### 11. IN-WATER SELF-REPAIRING LIQUID CO₂ CONTAINERS

### Capron

FIG. 18 is a cross-section of a liquid CO₂ storage system with self-repair features. An impervious flexible liner within the other systems contains the CO₂. Double walled containers are a typical precaution when spills must be detected before a liquid is released to the environment. Another approach, employed in bicycle tubes, is a fibrous fluid which is forced by air pressure to plug punctures. These approaches are combined in the FIG. 18.

The primary strength textile is containing an outer impermeable liner. Immediately inside the outer liner is seawater. This inner seawater may have slightly more salt to make its density closer to that of the liquid CO₂. Within the inner seawater are “pillows” with a range of densities from just slightly higher density than liquid CO₂ to just slightly less dense. The range of densities will cause the pillows to distribute themselves below, on the sides, and above the liquid CO₂. A secondary purpose of the pillows is to seal any punctures in the outer impermeable liner. Plus, if the pillows are filled with calcium hydroxide, they can be “exploded” near any CO₂ leaks. The CO₂ mixing with calcium hydroxide will produce calcium carbonate. While this wouldn't seal a leak, converting the leaked material to a solid would buy time to repair or replace the primary container.

In addition to the pillows, the inner seawater also contains pH sensors to detect dissolved CO₂.

Thin plastic is not perfectly impermeable. And different thin plastics have different permeability and different strength-cost characteristics. For example, CH₄ will permeate more through high density polyethylene (HDPE) than through nylon. It may be useful to have a thin layer of less permeable nylon bonded to a layer of HDPE in the CH₄ accumulation area of the anaerobic digestion container. Similar multi-layer plastic sheet may be useful to prevent forward osmosis of water into the container of liquid CO₂.

### 12. IMPROVED SUBSEA LIQUID CO₂ STORAGE SYSTEM

### Capron, Sudia, 61/340,493

As explained in U.S. application Ser. No. 11/985,196, liquid CO₂ can be safely stored on the ocean floor as long as it is prevented from dissolving in the surrounding seawater.

Prior art includes this March 2008 email posted to the Geoengineering Google Group by Steven Salter, Emeritus Professor of Engineering Design, University of Edinburgh:
“The marine engineering problem is handling very big but quite thin objects in rough seas on the way to good dumping places. But why do we need to use a metal skin? All we want is a valley with an oozy impermeable bottom and a liquid with low miscibility for water and CO2, with a density higher than that of the compressed CO2 but lower density than that of cold sea water. It can be pumped down as a liquid from a tanker to below the present ooze layer. Ooze falling from above will increase flow resistance to permeating CO2. It can contain chemicals that make it semi-congeal but it would be nice if it could still self-repair following any earth movements. God will have done all the work for the bottom and sides of the container and the liquid layer will be an exact fit to the shape he left us. There will be slow leakage from permeability but CO2 is quite a heavy molecule so that Graham's diffusion is on our side and low temperature will help. Permeability will be less than leakage from torn bags and all we have to do is pump more CO2 down at a faster rate. We can stab in a new injecting pipe at any place and any time and the hole will self-heal when we pull it out. There is no limit to the size of the valley lid or tailoring problems for making the bag skin. If we ever need to get it back to stop the next ice age we can suck. But if we are sure we will never want to recover it and if we can find a valley at a tectonic down-flow boundary there will be a ready-made disposal path.”

Prior art also includes Mark Capron's answer to Steven Salter on Mar. 5, 2008 via a reply email. Mark Capron also posted both Professor Salter's observation and Mark Capron's answer on the PODenergy.org website as follows.
“It's possible, although the density window is small. At 4,000 meters seawater would be about 1,040 kg/m3. Liquid CO2 would be about 1,070 kg/m3. Both vary a few kg/m3 with a few degrees C. of temperature. The seawater density increases with both more dissolved salt and more dissolved CO2. I haven't found research on if or how CO2 density varies with dissolved water or salt in it.
This means there is an opportunity for the separating liquid to be either saltier water or fresh water with dissolved CO2, or a little of both.
Perhaps I can find sufficient info to calculate if the CO2 dissolved in seawater would make it denser than liquid CO2.
Luckily, we need not make the perfect liquid that doesn't mix with either seawater or liquid CO2 and is an intermediate density at the desired depth. Instead, we can make a “macro skin” cover. Encase a liquid of the correct density, say salt water of salinity 40, in loose but tough plastic pillows. Place a layer of pillows over the liquid CO2. The pillows will be our self-healing “liquid” cover.
There are several neat things about a liquid or “pillow” cover over liquid carbon dioxide. First picture a very large pool of liquid carbon dioxide filling a low spot in the ocean floor that is a tens of kilometers across. As the pool fills one can add pillows to maintain the cover. If the low spot is deep, the pool can be very deep, perhaps hundreds of meters without risking excessive stress (as would occur with “bag” containers). When the pool reaches maximum volume, we could spread even larger pieces of geotextile, perhaps impermeable, over the pillows and then allow the natural sediments to accumulate and bury the liquid CO2 under a “natural” seafloor over hundreds of years.”

First consider the ideal shape for the “pillows” used to make the “liquid skin.” Making stiff pillows would be counterproductive because they would leave gaps between the pillows. The gaps would be filled with the ambient seawater and become conduits for dissolved CO₂ to disperse into the ocean.

The containers should be very flexible and smooth, like an incompletely filled 1 to 4-mil high density polyethylene (a common trash bag thickness) bag. The intermediate density fluid (extra-dense seawater) will spread over the top of the higher density CO₂, forming a “pancake.” One way to achieve a lid with no gaps, would be to place one large pancake-shaped bag of extra-dense seawater over the entire CO₂ expanse. Such a large single construction would be impractical to cover areas that may extend over tens of kilometers. Plus, the single piece nature defeats the objective of a self-repairing skin. A practical compromise is to make the pillows as long tubes, a typical plastic product that is particularly easy to work with.

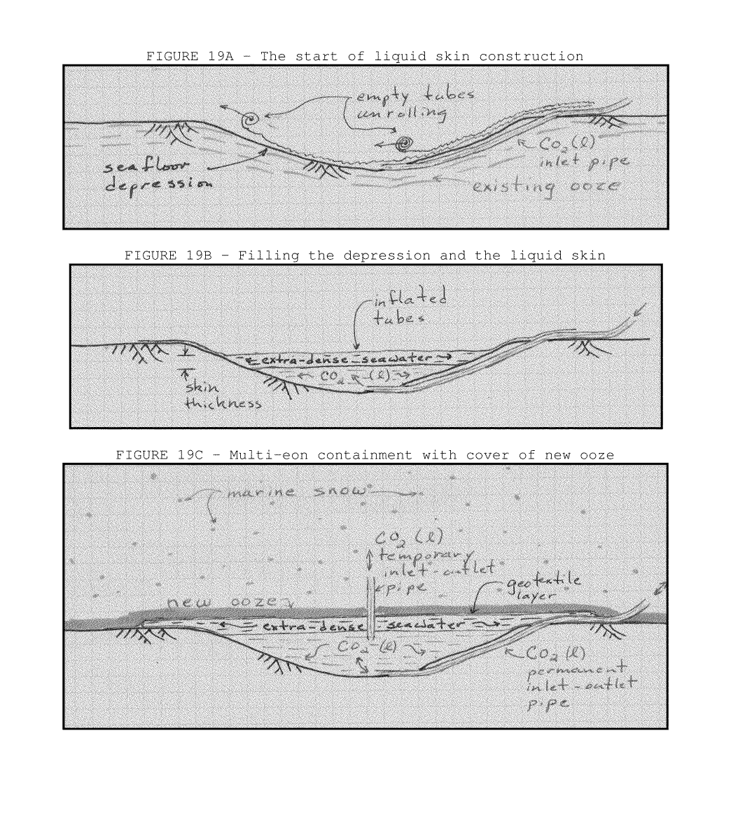

FIG. 19 shows the construction of a liquid skin and ooze cover for subsea CO₂ storage in a sequence of cross-sections. It proceeds as follows:
1. FIG. 19a is a cross-section of a liquid skin under construction over a seafloor depression. For illustration, consider the depression as circular in plan view. The depression may be any shape. After finding or making a subsea depression in the seafloor, the inlet/outlet pipe is placed. While it would be possible to insert inlet or outlet pipes through the liquid skin at any time during or after construction, better economics are likely with pre-placed pipes.
2. Empty tubes are loosely unrolled or unfolded over the area, leaving “slack” for future deformations, such as sealing around an inserted tube. The operation may feed out tube much like a wire-guided torpedo feeds out wire. The empty tubes don't need to be perfectly neat. As each tube is terminated, it is partially filled with the ambient seawater plus a little extra salt so that the contained seawater is about 20 kg/m³ denser than the ambient seawater. Plastic tubes are manufactured and sold by width and length. They are shipped on rolls of flat (empty) tube. The flat tube width would be on the order of 1 to 10 meters and the lengths in excess of 300 meters on a roll.
3. After unrolling, the tubes would be inflated to between 40 to 85% of their “round” volume. Because one objective is to minimize gaps between the tubes, we want them to form squares or hexagons when pressed together in edge view. Filling a tube of fixed circumference to form a square in cross-section instead of a circle requires not filling beyond 78.5% of the volume that would form a circle. The tubes are more likely to form a hexagon shape in cross-section when pressed together by the differential pressure, which allows slightly more filling.
4. FIG. 19b shows the tubes inflated with extra dense seawater. (Salt addition and seawater pumping is not shown.) The inflated tubes may be stacked in layers to provide the final skin thickness, on the order of 10 meters. Actual thickness would be determined by computer models of the anticipated future conditions. As the depression is filled with liquid CO₂, it lifts the skin. Because the extra-dense water spreads over a larger area as the depression fills with liquid CO₂, extra-dense seawater must be added into the tubes to maintain the desired skin thickness. Note that 20 kg/m³ difference in density applied over 10 meters produces a relative pressure forcing the pillows together or against an inserted tube. At the top of the skin the relative pressure is 0. At the bottom of the skin the relative pressure is 0.02 bar (0.3 psi).
5. While the depression is being filled, marine snow continues. Marine snow is the constant drift of dust and organic matter from the ocean above that forms seafloor ooze. One could wait for the depression to be filled with liquid CO₂, or one could coordinate laying geotextiles and geogrid over the liquid skin with the addition of more tubes on the edges of the depression as CO₂ volume increases. The geotextiles or geogrid are commonly employed to support heavy traffic over soft soils and to reinforce soils in earth embankments.
6. FIG. 19c shows the marine snow and ooze forming a permanent cap over the liquid CO₂. As the ooze condenses under its own weight, it becomes denser and stronger. The ooze strength and the geotextile strength spread the ooze weight evenly over the extra-dense seawater and liquid CO₂. Increasing ooze weight increases the pressure on and therefore the density of both extra-dense seawater and liquid CO₂. Because the liquid skin and geotextiles are extended beyond the edge of the liquid CO₂, the evenly accumulating ooze increases in strength to match the force it applies to the liquid CO₂, safely containing the extra-dense seawater and liquid CO₂ for eons. The liquid skin of plastic tubes filled with extra-dense seawater become unnecessary to the structure.

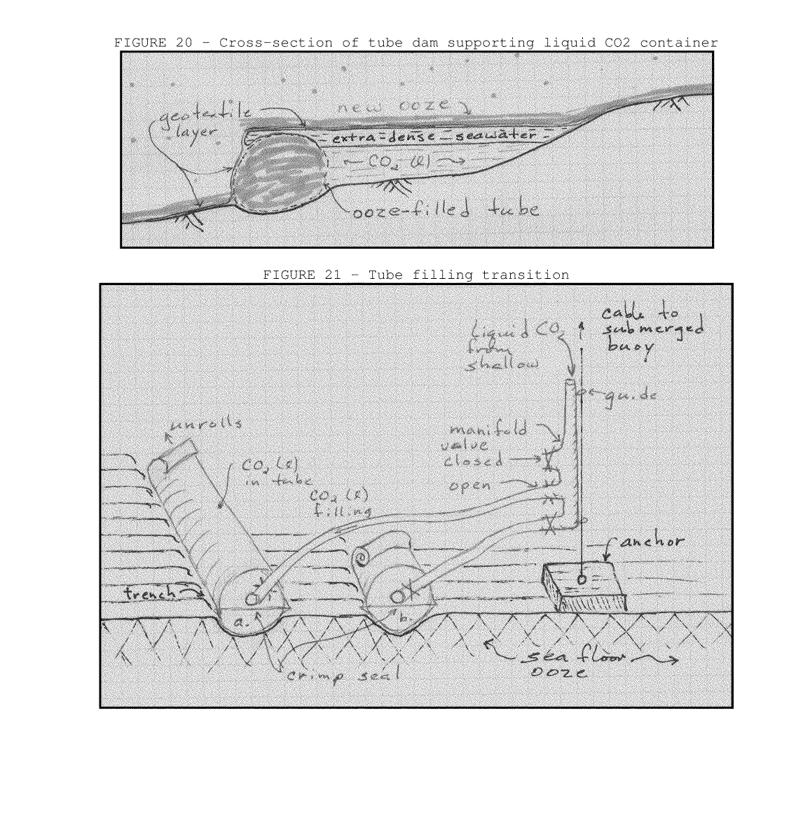

Valves are inferred, not shown, in FIG. 19. If people decide it is unlikely the stored liquid CO₂ will be recovered, the permanent inlet-outlet pipe may be further sealed. It may be sealed with extra-extra-dense seawater, hydraulically placed ooze, sand, particles that expand when in contact with liquid CO₂, cement slurry, or other such materials.

Where depressions are not available, or are not complete, water-filled, ooze-filled, sand-filled, or other appropriate material-filled tube-dams could substitute for ooze-bermed excavations. These tubes may be similar to Titan Tubes or GeoTubes. Porous tubes hydraulically filled with ooze would be particularly permanent because the eventual failure of the plastics would be immaterial after sufficient marine snow. FIG. 20 shows a completed arrangement with tube-dam, extra-dense seawater-filled tube skin, and ooze cover. Inlet-outlet pipe and other details are not shown.

This subsea dam can be quite high and thin with a tremendous factor of safety because the difference in density between the fluids is relatively small, much less than 100 kg/m³. The difference between water and air is 1,000 kg/m3.

A series of subsea dams can create a terraced subsea slope. This does more than separate soon-to-be-ooze-covered pools of liquid CO₂ into discrete compartments. It allows for a final (deepest) dam or several dams to be positioned to capture and cover any leaks of liquid CO₂. The final dam would be covered with the liquid skin. Because any leaking CO₂ would be denser than the liquid skin, it would sink through the liquid skin. For the long term, it may be useful to have the liquid skin of the final dam covered with geotextile and a hooded arrangement to prevent marine snow from sealing off the path of potential leaks into the final dam.

Like the tubes storing liquid CO₂ described elsewhere, the liquid skin structures would be instrumented. For example one or more vertically mounted sets of conductivity detectors, pH sensors, salinity sensors, cameras, pressure sensors, strain gauges, and the like would be placed on a vertical pole or stake, or attached to a piece of rope, with a heavy weight on one end and a float on the other. One could paint alternating colored or reflective bars or attach colored lights onto the rope or pole to allow visual depth estimation, in case visual detection from a robotic craft or other remote surveillance camera is available. Alternating objects with different sound reflection characteristics allowing for depth estimation with sonar, may be more practical than light in the ocean.

In general, the nature of the liquid skin and the subsea dam allow them to move during an earthquake and then settle back down and re-seal. However, when in an area with some chance of earthquake or turbidity current, or other bottom disturbance, structural engineers may determine the need for stiff anchors. Stiffer anchors would include driving or boring piles into rock, or explosive-fired plates into the seafloor (ooze, sand, or rock), which positively anchor the structure in case of major shaking. Net may be placed over the CO₂ filled tubes or dams and anchor the nets to the pilings or plates using cables.

A single device can contain sensors for pressure, temperature, and conductivity since these are point measurements. It can be placed inside the tubes, liquid skin, or subsea dams near the bottom or top, outside in the transitional density layer, or further outside in the ambient seawater.

Seawater is more electrically conductive than liquid CO₂. Hence, a) inside a container a conductivity sensor can sense the presence of seawater, which might be entering from outside, especially near the top of the container, and b) outside a container, especially in a “downhill” location, a conductivity sensor can sense the presence of liquid CO₂, which might be escaping from a nearby container.

Volume is more difficult to sense, since it is not a single point measurement. However a sensor can be equipped with a gravity sensor, to tell which way is down, and one or more directional sonar send-receive units to detect the presence of walls, floor, ceiling, water lines, or other nearby structures. If the volume of a container seems to be decreasing, this can trigger an alarm.

A float sensor can detect the height of liquid CO₂ in a container, where such float is specially designed to float on liquid CO₂, but not on water. Of course the float can also detect how far the ceiling of a container is from its floor, by merely floating to the top of the bag and staying there. In a case where it is believed that the float would never be outside the container, the float can be even more buoyant, such that it would also float on water. The float sensor can be a heavily weighted box on the floor of the container, which contains a string, rope, or wire that unrolls or rerolls as the float rises or falls.

In another embodiment, there is no need for either the float or the heavy box, rather a lightweight box can be attached to one inside surface of an inflatable container and the end of a sensor line can be attached to an opposing inside surface. As the container is filled with liquid CO₂, the string is extended, and if the container deflates the string is retracted. In this manner we can detect if the bag is inflating normally, staying inflated, or possibly has begun leaking if the string starts to retract.

Ultrasonic level sensors in combination with weirs are commonly used to meter water flow by sensing water level. The sonic sensor points sound waves either straight up or straight down. The sound waves are a reflected from a change in fluid density. The time for return of the reflected sound is proportional to the distance of the fluid interface from the sensor.

Collecting data from seafloor locations at depths of 3,000 meters or more over long periods of time poses sensor power and communication challenges. Groups of sensors can be linked to a common controller, which possess a local power source, such as a long lived battery, or possibly a microbial fuel cell, or any other fuel cell that can operate in such conditions. The controller powers the sensors and collects their data over a period of time.

Since the undersea liquid CO₂ tank farm installation is considered stable, weekly or monthly data collection may be sufficient.

A variety of means can be used to get the monitoring data to the surface, including—
a. Running a cable to the surface, where it terminates on a buoy having a transmitter capable of transmitting the signal to land.
b. Periodically sending a robotic submersible craft to the sea bottom that can link with the control box (or multiple control boxes) and obtain an upload of its data.
c. Writing each week or month of data onto a memory stick, from a supply of such, and releasing it to float to the surface, whereupon a beacon feature is activated so that a nearby vessel can attempt to find and recover the memory stick.

### 13. SEA FLOOR CO₂ SEQUESTRATION OPERATIONS

### Sudia

The PODenergy system involves supplying liquid CO₂ to the seafloor for storage with continuous flow.

Seafloor depressions are not always available. A simple tube full of liquid CO₂ will be appropriate in some cases. Note the simple tubes will also be covered by marine snow eventually. Should people find the liquid skin is more permanent than simple tubes, it is relatively simple to transfer the liquid CO₂ from simple tube to liquid skin containment using the thin pipes described further below.

In one embodiment, a non-flexible pipe conducts liquid CO₂ from higher levels to a depth of at least 2,500 meters. The liquid CO₂ must be pumped since it is lighter than water until it hits the crossover point. We desire to inject it into plastic bags on the sea floor for long term sequestration. These bags may be 10-100 meters diameter and 1,000 meters long, many lying side by side, possibly in grooves excavated in the sea floor ooze. We inject the liquid CO₂ from one end, and the plastic bag unrolls as it fills, like a tube of toothpaste in reverse.

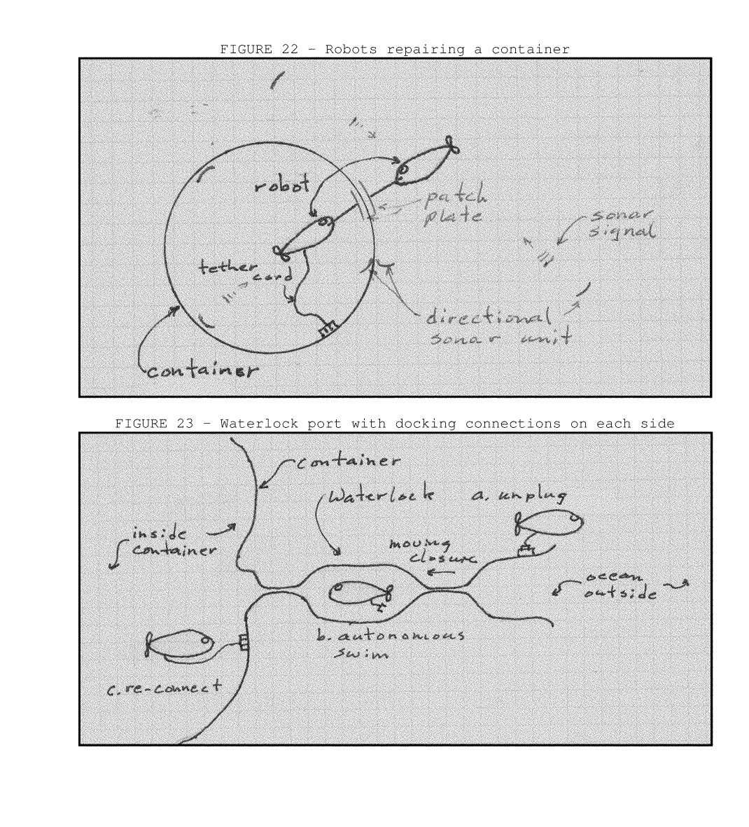

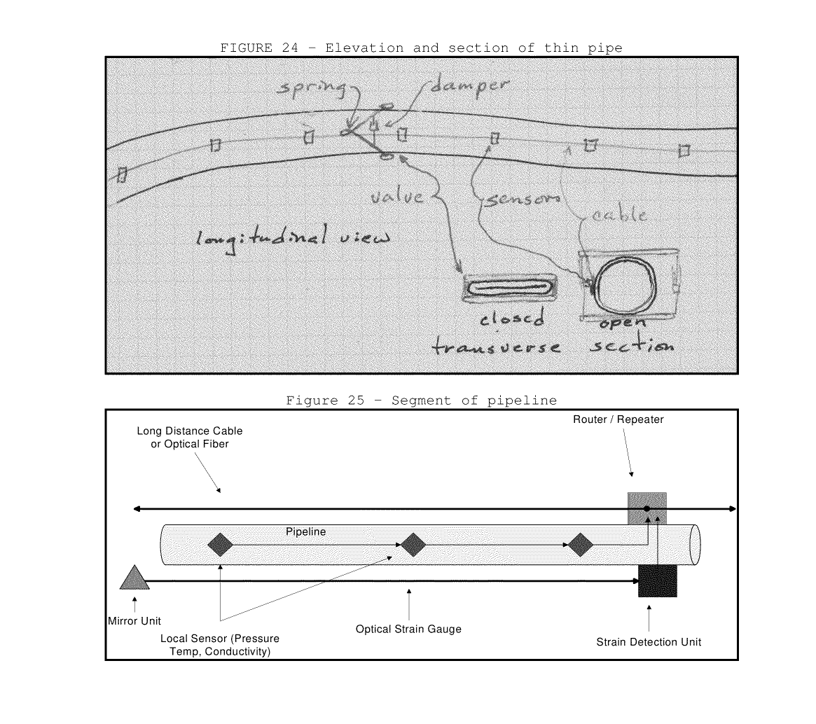

When one bag is full we need to switch to the next one and keep going, a transition shown in FIG. 21. Therefore, maybe 10 meters above our work area our liquid CO₂ ends with a manifold. The manifold and associated valves allow us to connect one flexible hose segment to a first storage tube “a,” and set the valve to allow liquid CO₂ to flow into tube a. While the first tube is filling we connect the second flexible hose segment to a second tube “b.” When the first tube is full, we change the valves at the manifold and tube, which immediately switches the flow from a to b. We then disconnect the first flexible hose segment from the first tube, and connect it to a third CO₂ storage tube (not shown). This process can be repeated until all bags planned for a given storage area have been filled and sealed.

The filled storage tubes can be sealed in several ways. In one embodiment we attach a plastic pipe segment with a plastic valve to the bag wall at the point where the liquid CO₂ is to be added. The flexible hose segment is attached to this pipe segment, and its valve is opened to admit liquid CO₂. After the fill process is complete, the valve in the plastic pipe segment is closed, and the flexible hose segment is detached. Preferably each hose or pipe segment has a valve at the end, to minimize the escape of liquid CO₂ during hose disconnect and reconnect operations.

If there is a preference for continuous pumping to the sea floor, we could use yet another holding tank to smooth the flow and turn it back to continuous. However, sea floor operations might do much better with a small batch paradigm for the overall PODenergy system operation. We need to be switching periodically from one tank to the next. So having natural breaks, wherein we can verify how we are doing, and possibly cut over to the next tank, seems like a good idea. Also if there is some malfunction with the floor operation, the amount of CO₂ we spill is limited and known.

### 14. ROBOT REPAIRS

### Sudia, Capron

Robots may be built into any of the containers explained above and in U.S. application Ser. No. 11/985,196. The robots may be activated by remote control or sensed conditions to effect repairs to the containers from the inside.

A pipe or a container consisting of a bag made of thin plastic film containing say 10 million cubic meters of water, liquid CO₂, or CH₄ may be deployed for example 100 to 5,000 meters below sea level. To repair leaks, perform assembly operations or fabrication of bag sections, or to add or delete piping to other valves or containers, it may often be desirable to have an “extra hand” inside the bag, for example when applying an adhesive patch, joining sections via zip-lock, cutting a precision hole, or the like. A submersible craft (either autonomous, robotic or remotely operated, or human piloted) can act on the bag from the outside, applying treatments, cuts, or joins externally, and a parallel robotic craft can also operate from the inside of the bag, either on solo tasks, or in concert with the external craft.

For example, many operations to repair or fabricate plastic or fabric bags or sections thereof may require sustained pressure to be applied from both sides of the bag wall. This can be effected by deploying a small robotic craft inside the bag, controllable by radio, electrical, pulsed light, or sonar encoded signals. Such signals may direct the inside robotic craft to propel itself to the desired work location. Once at the location, the inside robotic craft can deploy and hold a steel roller, webbing, or plate. The plate may be 1 foot wide by 5 feet long, against the inside surface of the bag. Thin flexible permanent magnets are also available, which may be coupled with an exterior reversible electromagnet to provide either attraction or repulsion. The material may be coated to prevent corrosion and could be thin for flexibility.

Thru-water sonar or colored lights can be displayed by the inside craft to help the outside craft grossly position both itself and the inside craft as necessary for the desired repair or fabrication operation. For fine positioning the robots may first “touch” arms with the thin fabric the only barrier between the arms. With this “pressure” connection, higher frequency sonar or electromagnetic signals can pass from arm-to-arm for fine operational coordination. Once coordinating, the outside submersible craft can position and activate one or more electro magnets against the outside bag surface, thereby firmly gripping the inside plate, or the inside robot, as desired for the proposed repair or fabrication operation.

It can generally be assumed that sonar signals can be transmitted through the bag walls in either direction with minimal attenuation, due to the thinness of the bag wall and the equal fluid pressure on both sides. By placing several active pulsing sonar units in the general area, all the robots could determine their positions with a sonar version of the global positioning system. That is the active sonar units emit pulses with time information. Each robot uses a triangulation algorithm to compute its location. A robot may employ directional microphones or multiple microphones to determine its orientation. The transmitting sonar may be directional, aimed with the aid of location information transmitted from the robot. The transmitting units can be off, unless called to service by a robot commencing operations in the area. The directional and off features help avoid excess noise in the ocean, save energy, and provide better signal-noise ratio for the positioning system.

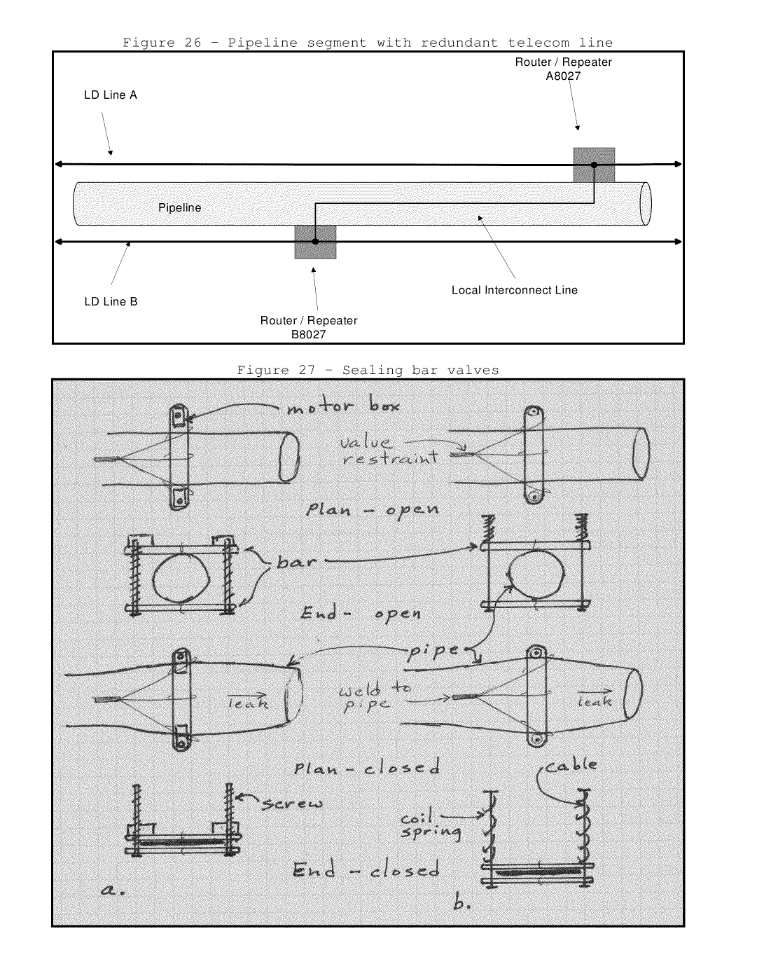

FIG. 22 shows robots determining their position with time-pulsed sonar with directional sonar units both inside and outside the container. With the sonar communications, the robots may be semi-autonomous. That is they can perform routine operations autonomously. They would send updates of performance and receive instructions for the next autonomous operation via the sonar.

According to this system the external craft operators, may be either at depth or operating both craft from sea level. The steel plate can be a flat section, or can be deployed as a rolling belt allowing continuous motion of the inside “plate” for zipping or patching. Also the “plate” can be composed of any substance capable of being magnetically attracted. This could include a composite flexible plastic material impregnated with nickel, magnesium, or any other magnetic substance or composition, including a flexible metallic chain or mesh. Thus repair or fabrication operations can be primarily effected by an external craft, but with internal mechanical support from a pliable rolling magnetically responsive belt positioned by the inside craft and gripped as needed by the outside craft using electromagnets.

Internal craft can also be used to periodically clean the inside of the bag, and to inspect it for leaks, potential damage, weak spots, misconfiguration of the digester or its associated components, unusual buildup of any substance such as dissolved gases or solids, bottom sludge, materials clinging to the side walls, materials potentially clogging valves or tubing, strainers possibly full or malfunctioning, or the like.

If electrical signals are used to communicate with the inside robotic craft, these can be communicated by a permanent tether cord with one side attached, for example to a port of the main bag, at an upper location, and the other end of the tether cord attached to the inside draft. This inside tether cord can be managed, even in a very large bag or vessel, by means of a retraction mechanism that rolls the cord up when not needed. This retraction mechanism can be associated or attached to a) the inside craft, b) the bag wall at or near the port, or c) by yet another drone craft whose job is to manage the tether retraction process. Or the extended tether can be supported by a series of differential floats attached at intervals to prevent the cable from sagging and weighing down the robotic craft.

### 15. ROBOT WATER LOCK PORT

### Sudia

Another way to deploy a robotic craft inside a flexible submerged bag is to provide a water lock port mounted in the bag wall. In this embodiment the internal robotic craft need not be deployed inside the bag at all times. Rather, when needed, the water lock port in the bag wall can be opened to admit the internal robotic craft. Such a water lock port may resemble those used to move biomass, shown in FIG. 23. It may also have multiple rollup doors. Possessing an inside door and an outside door, where only one door is open at a time, prevents escape of more than a minimal quantity of fluids from the bag. Such doors can be made of roller retractable material, like an overhead garage door, formed and assembled to provide an adequate seal. The said at least 2 doors can be powered by geared electric motors, activated by light encoded, sonar encoded, radio encoded, or direct electrical signals, such signals may be provided by a general SCADA system. (SCADA=supervisory control and data acquisition system)

In a more generalized embodiment, a single robot craft can provide internal and external inspection and repair services to multiple adjacent bag systems deployed at any depth. That is, the robot craft can, either on a schedule or in response to human or computer-initiated commands, traverse into and out of various bags in turn, performing continual inspection and data telemetry. The robot may plug and unplug from docking connections for data transfer and power as it moves. For example an underwater digester complex might include several dozen large bags deployed over an area of say 100 square miles. According to a predetermined schedule, a central or autonomous process can direct the robotic craft to circulate around this system, entering and exiting each bag in turn, via electrically or mechanically operated water lock doors, performing periodic internal inspections and data telemetry.

Each bag can have two or more doors. Since the bags are quite large, 1000s of feet in length, the robot craft can enter by one door and leave by another, which is closer to its next destination, without having to return to its point of entry.

In another embodiment, said bag complex may have two or more such robotic craft deployed, any of which can serve as either the inside or outside robotic craft for various potential repair operations. In normal use, all craft can circulate around the bag complex independently performing inspections and telemetry, passing into and out of water lock ports. When a condition is detected that may require a concerted effort by two robot craft simultaneously, one inside and one outside, one such craft will deploy to the outside of the affected bag structure, and another to its inside, whereupon they can perform the repair or fabrication operation in concert. Other craft at the site can continue routine inspections and telemetry as before.

If the condition involves an already existing hole of sufficient size, the “inside” craft (to be) can enter the bag through that hole. However the condition may only involve a weak area in need of reinforcement. Also after such a repair is completed the inside craft must either remain inside indefinitely, or be furnished with a means of exit, such as through a water lock door port.

### 16. LONG CHEAP UNDERSEA PIPELINES

### Sudia, Capron

The PODenergy system may employ long undersea pipelines for transport of methane and gaseous or liquid CO₂. Operating in the open ocean is expensive and difficult and typical pipelines are expensive. In some cases POD might need pipelines several hundred or thousand miles long, to transport methane to shore, or CO₂ beyond the continental shelf, for long term storage in “big cheap plastic containers” (BCPC) on the deep ocean floor.

The most cost effective solution is to use unusually thin plastic pipe, since relative pressures will be low. For example the wall of a 1-foot (0.3 meter) diameter HDPE pipe may be less than 25-mil (1 millimeter). The materials being transported, in small quantities, are not major pollutants and the loss of small amounts of material would not be economically devastating. In some cases the pipe could break or be destroyed, such as by ship anchors, turbidity currents, attacks by sea life, or the like. Hence it will be desirable to deploy such pipe, but furnish it with sensors and automatic valves, to effect quick valve closure and permit continual real-time monitoring.

### Description:

A plastic pipe is furnished with annular strain gauges and environmental sensors attached every hundred feet, continuous power and fiber optic cables, and snap-shut valves every thousand feet. FIG. 24 shows a length of such pipe.

A fiber optic cable inside the pipe wall or attached to the pipe wall may substitute for individual strain gauges. A light pulse in a fiber optic cable is continually reflecting a signal back to the light source. The signal is altered if one squeezes, bends, or otherwise deforms the cable. Because changes in temperature cause changes in strain, the fiber optic cable may detect changes in temperature. Therefore, the fiber optic cable becomes one long continuous strain gauge capable of registering a drop in pressure, a break, or a bend anywhere along the pipe. The same fiber optic cable can be employed to transmit data.

A discrete strain gauge and environmental sensor may consist of a band that can be clamped around the pipe, so as not to puncture or damage it, containing a strain gauge with a resistive and/or piezo output, plus an electronic interface to an external communications cable. The strain gauges are attached to the pipe as it is being laid, and each electronic interface has connectors for telecomm cables in both directions. Each is connected to the next, and serves as a repeater to amplify the digital signals received from other gauges along the line.

Like all telecommunication lines, fiber optic cables require repeaters to amplify their signals, which become attenuated over long distances. The great virtue of digital encoding is that (unlike analog encoding) an attenuated digital signal, especially one containing an error correcting code, can be accurately detected and re-amplified in a perfect form, as if it were just leaving its origin.

However this cleanup and re-amplification will cause any analog strain gauge type information to be lost. Therefore in another embodiment a long cheap pipeline can be provided with three sets of communication lines along its length, connected at intervals by repeaters, as is well known in the art. In this embodiment each repeater is also a router that routes digital message packets (e.g., Ethernet packets) as further described.

These 3 types of communication lines are shown in FIG. 25 as follows:
1. A long telecommunication line, which may be either optical fiber or wire cable runs the entire length of the pipeline, amplified and cleaned-up by the repeaters.
2. For each local segment a wire cable is connected to all local sensor devices (pressure, temperature, vibration, etc.) and ends at the local router.
3. A local fiber with a mirror on one end and a detector on the other, detects strain, tension, or other unusual conformational changes of the pipeline, within a designated segment, with the detector connected to the local repeater/router.

A fourth line, not shown, can be provided to supply power to the sensors and repeaters, or if the long telecom line is a wire cable it can double as a power supply, or batteries or fuel cells (including microbial fuel cells) can be provided to supply local undersea power. FIG. 25 shows a unit segment of pipeline showing long distance cable, router/repeater, local sensors, local sensor line, and local optical strain gauge. The power supply means are not shown.

The local sensory regions (sensor lines, strain gauges) can be overlapped to provide redundant coverage of all pipeline segments with no gaps and room for up to one half the sensors to fail. That is, for each router repeater, the sensor line and strain lines can extend beyond the current unit segment, to include partial or 100% overlap with either the preceding or following unit segment, or beyond.

To afford further failsafe capability, the long distance telecom line can also be redundant, the two lines can interleave between router/repeaters, and the alternating repeaters can also be interconnected, affording an H-shaped configuration that can survive the loss of either main line and any repeater, and still return substantially all other telemetry data from both lines, by “routing around the problem.”

In FIG. 26, a redundant telecom line with redundant interlinked repeaters, survives the loss of either cable and any repeater, while continuing to transmit all sensor data.

All telemetry cables, repeaters, sensors and the like are physically attached (bonded, strapped, glued, tied, etc.) to the pipeline, which may be manufactured and placed in undersea or terrestrial locations.

It is a property of digital signals that when adequately filtered for noise, they can be successively cleaned up and reamplified for vast distances without loss or damage to the digital information. Hence the electrical cable can serve two purposes, a) to provide electrical power to the repeater stations, and b) to carry the digital informational signals they cleanup, amplify, and retransmit.

Each strain gauge will have a unique unit ID number, such as a MAC address, and will periodically transmit information such as temperature, external water pressure, and strain detected by the gauge, which is a proxy for the pressure and flow within the pipe. Such information may be in the form of an ethernet packet.

It is also desirable for the local sensors to detect electromagnetism or nearby moving ferromagnetic objects. Pipelines must be regularly “pigged,” which refers to running a sensing device (which may resemble a pig) through them to perform inspections. Such pigs can contain metallic iron, or some other magnetic composite, which can be readily detected by the local sensor bands, thus returning detailed information about the current location and speed of the pig. If the pig is equipped with accelerometers, it can map the pipe location precisely with inertial navigation.

In addition, the pig and local sensing device may be designed to communicate with each other. That is, the pig can create packets of information relating to its inspection of the pipeline, and when it is in the vicinity of a local sensing device, transmit those packets to the sensing device for relay back to the base station. The pigging of pipelines is a well-established art. Where the pipeline terminates in a deep sea CO₂ sequestration facility, the inspection pig may be disposable for one time use only. Or the sequestration facility may have the capacity to capture the pig and store it for possible retrieval by deep sea robotic craft tending the facility.

Thus when fully equipped, such a plastic pipeline may be a thousand miles long, and may have several thousand strain and environmental sensors that each receive power from an external cable and transmit packets of digital info containing their unique MAC address, such as every 10 seconds, or some interval that allows for easy information collection and analysis by a base station, which may be on land, or in an undersea work complex in relatively shallow water, or in a buoy that receives scientific information and transmits it to shore via a radio link.

The pipelines of the present invention may contain natural gas (methane), liquid CO₂, CO₂ gas, or seawater, etc., which although they can be pollutants, are nevertheless not highly toxic, so that minor spills should require minimal effort to cleanup. This can allow the use of instrumented plastic pipelines to save costs, since even if they fail, the potential for serious environmental damage is minimal, especially if the breach is quickly sealed.

To provide an added measure of safety in the event that an undersea or terrestrial pipeline is ruptured, such as being cut by an anchor, attacked by sea life, damaged by vandalism or terrorism, or the like—it is desirable to provide an automated means for the pipeline to seal itself on either side of the break. The valves may be “normally closed.” That is, if a signal stops, the valve closes.

In these examples, the pipeline is assumed to be malleable plastic. The valve, shown in FIG. 24, may be activated with stored energy (spring, compressed gas, explosive, battery, etc.) FIG. 24 shows a valve that works like a spring-loaded mouse trap to pinch the pipe closed quickly. A damper prevents excessively quick closure, which may cause pressure waves in the moving fluid. Rotary and linear dampers are commonly available for many such applications. Other valves described above are also applicable to this situation.

Yet another kind of valve would consist of two sealer bars, longer than the pipeline's diameter. The bars may have a circular or triangular aspect facing the pipeline, a shape which presses the pipe walls together without cutting the pipe. The sealer bars can be plastic-coated metal (e.g., iron), or merely heavier blocks of a hard and tough plastic, possibly reinforced with wire, cable, or metal.

In one embodiment, FIG. 27a, the upper bar has two holes, one at each end, and the lower one has two screws mounted in fixed positions, with their threaded shanks extending up through the holes in the upper bar. Above the upper bar two gears or disks are threaded onto the screw shanks, and an electric or spring wound motor is provided.

Upon receiving a signal to seal the local segment, the motor applies a turning force to the two disks or gears that causes the two bars to clamp together, thus sealing the pipeline. By providing adequate down gearing the line can be sealed in a short time.

In another embodiment, FIG. 27b, the upper and lower bars are connected by 2 steel cables, one on each side, that can be rolled up by a spring loaded mechanism, for example onto a coil spring mounted over the upper bar. In this case the energy required to initiate the sealing of the pipeline can be minimal, just enough to trip the release of the spring mechanism. The spring can go through gears that reduce its speed and increase its force, or a damper (not shown) can prevent excessively fast closure. The sealing device can be activated by an electrical signal that trips a solenoid that releases the coiled spring energy to roll up and retract the steel cable on both sides to seal the pipeline.

All sealer mechanism parts (including bars, cables, screws, gears, springs, etc.) can be made of plastic, so long as such parts are sufficiently thicker, harder, stronger, and/or tougher than the pipeline they are intended to seal.

When the valve closes, there will be force tending to move the valve caused by the difference in pressure between the outside and the inside of the pipeline. In typical pipeline construction, the valves are often anchored in the soil with thrust blocks. However, when dealing with welded or mechanically joined pipe segments, the valves may be attached to the pipe without thrust blocks. In order to resist this force, the sealing bars may be attached to the pipe wall in the manner of FIG. 27. The restraint would be on both sides of the valve, because the leak can be on either side.

### Benefits:

This system of linked gauges and transmitters makes it much easier to monitor the performance of an undersea plastic pipeline carrying, for example, methane gas or gaseous or liquid CO₂. If there is a break or significant leak, this will generally be detectable.

If the pipeline is cut by a ship anchor, a) all sensors beyond the break may cease to be “visible” to the monitoring station, and/or b) in the case of a hole there may be anomalies in the pipeline's internal pressure, as detected by the strain gauges. For example, pressures in the vicinity of, and beyond the break/hole, in the direction of flow, will drop off.

### Implementation:

All existing methodologies for the laying of undersea telecommunications cables should be (more or less) directly applicable to instrumented plastic fluid lines. More, the pipe may be sufficiently flexible to allow folding or pay-out as from a wire-guided torpedo. Joint-less plastic pipelines may be extruded and rapidly cured from raw materials on-ship, eliminating the need to pre-manufacture and pre-load large coils of pipe on ship, or to join pipe segments together. Such joints are possible weak spots and require high skill, consistency, and inspections to eliminate errors.

Rather than use connectors to attach the electrical cable to the sensing devices, it may be preferable for both power take off and packet transmission (by the sensors) to occur via induction. That is, a single unbroken network cable can be reeled out (or manufactured on ship) and attached to the pipeline. Then each sensing device can have an inductor unit (say 1 foot long, or long enough to encompass several wave lengths) clamped to this cable. Thus the pipeline, the cable, and local sensors would all be sealed and break-free.

Pipelines for transport of gaseous methane and liquid CO₂ are feasible to operate without pump stations, because they can be density driven. Methane gas will naturally rise to areas of less pressure, which is the desired behavior to recover it for land based or sea surface use, and CO₂ below a certain depth is denser than water so it naturally sinks, which is desired when it is being conveyed to a deep sea facility for sequestration.

### FURTHER EMBODIMENTS

In another embodiment the local sensing devices may be powered by batteries or microbial fuel cells whose life is forecast to equal the service life of the pipeline.

In a continuously formed pipeline, which is formed on the ship, it is possible to embed pressure sensors directly into the pipe wall. In this manner the sensing units can obtain direct pressure readings of the fluids in the pipe. However, this introduces inhomogeneity and possible weakening, and may significantly increase the costs of the pipe formation process and equipment, over that of merely attaching external sensors.

### 17. SUBMERGED SUPERCRITICAL CO₂ PROCESSES

### Capron

Components of the PODenergy system operate near the conditions needed for supercritical CO₂. Therefore the technologies explained in herein can be applied to support processes requiring supercritical CO₂.

Supercritical CO₂ can replace traditional organic solvents. It is not considered a volatile organic compound (VOC). VOCs are regulated as air pollutants and can be hazardous. When withdrawn from the environment, it may be returned to the environment without increasing greenhouse gas concentrations.

Above critical values, CO₂'s liquid-vapor phase boundary disappears. Further, its fluid properties can be tuned by adjusting pressure and temperature. Supercritical CO₂ has the density of a liquid, but exhibits the diffusivity, surface tension, and viscosity of a gas. That is, it can be pushed through a pipe with relatively little friction. It can penetrate more quickly into porous solids. Meanwhile, it has the density to be a powerful solvent. Specifically, oils and other organic liquids, will dissolve in supercritical CO₂. Because the solvent power can be varied with changes in pressure and temperature, supercritical CO₂ is a tunable solvent.

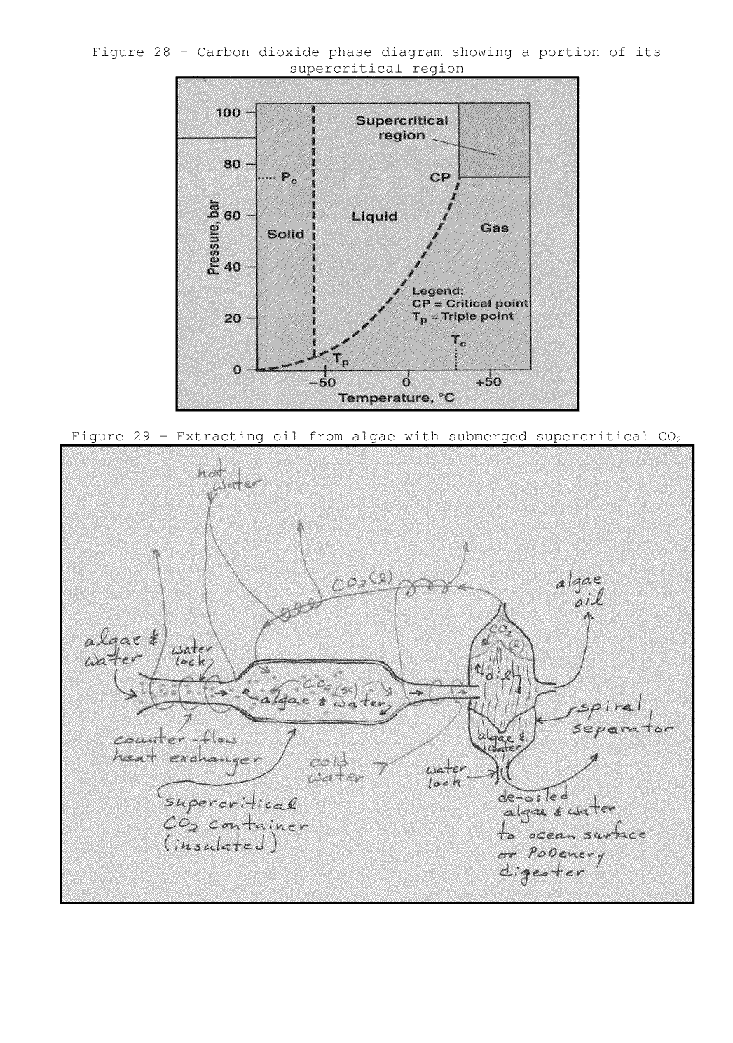

FIG. 28 is a phase change diagram for carbon dioxide showing the supercritical region in relation to typical ocean conditions. The critical temperature of CO₂ is 32.1° C., and the critical pressure is 73.8 bar (about 748 meters of water depth). In the deep ocean, pressures up to 400 bar are often available within a few hundred miles of land. While the ocean temperature at that depth will be about 25° C. lower than supercritical, it is feasible to insulate large plastic textile containers and heat them to temperatures which are well above supercritical but not so high as to inhibit their structural strength.

Commercial scale supercritical CO2 extraction processes include:
Coffee & tea decaffeination
Extract fatty acids from spent barley
Vitamin E oil, phytosterol, fatty acid methyl ester, ginger oil
Natural insecticide/pesticide (pyrethrum extract)
Hops extraction
Spices, flavors, aromas, natural products, colors

The above is not a complete list of supercritical CO₂ uses. There are small-scale operations and investigations using supercritical CO₂ for:
An alternative reaction medium replacing organic solvents;
A reaction medium with improved reactivity and selectivity;
New chemistry;
Improved separation and recovery of products and catalysts;
Polymerization, polymer composite production, polymer blending, particle production, and microcellular foaming;
Cleaning semiconductors; and
Producing micro- and nano-scale particles.

Like the processes explained in U.S. application Ser. No. 11/985,196, a tensile fabric structure containing supercritical CO₂ in the ocean can be made large inexpensively. That is: the submerged supercritical CO₂ process can revolutionize the chemical industry by removing the economic limits imposed by expensive pressure vessels.

One example—Currently, the production of biodiesel from algae is limited by the step of separating the oil from the algae. Because the oil separation step is equipment intensive, economies are sought by producing special algae. If the oil separation were relatively inexpensive, naturally occurring algae grown in naturally occurring conditions may be economic.

FIG. 29 is a schematic elevation of a submerged supercritical CO₂ process for harvesting oil from algae. It may be 1,000 meters or more deep (100 bar) and warmed to 40° C. or warmer. A large insulated textile container of supercritical CO₂ is maintained at the desired depth and temperature. A mixture of algae and water, harvested from the ocean surface, is processed through the container using waterlocks and other technologies from the earlier mentioned patent applications. As the algae, water, and supercritical CO₂ transit the container, the oil dissolves into the CO₂. The mix of de-oiled algae and CO₂ with dissolved oil is conveyed to a second cooler container where either reduced temperature or reduced pressure or both cause the oil to drop out of the CO₂. FIG. 29 shows temperature reduction to perhaps 20° C. using the ambient water, which is 5° C. It may not be necessary to liquefy the CO₂. That is the CO₂ may remain supercritical. Detuning the supercritical CO₂ to a lower temperature or pressure may be sufficient to cause the oil to drop out of the CO₂.

Inside the cooler container the pure oil, pure liquid CO₂, and algae/water blend stratify. Conditions will determine if the oil is more or less dense than the CO₂. FIG. 29 shows a spiral separator, also known as a cyclone separator. Any of many different processes for separating liquids of different densities may be employed.

The process shown in FIG. 29 can be integrated with the PODenergy system. For instance, the hot water may come from floating solar hot water heaters or co-generation heat from engines running on the PODenergy digester methane. The methane would come from anaerobic digestion of the de-oiled algae. Or the de-oiled algae may be returned to the ocean surface as fish food and to provide nutrients for the continued growth of algae.

### 18. SPARGING DISSOLVED GASES AT DEPTH

### Capron

There are many processes which need to recover dissolved gases. One example is recovering the CO₂ and CH₄ accumulated in the anaerobic digesters of the PODenergy system. The typical way to remove dissolved gas is to decrease pressure or increase temperature. Either reduces the equilibrium dissolved gas concentration.

However, the principle of partial pressure allows for a third alternative. Partial pressure refers to the pressure of one gas in a mixture. For example, air is a mixture of 21% O₂ and 80% N₂. That means the partial pressure of O₂ in air that is at 1-bar is 0.21 bar.

In an aquatic process, the bacteria or plants generate the gas directly into a dissolved state. For example, algae will dissolve O₂ into water approaching the 1-bar dissolved O₂ equilibrium concentration of 40 mg/L. This happens even though pumping air into water will not produce more than 8 mg/L of dissolved O₂. Similarly the anaerobic bacteria of the PODenergy system will be dissolving their produced gases up to the equilibrium concentration corresponding to a pure gas interface. They may even push the dissolved gases to temporarily exceed equilibrium concentration.

In general, the seawater in the PODenergy digester will be saturated with CH₄. But the dissolved CO₂ will be less than half the equilibrium value. However, when a bubble of CH₄ forms, the dissolved CO₂ in the surrounding seawater will “see” the initially pure CH₄ bubble with a partial pressure of 0-bar CO₂. That is, the CO₂ will come out of solution into the CH₄ bubble, over time, as the CH₄ bubble travels upward through the seawater. The CH₄ bubble accelerates as it expands with decreasing pressure and gathered CH₄ and CO₂. The relative amount of CH₄ and CO₂ in the harvested gas can be controlled by timing the formation of CH₄ bubbles to be close to the gas/water interface.

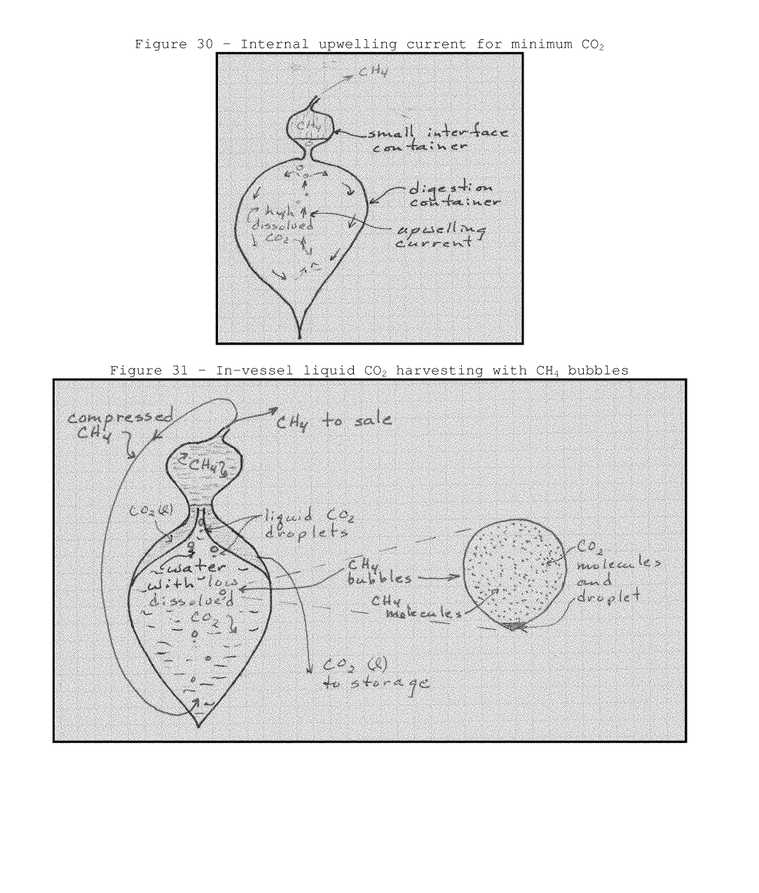

FIG. 30 shows an upwelling current and a small interface container. (Algae, waterlocks, moorings, and other components explained in the previous applications are not shown.) Because the equilibrium concentration of CH₄ will drop with dropping pressure, the CH₄ will tend to bubble out of solution near the top of the container and in a current carrying them upward. The current reduces the relative velocity of the CH₄ gas bubble, further reducing the amount of CO₂ filled water with which the bubble contacts before reaching the “top” bubble. The small interface container is a narrower space that reduces the area of CH₂ and seawater contact. This reduces the opportunity for CO₂ to come out of the seawater into the top CH₄ bubble. The small “neck” at the entrance to the small interface container reduces the chance for seawater to circulate past the CO₂/seawater interface and drop CO₂ out of solution.

When the entire digester is operated at the depth and temperature where CO₂ is liquid, the principles of partial pressure may be used to directly harvest liquid CO₂ at depth. At this depth and temperature, the CO₂ entering the CH₄ bubble will convert to liquid. The liquid CO₂ will then be left behind by the more rapidly rising CH₄ bubble. The bubbles of liquid CO₂ will continue to rise, but will also re-dissolve. However, one can envision employing pumped methane bubbles, as in FIG. 31 to move liquid CO₂ into a pool atop the seawater. In this arrangement the CH₄ will be as pure as the equilibrium situation for liquid CO₂ in gaseous CH₄. The concentration of CO₂ in the seawater depends on how much CH₄ is bubbled. More bubbles will require more energy to pump the methane.

Even in the conditions of liquid CO₂, it may be advantageous to minimize the thickness of liquid CO₂ through which the methane must pass. It may also be useful to minimize the area of CH₄ and liquid CO₂ interface. In FIG. 31, a stiff structure below the interface container allows for a thin layer of liquid CO₂. The thin layer is maintained by constantly pumping out the liquid CO₂.

TABLE B
Energy comparison extracting dissolved CO₂ or producing liquid CO₂

| Volume of | Start | End | Volume of | Energy to |
|---|---|---|---|---|
| CO₂ | pressure | pressure | CH₄¹ | compress² |
| (scm) | (bar) | (bar) | (scm) | (kWh) |
| 100 | 1 | 54 | 0 | 22 |
| 100 | 10 | 54 | 0 | 9 |
| 100 | 20 | 54 | 0 | 6 |
| 100 | 50 | 54 | 5,000 | 21 |
| 100 | 52 | 54 | 5,200 | 11 |
| 100 | 53 | 54 | 5,300 | 6 |

¹The “bubble” of CH₄ needs to have sufficient volume so that the volume of CO₂ inside the bubble will be at 1-bar partial pressure.
²The compression energy is calculated for isothermal compression as the scm of gas × 100 × ln(P_{b}/Bₐ)/3,600 kJ/kWh/50% efficiency. Numbers shown are based on air density, not adjusted for the lower density of CH₄.

Table B shows how the energy of compressing CH₄ to make bubbles differs for each situation. The top three rows represent compressing CO₂ gas from sealevel, 10 bars, and 20 bars to 54 bars, where it will transition into a liquid. Subsequent rows are based on compressing CH₄ from the indicated pressure. The compressed CH₄ then extracts dissolved CO₂ at pressure from the seawater. That is, the CH₄ bubbles provide a low partial pressure environment for the dissolved CO₂.

FIG. 32 zooms in on the small interface container area with a seawater spray. Wastewater engineers have known for decades that it is more energy efficient to dissolve O₂ in water by spraying water through air, instead of bubbling the air through the water. In addition to gas/liquid transfer issues and the difficulty of producing tiny bubbles for maximum surface area, water pumps are generally more efficient than gas compressors. CO₂ in the water droplets will move out of the droplets because of the low partial pressure of CO₂ in the surrounding CH₄. With the correct pressure and temperature conditions in the small interface container the CO₂ leaving the droplets will become a liquid. The liquid CO₂ and water droplets may be separated by any of many technologies used to separate liquids of different density.

The arrangement shown is particularly simple. When the seawater spray shown in FIG. 32 hits bottom, there will be a thin layer of liquid CO₂ over the seawater. The sprayed seawater will have to sink through the liquid CO₂ without picking up significant dissolved CO₂. The interior container arrangement is one way to ensure a very thin layer of CO₂. The static head (a measure of the energy required) of the pumped seawater is only the distance from the top of the seawater to the spray nozzle. Some pressure will be lost (energy expended) in the spray nozzle.

Any of these gas sparging processes may occur at some distance from and at different depths than the depth of the digestion container.

### 19. PRESSURE-HEAT SEPARATION OF DISSOLVED CO₂ AND SEAWATER

### Sudia, Capron

It may be useful to maintain a lower dissolved CO₂ concentration in the anaerobic digester of the PODenergy system. Hence there may be energy advantages to de-gassing dissolved CO₂ with heat. The operation could be performed in a continuous process. CO₂ is more soluble in water when cold and under pressure, as anyone can verify who opens a can of coke and puts it back in the fridge. It stays fizzier longer when kept cold, even till the next day.

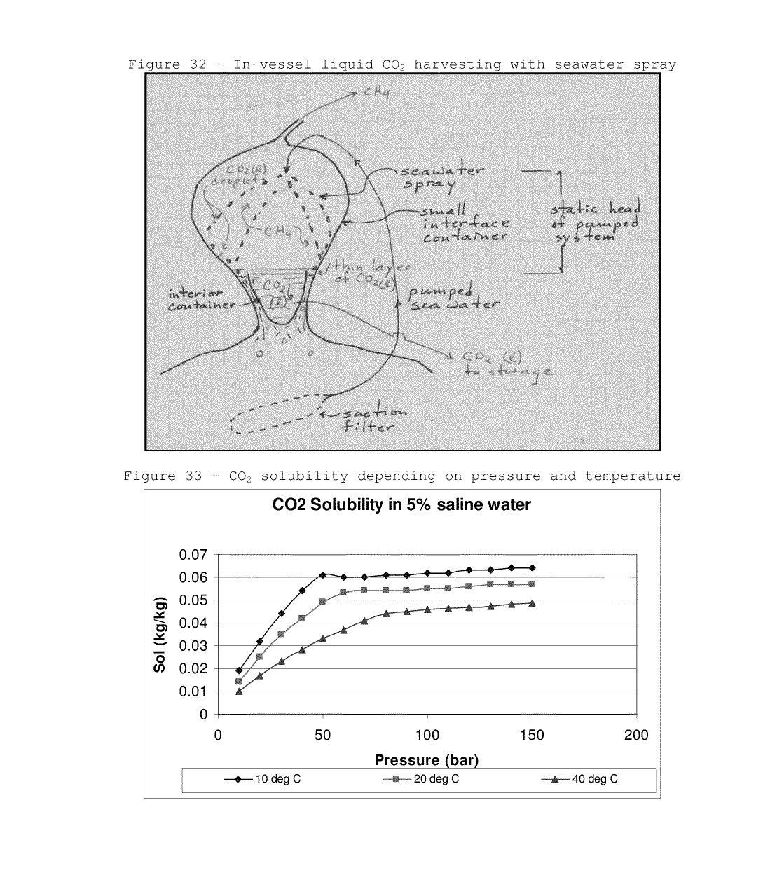

The pressure-temperature relationship of CO₂ is shown in FIG. 33. Suppose we wanted to maintain less than 0.02 kg/kg of dissolved CO₂ in our PODenergy anaerobic digester. We could maintain the digester temperature above 20 deg C. and perform the digest at a depth of less than 150 meters (pressure of 15 bar). Further, suppose our digestion container was as deep as 500 meters, cool as 10° C., and contained 0.04 kg/kg of dissolved CO₂. We could remove 0.02 kg/kg of dissolved CO₂ (half the CO₂), by lifting the liquid to 200 meters and raising its temperature to 40° C. Note that lifting a liquid that is submerged in a liquid of similar density requires very little energy.

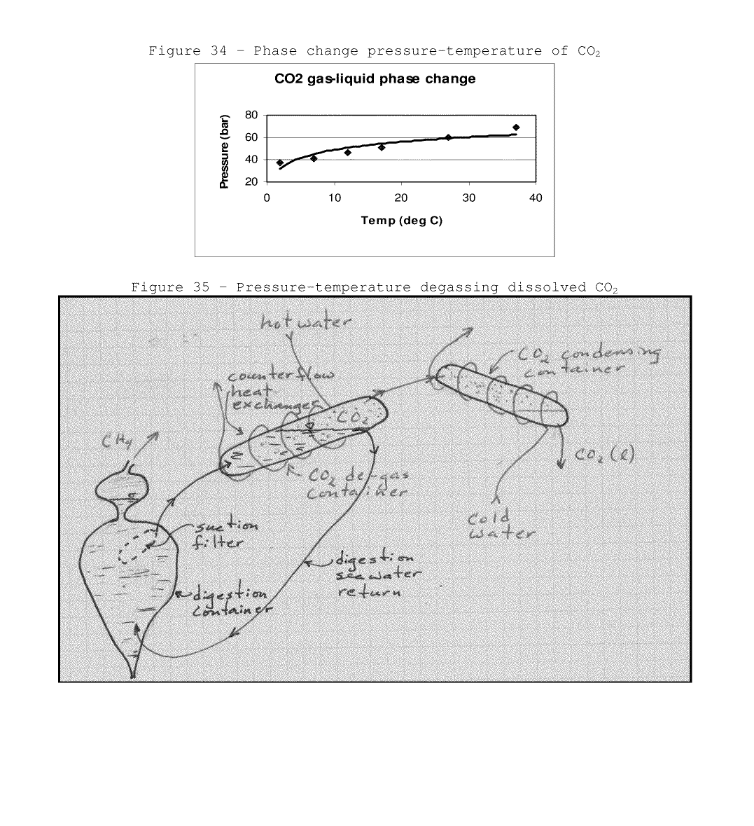

Referring now to both FIG. 33 and FIG. 34, note that CO₂ solubility with depth nearly levels out at about the same pressure-temperature condition as when the CO₂ changes phase from gas to liquid. That is, relatively little CO₂ will come out of solution as pressure decreases from 150 bar to 50 bar at typical ocean temperatures. Much more comes out of solution over the temperature-pressure range where CO₂ comes out of solution as a gas.

However, we can remove the dissolved CO₂ into a storage-ready liquid using the process shown in FIG. 35. The seawater in the digestion container picks up CO₂ and a little CH₄ (not shown) during the digestion process. The digestion seawater is pumped via a suction filter to the CO₂ de-gas container. On the way or in the de-gas container, the seawater is heated with a counter-flow heat exchanger. The heat may be warm ocean surface water, a solar hot water heater sitting on the ocean surface, or “waste” heat from other PODenergy system processes. The combination of increased heat and reduced pressure cause a good amount of CO₂ to come out of solution. The phase of the removed CO₂ depends on the conditions, but it is more likely to be a gas, shown here. The gas is chilled with ambient ocean water, which changes the gas into a liquid.

Note that the removed CH₄ would remain a gas. This allows separating the CH₄ from the CO₂ with any of several processes, including ones described elsewhere above. Should we choose to use a compression step, there are large energy advantages to starting compression from depth instead of sealevel. Table B compares the energy cost of compressing CO₂ for sealevel, 10 bar, and 20 bar (200 meters).

The features of CO₂ make for more options when employing the PODenergy system and processes integrated therewith. For example, a continuous digestion process is appealing, since it is assumed the other processes may be long lived. However a batch digestion process might also be desirable, if digestion is allowed to “complete” and then all digester water is resolved at once. With a series of small batches, NN m3 of water can be raised, warmed, detained until it separates, have the CO₂ siphoned off (so to speak) and then repeat with same batch size until huge vessel is processed. If we are merely patient, an equilibrium will be reached with mostly CO₂ above, mostly water below. We're in no big hurry, we sold most of the methane long ago, so this might be simpler than trying to “goose” the dissolved CO₂ to make it separate rapidly enough for a continuous process with a short residence time.

Liquid CO₂ should be an insulator, like SiO₂, due to its lack of free electrons. Perhaps a quilt of liquid CO₂ could surround warm or hot processes.

Rather than mimic a classical centrifugal separator, we can provide a simple vertical cylinder, sphere, or even an imperfect cylinder (like a wrapped piece of hard candy) formed by crimping the ends of a cylinder. Introduce the already separated fluids tangentially at the center of its length, do the automated water line sensing, and pump out the 2 fluids at either end. The conical bottom and domed top do not seem essential, though they would not hurt either. In the cheapest version, the 2 outlet pipes are simply bonded into the “crimp” at the ends of the large diameter vertical cylinder.

The de-gas or gas-to-liquid condensing container may also be a helix or other shape instead of a simple cylinder.

Seawater, which has ample free ions (Na⁺, Cl⁻), routine disassociation of H⁺, etc., is more electrically conductive than liquid CO₂, which as a molecule is far more tightly bound. Therefore, a vessel can be equipped with a series of pairs of electrodes deployed along a vertical line on an inner side wall (or possibly on a vertical pole in the middle). As the “water line” separating the liquid CO₂ from the water rises and falls, these pairs of electrodes will give an approximate reading of its position, which can be made more exact if desired by using more pairs of electrodes spaced closer together. However for most purposes, a vertical spacing of 1-2 inches between electrode pairs should be sufficient.

Besides electrical conductivity, other means of automatically sensing the dividing line between 2 separated liquids of different densities are available, including thermal conductivity, optical transparency & reflectivity, ultrasonic transparency & reflectivity, and many others known to those skilled in the relevant arts.

If dealing with two liquids, a clean separation of the 2 liquids can be achieved as follows. The liquid from the end of the container in FIG. 26* is piped into a much larger tank, which looks (and works) like a dust separator as seen atop industrial buildings needing to remove dust from their air exhaust. The incoming fluid enters near the top at the widest point, in a direction tangential to its circular shape. In the downward direction the tank is conical. Water is removed through a port at the bottom (point) of the conical section. In the upward direction the tank forms a dome, with liquid CO₂ taken off through a port either at the top, or near the top at one side.

Tank sizing and fluid flow rates must be adjusted to avoid formation of a vortex that would suck liquid CO₂ down the conical section. Meanwhile, since this operation is performed at a depth of −500 meters, we need a reliable way to adjust the flow rates to assure that the separation is working as planned. We achieve this by continually monitoring the “water line” using pairs of electrodes deployed along a vertical axis inside the separation tank. If we see that the “water line” has moved out of its desired range, either up or down, e.g., due to varying concentrations of dissolved CO₂ in the digester water, we increase or decrease our rate of pumping out the two respective fluids to move it back into its desired range.

It is possible that, at the desired flow rates, the degree of separation still may not be as exact as desired. In that case the process can be repeated on one or both output lines. That is, the output CO₂ line can be re-separated to remove excess water, and/or the output water line can be re-separated to remove excess liquid CO₂.

In other embodiments the final separation tank, with its pairs of electrode sensors, may not need to be centrifugal. A less expensive design might be sufficient, especially for very low flow rates. However the centrifugal design seems adequate, well known, and should not add significant cost (to a product that is all plastic film), so it may still be preferred.

In a preferred embodiment, to avoid turbulence, the “water line” as detected by the sensors in the centrifugal separator, should be kept nearly level with the “water line” of the fluids leaving the separation container. To determine where that line is, the separation container is further equipped, especially near the outlet end, with vertical poles bearing pairs of electrodes along their length. These sensors are read continuously to determine the height of the “water line” inside the separation container, and then the 2 rates of fluid pumping from the centrifugal separation tank are precisely and continuously adjusted to keep the “water line” for the latter tank as nearly level with that of the former as practical.

In another embodiment, the “water line” might be detected by a float of intermediate density, like the float in a toilet tank or an automobile gas tank. The float must float on seawater but sink in liquid CO₂. This can be achieved by providing a plastic bag or other vessel filled with less-saline water. However, such a float mechanism has moving parts, and its valid response to rapidly varying conditions might be slow. Therefore the solution of pairs of electrodes seems more appealing, due to no moving parts and rapid response time to changing conditions, as rapidly as we care to sample it.

The electrode solution is not without problems as well. The electrode pairs may become fouled with organic or other unknown matter from the digester effluent. Accordingly the raw digester fluid must be strained to remove large items, and means should be provided to either shield the electrode pairs from potential foulants and/or to provide a periodic, or continuous in-place, or self-cleaning process. Hopefully the great bulk of organic or unknown matter is safely reposed in sediment at the bottom of the digester, so our exposure to it should be minimal.

The horizontal version of a liquid CO₂ separation chamber could be further enhanced by configuring its (say) 500 foot length into 1) a circle, like a circular fluorescent light, 2) a spiral all at substantially equal depth, or 3) a helix (say) 50 feet in diameter (say 150 feet in circumference) with a shallow rate of rise. This latter embodiment could allow for a more compact deployment of the separator at 500 meters depth, and greater ease of warming the separation chamber with surface water using less external tubing to conduct the warm water. The gradual rise of several (say 15) meters from one end of the helix to the other will not be a significant water pressure differential, since we are still near 500 meters below sea level.

In yet another embodiment the helix could be suspended in a single larger tank containing a circulating flow of warmer surface water. Such warmer surface water could be introduced at the top of the outer tank, adjacent to the warmest liquid CO₂ rising up in the helix. Upon contact with the helix containing cold liquid CO₂ it will start to get colder, and thereupon sink towards the bottom of the tank, where it is pumped out and returned to the ambience.

In batches, NN m3 of water can be raised, warmed, detained until it separates, have the CO₂ siphoned off (so to speak) and then repeat with same batch size until huge vessel is processed.

### 20. GATHERING H₂O AND CO₂ FROM CH₄ POWER PLANT EXHAUST

### Capron

The processes explained in U.S. application Ser. No. 11/985,196 are useful for sequestering CO₂ from power plant exhaust. Existing energy production from CH₄ includes N₂ with the oxygen. The combustion systems are arranged to employ or work around N₂ as a “filler” expansion gas in a piston or heat intensity control in combustion chamber. The combustion processes have to be controlled to reduce formation of NOₓ. The high proportion of N₂ in exhaust increases the difficulty of harvesting pure CO₂ and H₂O from the exhaust gas.

Manufacturers of oxygen purifying equipment including Air Products and AirSep acknowledge they have not been asked to provide on-site oxygen supply equipment where energy efficiency is the primary criteria, and certainly not on the scale proposed. It is possible to produce oxygen cryogenically or with pressure swing while recovering nearly all the energy. A more efficient cryogenic process would make better use of cross-flow heat exchangers wherein the warm incoming air is chilled by the separated cold oxygen and cold nitrogen. A pressure swing process would recover the compressed gas energy. While difficult to estimate the economics, it is likely the energy cost of combusting on pure oxygen will drop below 4% of the produced energy.

Note the above costs do not include an anticipated improvement in the combustion process electrical energy efficiency, the reduced cost of recovering more exhaust heat due to the high steam content, or the value of water recovered from the exhaust. An understanding of combustion processes suggests that not introducing nitrogen allows adjusting many variables and some of those adjustments should result in better electrical efficiency.

The technologies explained above and in U.S. application Ser. No. 11/985,196 can be applied to this situation. Specifically, the submerged pressure swing adsorption (PSA) would provide pure O₂ from air. PSA is generally most economic providing 90-95% pure O₂, with the balance primarily N₂. When retrofitting existing power plants, it may be necessary to replace the nitrogen with steam or water vapor to provide a “filler,” more chemical-to-electrical efficiency, more economic heat recovery, and low pollutant levels similar to those from a fuel cell running on natural gas. The chemical formulae below show how the fraction of nitrogen in with the oxygen affects the fraction of water molecules in the exhaust of natural gas fueled combustion. Note in actual combustion, there is generally some excess air (lean burn) to ensure all the fuel is consumed.

Air input generates 18% steam, 9% CO₂:

8N₂+CH₄+2O₂→8N₂+CO₂+2H₂O

50% N₂ with steam input generates 55% steam, 20% CO₂ after condensation:

4N₂+CH₄+2O₂+4H₂O→4N₂+CO₂+6H₂O

20% N₂ with steam input generates 70% steam, 70% CO₂ after condensation:

2N₂+4CH₄+8O₂+6H₂O→2N₂+4CO₂+14H₂O

10% N₂ without steam input generates 62% steam, 82% CO₂ after condensation:

2N₂+9CH₄+18O₂→2N₂+9CO₂+18H₂O

0% N₂, without steam input generates 67% steam, 100% CO₂ after condensation:

CH₄+2O₂→CO₂+2H₂O

Another approach is to continue to employ air in the combustion process, and then use other PODenergy system components to capture the CO₂ and H₂O. These include:
Submerged PSA performed on the exhaust gas; and
Cooling and compressing the exhaust gas in the ocean precipitating a phase change of the CO₂ to liquid.

The submerged PSA process can address either the purer O₂ or the purer CO₂. Such submerged cooling and compression is appropriate for any amount of N₂, and would be particularly useful for removing smaller concentrations of N₂ during the CO₂ condensation step.

The process listed in Table C as “PSA for 50% O₂” consists of 1) Compress air through a submerged PSA to produce a gas that is 50% O₂ for combustion. 2) Condense water out of the exhaust gas, perhaps recovering energy with any of many heat-to-electricity devices. 3) Compress and cool the remaining exhaust gas in a submerged CO₂ separation device, like that explained in 61/335,811. 4) Store the liquid CO₂ or ship it for enhanced oil recovery.

The process listed in Table C as “PSA for 90% O₂” is the same as that for 50% O₂, except the O₂ is higher purity.

The process listed in Table C as “PSA of air-CH₄ exhaust” consists of 1) Fuel combustion with air. 2) Condense water out of the exhaust gas, perhaps recovering energy with any of many heat-to-electricity devices. 3) Compress the remaining exhaust gas through a submerged PSA to produce a gas that is 90% CO₂. 4) Compress and cool the remaining gas in a submerged CO₂ separation device, like that explained in 61/335,811. 5) Store the liquid CO₂ or ship it for enhanced oil recovery.

The process listed in Table C as “Blow air-CH₄ exhaust into a kelp forest to dissolve CO₂” consists of 1) Fuel combustion with air. 2) Condense water out of the exhaust gas, perhaps recovering energy with any of many heat-to-electricity devices. 3) Blow (small bubble diffusers) the remaining exhaust gas in a floating aquatic plant forest. 4) Allow the aquatic plants to extract the C from the CO₂. 5) Harvest the aquatic plants into the PODenergy anaerobic digestion system. 6) Produce pure CO₂ via the PODenergy process. 7) Store the liquid CO₂ or ship it for enhanced oil recovery.

TABLE C
Energy expense for different power plant CO₂ sequestering arrangements

| | | | | | | | | | 20% |
|---|---|---|---|---|---|---|---|---|---|
| | | | | | | | | | of |
| | | | | | | | | | power |
| | | CH4 | | | | | | | in |
| | | demand, | Volume | | | | Water | | steam |
| | | full | of air | | | | from | | btwn |
| | Power | capacity, | or | | | Power | exhaust | Water | 150° C. |
| | plant | 50% | condensed | Start | End | to | (liters | from | and |
| | capacity | eff. | exhaust | pressure | pressure | compress¹ | per | exhaust | 15° C. |
| Process | (MW) | (scm/day) | (scm) | (bar) | (bar) | (MW) | day) | (af/yr) | (MW) |
| PSA for | 100 | 480,000 | 3,500,000 | 1 | 5 | 13 | 780,000 | 230 | 5 |
| 50% O₂ | | | | | | | | | |
| Compress | | | 2,400,000 | 1 | 54 | 22 | | | |
| & cool | | | | | | | | | |
| O₂—CH₄ | | | | | | | | | |
| exhaust | | | | | | | | | |
| to | | | | | | | | | |
| liquify | | | | | | | | | |
| CO₂ | | | | | | | | | |

| Sum of two steps above | | | | | | 35 |
|---|---|---|---|---|---|---|
| PSA for | 100 | 480,000 | 4,600,000 | 1 | 5 | 17 |
| 90% O₂ | | | | | | |
| Compress | | | 590,000 | 1 | 54 | 5 |
| & cool | | | | | | |
| O₂—CH₄ | | | | | | |
| exhaust | | | | | | |
| to | | | | | | |
| liquify | | | | | | |
| CO₂ | | | | | | |
| Sum of two steps above | | | | | | 23 |
| PSA of | 100 | 480,000 | 4,320,000 | 1 | 5 | 16 |
| air-CH₄ | | | | | | |
| exhaust | | | | | | |
| Compress | | | 530,000 | 1 | 54 | 5 |
| & cool | | | | | | |
| 90% CO₂ | | | | | | |
| exhaust | | | | | | |
| to | | | | | | |
| liquid | | | | | | |
| Sum of two steps above | | | | | | 21 |
| Blow | 100 | 480,000 | 4,300,000 | 1 | 2 | 7 |
| air-CH₄ | | | | | | |
| exhaust | | | | | | |
| into a | | | | | | |
| kelp | | | | | | |
| forest | | | | | | |
| to | | | | | | |
| dissolve | | | | | | |
| CO₂ | | | | | | |
| Compress | 100 | 480,000 | 4,300,000 | 1 | 54 | 40 |
| & cool | | | | | | |
| air-CH₄ | | | | | | |
| exhaust | | | | | | |
| to | | | | | | |
| liquify | | | | | | |
| CO₂ | | | | | | |

¹The compression energy is calculated for isothermal compression as the scm of gas × 100 × ln(Pb/Pa)/3,600 kJ/kWh/50% efficiency. It has not been adjusted for gas density.

The process listed in Table C as “Compress & cool air-CH₄ exhaust to liquify CO₂” consists of 1) Fuel combustion with air. 2) Condense water out of the exhaust gas, perhaps recovering energy with any of many heat-to-electricity devices. 3) Compress and cool the remaining gas in a submerged CO₂ separation device, like that explained in 61/335,811. 4) Store the liquid CO₂ or ship it for enhanced oil recovery.

### 21. FLOATING KELP FOREST, MARK E. CAPRON

It may be convenient to employ the PODenergy system an ocean current. Ocean currents generally circle the world's oceans so that most near (several hundred miles) shore locations have a current. The speed and direction of a deep-water current is often different from that of the surface water current. The current can serve to maintain high dissolved CO₂ seawater flowing through a stationary aquatic plant forest. The plants will be removing dissolved CO2. Without a current, aquatic plant growth may be limited by the rate of CO₂ transfer from the atmosphere or from nearby CO₂ producing power plants. When employing the stationary aquatic plant forest as part of a PODenergy system, the recycled nutrients would be released upstream in a dispersed manner that causes their adsorption by the forest.

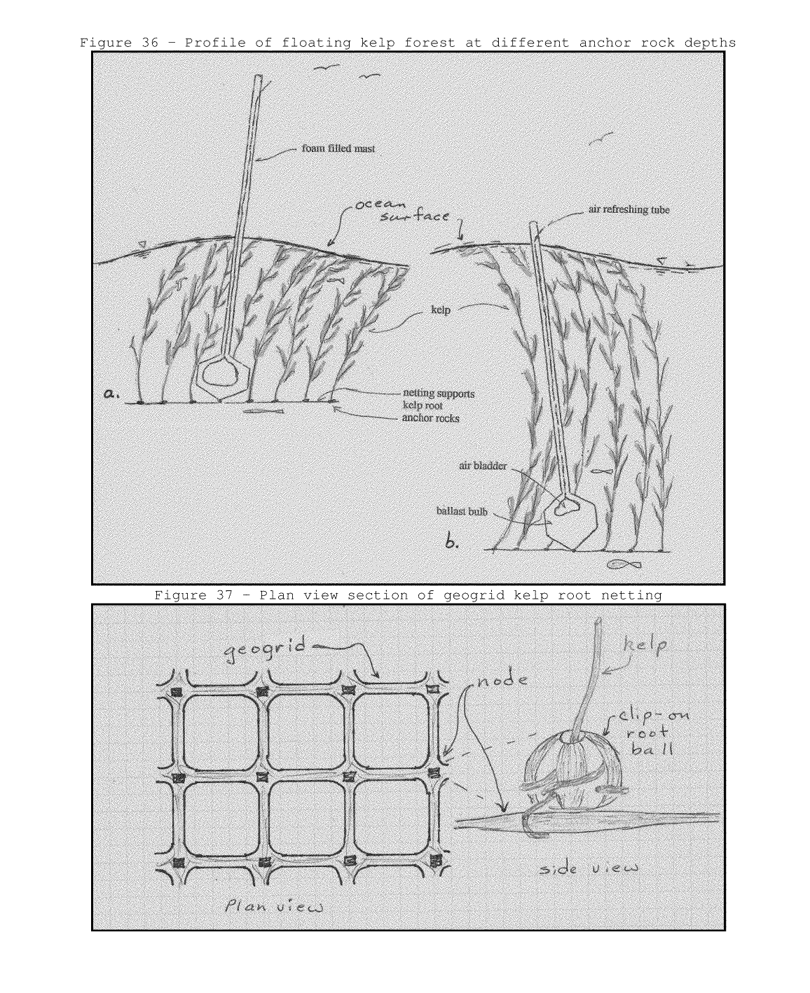

Some aquatic plants, notably kelp, will strongly attach to rocks. Synthetic anchor rocks can be produced from ceramics with neutral buoyancy. FIG. 36 shows how such rocks may be woven into a net that is moored to remain in one location. A special buoy may be employed to adjust the depth of the anchor rocks.

FIG. 36a shows the kelp bed at minimum depth, just after harvesting, with a gentle wave on the ocean surface. The seafloor might be 1,000s of meters below the kelp roots. In FIG. 36a, the buoy air bladder has been inflated to raise the neutrally buoyant moorings, netting, and anchor rocks. (Moorings not shown.) The air may be supplied from a high-pressure flask in the mast. Instrumentation would allow for automatic and radio control of the netting depth. Batteries and the air flask would be refreshed when harvesting the kelp. Alternatively, solar photovoltaic, microbial fuel cells, or other power system allows a longer time between buoy maintenance visits. Selecting appropriate buoyancy per length of mast allows stable depth control, even though the air compresses with depth.

FIG. 36b shows the kelp roots at maximum depth, perhaps 20 meters, just before harvesting the kelp bed.

The kelp may be harvested in any of several ways. The kelp can be mowed by boats with cutting devices. The kelp can be mowed with open harvesting bales and tow ropes as shown above. Alternatively, swaths of netting can be rolled up with the kelp attached to form large bales. Or long strings can be pulled through a continuous feed digestion process described elsewhere above.

The typical rope employed as netting and the ceramic rocks will be a large expense for kelp forests extending for hundreds of square miles. An alternative construction, FIG. 37, would employ a particularly large-gapped geogrid. Typical road construction geogrid, such as the Tensar geogrid, has openings of a few inches in length and width. The geogrid for kelp forest netting would have openings more than a foot in length and width. Instead of ceramic rocks at each grid intersection, the plastic could be formed as an enclosure for kelp roots. The plastic at nodes may be coated with or have embedded a material that is attractive to kelp roots, such as granite dust, sand, or a ceramic.

Over time, shellfish growing on the buoys and netting will add weight to the entire structure. The extra weight may cause sags between buoys. However, slowly developing sags won't change the depth to the top of the kelp. Additional air in the buoys and occasional shellfish harvesting may be necessary.

### 22. METHOD OF FERTILIZING AN OCEAN REGION

### Sudia

To address the crisis of global warming, it is not only necessary to reduce CO₂ emissions but to radically reduce existing atmospheric CO₂ levels. One way to achieve this result is to cultivate large amounts of biomass to extract legacy CO₂ from the atmosphere. There is not enough terrestrial water or land available to cultivate such a large amount of biomass, hence it is desirable to develop large offshore farms for algae, plankton, and seaweed, covering up to 6% of the world's ocean surface. (See prior works of M. E. Capron.)

Massive oceanic farming of biomass encounters a variety of issues. The open ocean surface is relatively sterile, due to lack of nutrients. Most plant growth and associated system development occurs in areas of upwelling, where various types of ocean currents bring up colder nutrient laden water from deeper depths.

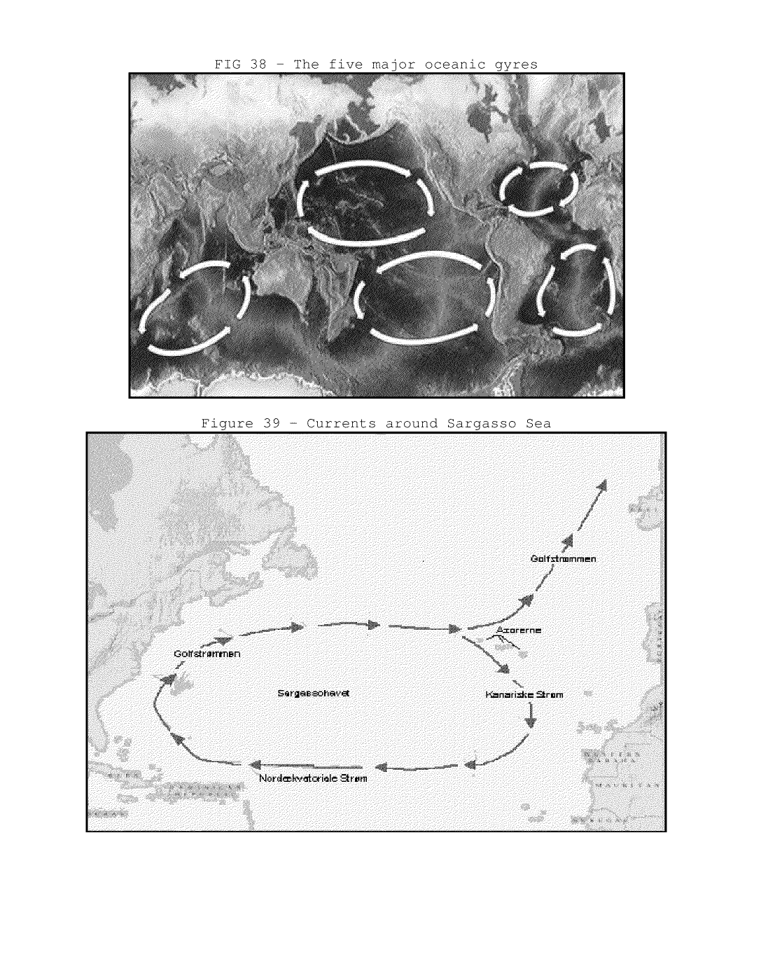

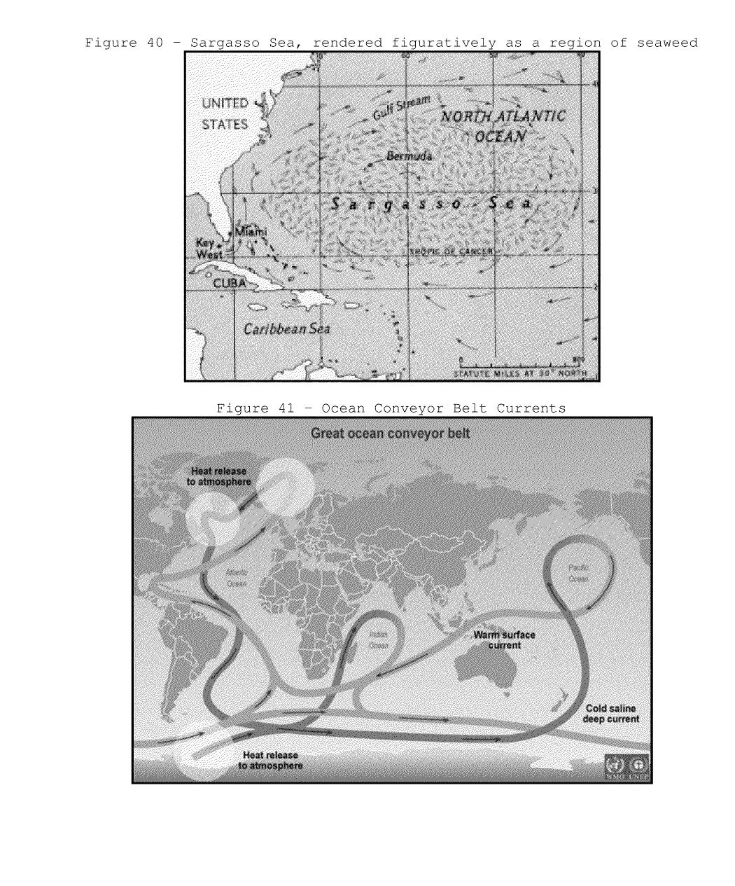

To carry out massive oceanic farming of biomass we require large new areas of ocean, in addition to those already producing biomass, and we may prefer them to be located in areas of minimal lateral surface current, to minimize the departure of the generated biomass. Such areas occur in many places, especially the 5 large oceanic gyres (See FIG. 38), which are areas surrounded by circular current flows. For example the Sargasso Sea (see FIGS. 39-40) is such an area in the North Atlantic. Also the existence of extensive areas of plastic trash in (e.g.) the North Pacific Ocean is indicative that surface matter is being trapped by circular ocean currents there.

In addition we also desire that these new areas be fertilized by nutrient rich water from lower depths. This can be achieved using mechanical pumps to pump colder water from lower levels, but this is somewhat energy consumptive. Hence it may be preferable to devise another way to get cooler water to rise in a desired area, via an artificial upwelling, by somehow harnessing natural forces.

As it happens such a natural force exists, very close to several of the desired locations (central oceanic gyres), in the form of the deep oceanic conveyor belt currents (FIG. 41).

Based on studies of isobaric deep sea floats tracked by sonar, Susan Lozier et al (“Interior Pathways of the North Atlantic Meridional Overturning Circulation,” Amy S. Bower, M. Susan Lozier, Stefan F. Gary & Claus W. Böning, Nature May 14, 2009) question that there is a distinct deep cold current in the North Atlantic, giving rise to the suggestion that the southward interior pathway is more important than the deep water boundary current (DWBC) as previously thought. However this does not change the basic thrust of our discussion.

### Description:

Some nutritional oceanic upwellings result when cold currents encounter obstacles such as reefs, islands, “banks” or rock formations that can force the colder waters towards the surface. The goal is not to necessarily bring actual sea floor water all the way to the top, but rather to induce a disturbance at a deep level that in turn can cause nutrient rich waters at intermediate levels to mix with surface waters, thereby fertilizing the latter.

To this end, we propose to anchor “artificial lumps” or “inverted ski jump ramps” (FIG. 42) in specific locations on the ocean floor where they will intercept deep cold currents and force an upwelling, preferably an upwelling of intermediate water to the surface, because we do not wish to disturb the global oceanic circulation of the cold deep current, which could have deleterious effects on the climate of one or more terrestrial regions.

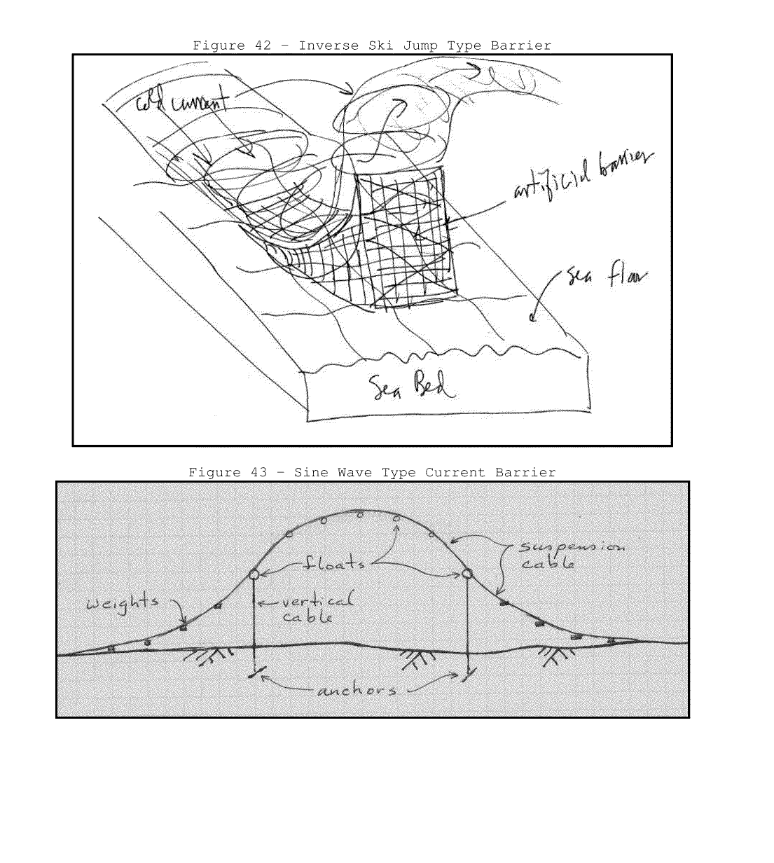

To achieve an upward disturbance that is not overly disruptive of the original flux of the cold deep current, we may engineer the artificial barrier with a cross section in the form of one or more smooth waves (FIG. 43) of a sinusoidal or parabolic character. In this manner, the deep current will be forced upward for an interval, but will return to its original path with minimal disturbance or turbulent flows. This may be sufficient to perturb the upper layers, causing mixing of middle and top layers.

FIG. 43 shows a side elevation of one practical construction of a current upwelling device. It would be repeated when constructing a double sine wave.

Each unit of width requires only two supporting floats tethered to the ocean floor with two vertical cables. The weighted suspension cable forms an upward facing parabola, while floats force the suspension cable into a downward facing parabola. The structure would have width in and out of the page. The floats may be gas-filled tubes and the weights may be ooze-filled tubes with tube length equal to the overall structure width. The suspension cable may be a sheet of plastic or a combination cable, geogrid, and plastic sheet.

Extra care maybe required to firmly anchor these structures to the sea floor, due to the Bernoulli effect, which may cause a strong vertical lift due to the increased fluid flow across the surface area.

Given the very large size of these proposed current disturbance barriers, to build one using conventional materials might be the equivalent of several large suspension bridges, and thus would be extremely costly, to say nothing of dangerous given the remote and inhospitable conditions and the presence of a strong cold deep current.

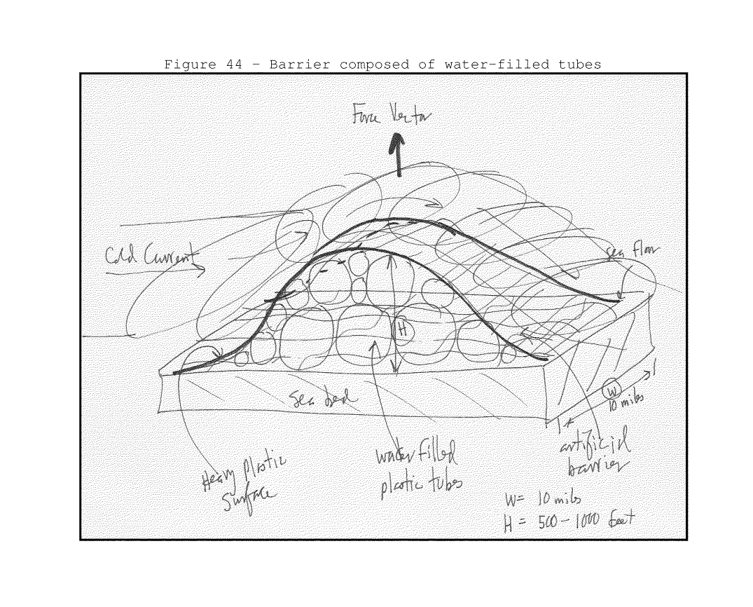

Therefore, to save expense it may be preferable to construct the barrier using entirely plastic film materials (See FIG. 44), including plastic sheets and water filled tubes. In this embodiment, a current barrier to promote an upward disturbance is formed by using submersible robotic craft to place a configuration of non-inflated plastic tubes and sheets on the sea floor, including adequate cables or ropes (not shown) attached to anchor pylons (not shown) sunk into the sea floor.

Once the configuration of materials is complete, a water inlet can be opened into the current itself, conveying pressurized water into the internal tube structures, thus using the deep ocean current's own force to inflate the structure. Once inflated the inlet and associated valves can be closed, leaving the structure in its permanent position.

A series of valves can be opened and closed in sequence to inflate the structure in a controlled manner, starting with the bottom or foundational water filled plastic tubes, and proceeding to the upper ones. Each layer of tubes will be filled and sealed before proceeding to the ones above it.

As the process of inflating the deep ocean current barrier proceeds, the forces exerted on the barrier (both laterally and vertically downward) by the current will increase. Toward the upper levels the natural force of the current entering the water inlet might not be enough to counteract the forces pressing down on the newly inflated structure. Then we can switch to conventional water pumps, lowered to the work area, powered by electricity or other suitable means.

The plastic tubes in the current deflection barrier may be the same as those employed for any of other subsea processes described herein.

It is arguable that the prevalence of seaweed and other marine life in the North Atlantic Gyre or Sargasso Sea may be the result in part of irregularities in the sea floor disturbing deep ocean currents and promoting mixing of intermediate nutrient rich waters with surface waters that ordinarily might be relatively sterile.

However, the central ocean gyres are not as productive as the areas of upwelling, which are mainly a coastal phenomenon. Hence a goal of the present invention is to provide an artificial upwelling in a central ocean area that is otherwise suitable for cultivation of biomass, due to its minimal lateral surface currents.

The presence of this artificial barrier should promote the development of a rich area of biomass creation including algae, plankton, seaweed, and diverse fish species, among others. In other words, an artificial Grand Banks, George's Bank, or Dogger Bank.

To promote safety and maintenance, the current barriers will be instrumented with an array of sensors, to detect any problems, such as leakage of the tube structures, changes of the barrier's shape, the arrival of any intrusions such as submarines or sunken surface vessels, trash dumped from the surface, accumulation of unusual amounts of sediment, and the like. Such sensors can take the form of video cameras, as well as the usual sensors of temperature, pressure, current flow, salinity, dissolved oxygen, and the like.

For example, if the deep ocean current shifts to another location, we can detect that and possibly deflate the structure, move it to a new location, re-anchor and re-inflate it. In the case of a structure composed of water filled plastic tubes (or the like) the cost of such relocation, while significant, would be far less than for structures composed of conventional materials such as concrete or steel.

Plastic structures herein are described as “tubes” because this is the most common and inexpensive form in which such plastic films are supplied.

However, any form of plastic can be used. For example a current barrier structure could be formed of plastic sheets bonded together into tent like structures or other geometric forms. However, given the rigorous conditions on the sea floor, it is believed that tubes will be the easiest to deploy, because they can be easily fabricated, packed, transported, placed, unrolled, composed into structural configurations, and inflated. The same cannot be said for custom-fabricated structures, especially when very large undersea objects are contemplated.

### 23. MOBILE SUBMERGED PROCESSES

### Sudia, Capron

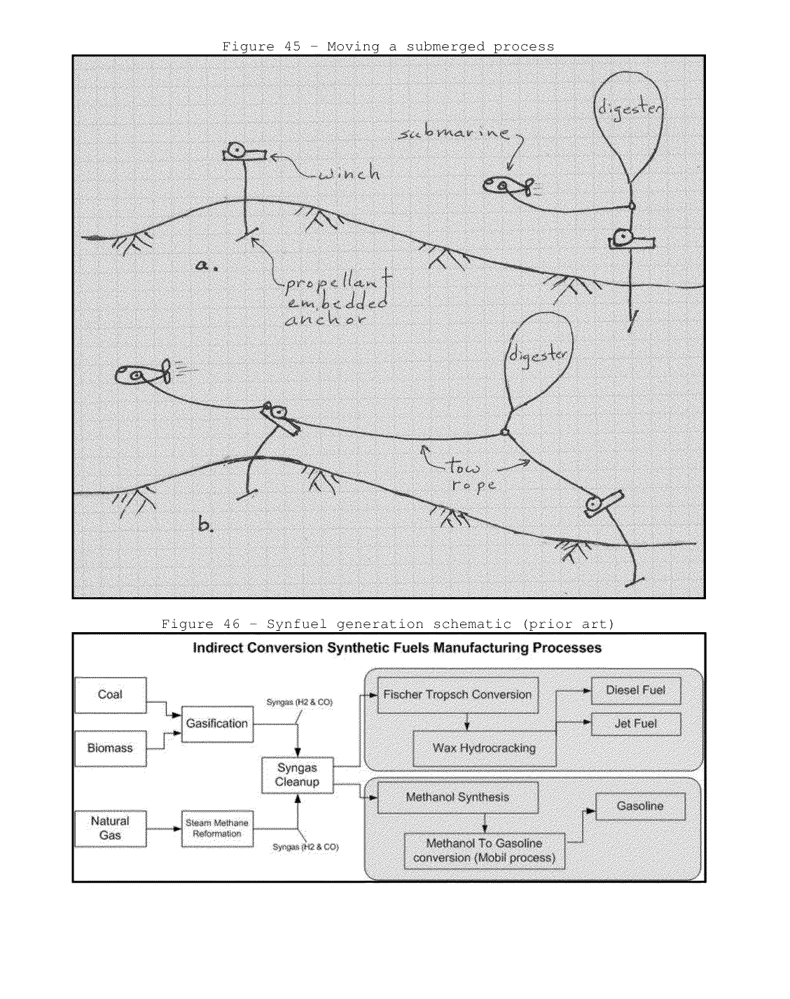

It may be desirable to move the undersea equipment mentioned in this and related applications from time to time. This can be accomplished with an anchored towing cable. FIG. 45a shows one end of a tow rope attached to a submerged digestion container while a tow-rope deploying submarine swims to a new location. The submarine does not tow the digester. The remote end of the tow rope attached to a winch at the new desired location. The winch is anchored to the seafloor.

FIG. 45b shows the submarine taking a tow cable to a subsequent location as the winch slowly moves the digestion container, which has detached from its previous anchor. Some means of controlling the depth of the digester is necessary, such as by attaching adjustable ballast or motorized thrusters, but is not shown. The depth controlling means may be a combination of a surface buoy above and a weight below the digester. Depth control may also be accomplished with a weight that rolls over the seafloor and reels in or out on a depth control wire to adjust for seafloor topography. Depth controlling means are not shown.

There is a “tow back” cable paying out from the winch at the initial anchor point. By leaving the tow cables and anchors in place, a network is gradually built. The network eventually allows moving any submerged process to any previous location without the submarine or new tow rope. Winches may be left in place or moved as necessary. A series of the moves shown in FIG. 45 may be needed to cross subsea “mountains” and canyons.

The winches are shown as buoyant a few meters above the seafloor to keep them from being buried by marine snow. Actually, only a “locator buoy” above the anchor need be elevated above the seafloor. The winches can be equipped with sonar beacons to help find them for maintenance, or they can just be conspicuously shaped objects that are easy spotting with active sonar.

### 24. GAS TO LIQUID (GTL) SYNFUEL PROCESS

### Sudia, Capron

There is extensive prior art relating to synfuels processes in general, and gas to liquid (GTL) synfuels processes in particular. The following is a sample of recent patents, patent applications and other reference material in the field, which may or may not be relevant to the herein described invention.

| | Partial Title |
|---|---|
| U.S. Pat. No. | |
| 5,733,941 | Hydrocarbon Gas Conversion System |
| 5,861,441 | Combusting A Hydrocarbon Gas To |
| 6,011,073 | System And Method For Converting |
| 6,172,124 | Process For Converting Gas To Liquid |
| 6,225,358 | System And Method For Converting |
| 6,239,184 | Extended Catalyst Life Fischer-T |
| 6,262,131 | Structured Fischer-Tropsch Catal |
| 6,277,338 | System For Converting Light Hydr |
| 6,277,894 | System And Method For Converting |
| 6,313,361 | Formation Of A Stable Wax Slurry |
| 6,344,491 | Method For Operating A Fischer T |
| 6,512,018 | Hydrocarbon Conversion Process U |
| 6,765,025 | Process For Direct Synthesis Of |
| 6,992,113 | Control CO₂ In FT Process |
| US Applic. | |
| 10/493,481 | Integrated Oxygen Generation |
| 10/924,174 | Two Stage Auto Thermal Reform |
| 10/924,378 | Integrated Fischer-Tropsch Process |
| 11/088,287 | Transportable Gas To Liquid P |
| 11/302,009 | Fischer-Tropsch Product Conde |
| 11/669,988 | Paraffinic Hydrocarbon For Fuel |
| 11/781,358 | Hydrocarbon Recovery In The F |

J. G. Speight, Synthetic Fuels Handbook: Properties, Process, and Performance
Handbook of Alternative Fuel Technologies, by Lee, Speight & Loyalka (Editors)
Fischer, Franz 1925 The Conversion of Coal into Oils
Fischer, Franz 1932 Kenntnis der Kohle
Delmon, B. 1976 Preparation of Catalysts I—Scientific Bases for the Preparation of Heterogeneous Catalysts Proceedings of the First International Symposium held at the Solvay Research Centre, Brussels, Oct. 14-17, 1975
   Probstein, Ronald F. 1982 Synthetic Fuels
   Anderson, Robert B. 1984 The Fischer-Tropsch Synthesis
   Guczi, L. 1991 New Trends in CO Activation
   van Santen, R. A. 1999 Catalysis—An Integrated Approach

### Fischer-Tropsch Process:

“Generally, the Fischer-Tropsch process is operated in the temperature range of 150-300° C. (302-572° F.). Higher temperatures lead to faster reactions and higher conversion rates but also tend to favor methane production. As a result the temperature is usually maintained at the low to middle part of the range. Increasing the pressure leads to higher conversion rates and also favors formation of long-chained alkanes both of which are desirable. Typical pressures range from one to several tens of atmospheres. Even higher pressures would be favorable, but the benefits may not justify the additional costs of high-pressure equipment.”—Wikipedia

The processes shown schematically in FIG. 46 can utilize a catalyst comprising at one or more of copper, chromium, zeolite, zinc, and combinations thereof. Specifically, a Fischer-Tropsch catalyst can comprise cobalt or ruthenium. Other catalysts may be found specific to the higher pressures, see Table D, of this invention. A Fischer-Tropsch reactor can be a slurry bed reactor, a fixed bed reactor, a fluidized bed reactor, or combinations thereof.

Surplus hydrogen can be recovered by membrane separation, adsorption, absorption, cryogenic separation, and combinations thereof, or can be combined with stoichiometric quantities of oxygen O₂ to form water.

TABLE D
Water Pressure at Selected Ocean Depths

| Depth in Meters | Pressure in Bar | Pressure in PSI |
|---|---|---|
| 0 | 1 | 14.5 |
| 500 | 50 | 750 |
| 1,000 | 100 | 1,500 |
| 2,500 | 250 | 3,750 |

TABLE E
Selected Centigrade to Fahrenheit Conversions

| Centigrade | Fahrenheit |
|---|---|
| 50 | 122 |
| 100 | 212 |
| 150 | 302 |
| 200 | 392 |
| 250 | 482 |
| 300 | 572 |

Biomethane Production and Transport:

The submerged process may employ a fossil feedstock such as coal or natural gas. However, using the PODenergy oceanic biomass digestion process, as extensively described in our prior utility and provisional applications, it is possible to produce large amounts of renewable methane gas. Since the digestion process may preferably conducted in deep water, and biomass creation may preferably be performed in mid-ocean gyres, such methane will be produced far from existing markets for the sale of renewable natural gas. Possible methods to transport such natural gas to market include pipelines, CNG or LNG tankers, or on-site production of liquid synfuels or paraffins that are easier to store and transport to market via conventional tanker ships.

One means to convert methane to a liquid or solid synfuel is the Fischer-Tropsch (FT) process, which dates from the 1920s and was used by the Germans to produce synthetic fuels during World War II.

Conventional FT Process Narration (Prior Art)

H₂S Removal Step

Prior to converting methane to synfuel, it may be desirable to remove H₂S from the CH₄ stream since even tiny amounts of H₂S can poison the catalysts. H₂S is twice as soluble in H₂O as CO₂, so we do not expect large amounts of it. However, if necessary it can be removed by several processes. For example one such process is by reaction with iron oxide. “Gas is pumped through a container of hydrated iron(III) oxide which combines with hydrogen sulfide.

Fe₂O₃(s)+H₂O(l)+3H₂S(g)→Fe₂S₃(s)+4H₂O(l)

To regenerate iron(III) oxide, the container must be taken out of service, flooded with water and aerated.

2Fe₂S₃(s)+3O₂(g)+2H₂O(l)→2Fe₂O₃(s)+H₂O(l)+6S(s)

On completion of the regeneration reaction the container is drained of water and can be returned to service. An advantage of this system is that it is completely passive during the extraction phase.” Processes commonly employed in the wastewater industry to reduce H₂S formation or to remove it may prove better in the submerged situation, such as activated carbon or the biologic conversion of sulfides to sulfate.

Syngas Formation Step

An FT process can begin by converting methane to syngas via steam reforming:

CH₄+H₂O→CO+3H₂

(catalyst)

As is extensively discussed in the art, such step can also include partial oxygenation such as with stoichiometric amounts of O₂, to reduce excess H₂. However, in the deep ocean environment it is preferable to avoid conveying O₂ (or any gas) to deep levels. Therefore it may be preferable to remove the excess H₂ at the end of the FT process via membrane separation, since H₂ is very prone to pass differentially through membranes.

Fischer-Tropsch Step

In the presence of a different catalyst, the syngas can be converted into long chain and branched alkanes plus H₂O:

2nH₂CO→—(CH₂-)n-+H₂O

(catalyst)

Heat Recycling Step

The syngas step is significantly endothermic, and the FT step is significantly exothermic. Hence it is conventional to recycle heat liberated in the latter back to the former.

H₂ Separation Step

Surplus H₂ remaining after the polymerization step can be removed by various methods, including membrane separation.

Refining Step

The longer chain hydrocarbons thus produced may be further refined by cracking and distillation, in the manner of conventional petroleum, to yield hydrocarbon chains of desired lengths.

—(CH₂-)n-→fuels, lubricants, etc.

(catalyst)

Description of the Invention:

What follows does not alter the standard reaction chemistry and hence applies to any gas to liquid (GTL) synfuels process, such as the Mobil Process of synthesizing gasoline using methanol intermediate. It also applies to any variant of such processes now known or hereafter invented.

The FT process can operate as low as 150° C.-200° C. (302° F.-392° F.), and “several tens of atmospheres” of pressure. Lower temperatures and higher pressures “lead to higher conversion rates and also favor formation of long-chained alkanes, both of which are desirable.”

The Capron oceanic biomass digestion process produces pure methane gas in the deep ocean at around 1,000 meters deep, at a pressure of around 100 atmospheres (100 bar) or 1,500 psi. Since it has just bubbled out of a seawater digester, it contains water vapor.

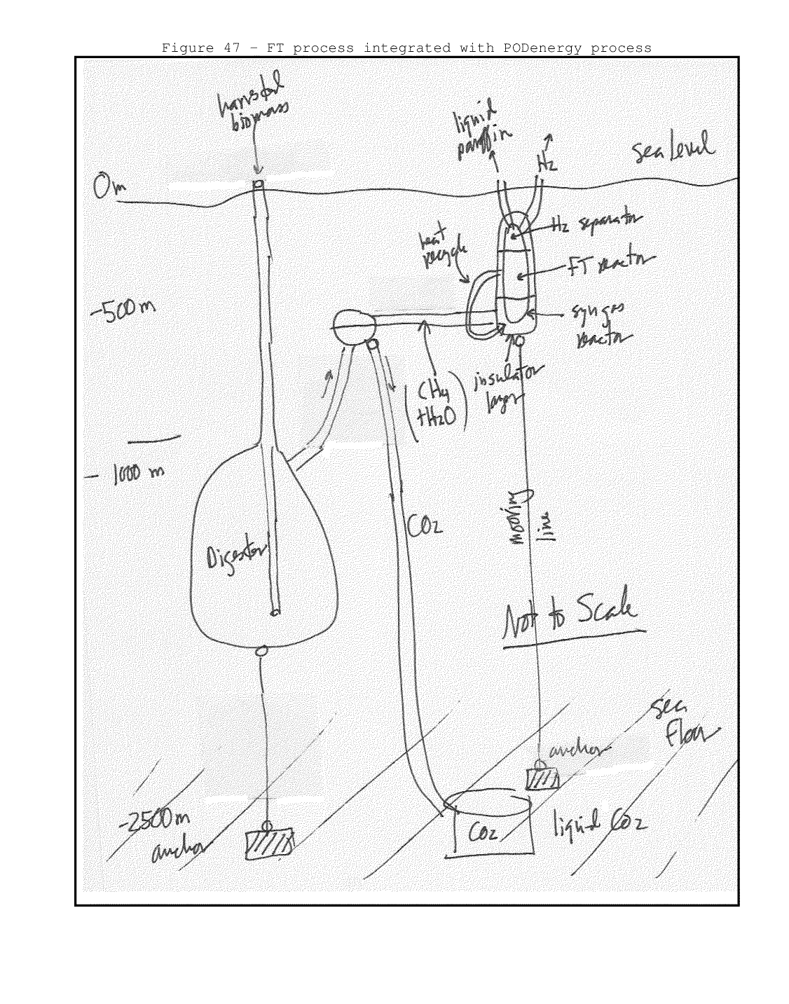

Such pressures are achieved with plastic reaction vessels. For example, the digester shown in FIG. 47 may be made from 25 mil plastic film, since the vessels are water-supported and the ambient water pressure is already 100 bar. The reaction vessel would be somewhat thicker both because of the buoyancy forces and the need to provide insulation. The average depth of the ocean would permit processing at pressures near 400 bar, if such proved beneficial.

Various plastics are available, including forms of HDPE, which can withstand operating temperatures up to 150° C.-200° C. (302° F.-392° F.). It is therefore possible to construct an FT reactor for operational use at 150° C.-200° C. and 100 atmospheres (at 1,000 meters depth) using inexpensive plastic materials, which may cost 100× to 1,000× less than steel FT reaction vessels.

FIG. 47, shows the FT reactor in a vertical orientation. Note that when a submerged flexible vessel is filled with gas, the pressure is everywhere the same inside the vessel and must equal the ambient pressure at the bottom of the vessel to prevent the bottom from collapsing inward. For example, if the reactor were 10 meters high, the top of vessel would have to contain the 1 bar pressure difference. The differential pressure can be contained with differential skin thickness. Also, the differential pressure can be minimized by distance between the top and the bottom of the reactor.

Typical water temperature in the deep ocean is 4° C. (39° F.). Hence one or more plastic insulating sleeves (with seawater or other liquids in between) are used around the vessel. Such sleeves could also contain plastic insulating foams, suitably permeated with water, other liquid, solid, or compressed gas. While liquids and solids offer density, which reduces buoyancy forces and pressure differences, a compressed gas is likely to be a better thermal insulator. For example, a plastic foam made with tiny gas-filled glass spheres may be the ideal flexible insulator. The glass spheres are extremely strong under pressure.

Despite the intense pressure, all reactants remain in their gaseous phases, due to the high temperature. Hence the reactions will proceed normally. However, after reacting, the ambient temperatures of 4-30° C. allow for rapidly cooling the products. Also, higher pressures from nearby deeper water may be easily available. Either cooling of increased pressure may cause phase change in some products for convenient separation of those products. For example, if one product is paraffin (as a gas), its conversion to a liquid or a solid would leave the excess H₂ as a gas.

Such heat as is required, which cannot be supplied by recycling waste heat from later parts of the process, can be furnished by either electric heating, or flameless catalytic combustion of fuel and O₂ or air. Such fuel can include surplus H₂ removed from the FT product during the H₂ separation step. The platinum or other catalyst for flameless combustion can be applied to a layer of ceramic on the outside of the reaction chamber, or directly to the plastic surface to be heated.

In addition to process heating, surplus H₂ can be used to produce ammonia from atmospheric N₂. Such ammonia can be used as a nutrient in the PODenergy system, and if returned to the sea would reduce its pH, which has been rising to levels dangerous to current life forms due to rising levels of dissolved CO₂.

If necessary for device or catalyst physical or thermal stability, the working catalyst may be applied to ceramic or zeolite substrate, which in turn may be suspended or supported in a wire mesh or other metallic shelf or cage in the reactant pathway. In addition, conventional processes, including continuous processes, may be applied to move such catalyst elements into another chamber, including by a conveyor belt or screw, or in small batches, to be refreshed or cleaned by other reactions and returned to service, such catalyst holding elements being optionally made of or containing conventional metals.

Given the propensity of the gaseous reactants to rise in the underwater environment, the reaction will proceed mainly in an upward direction. To provide continuous production, the plastic reaction vessel described herein can be sized to match the output of an associated PODenergy deep water digester, or the output of several such digesters can be combined to feed a single FT reactor.

The plastic reaction vessels described herein can be used at depths of more or less than 1,000 meters, and can operate at any depth that is sufficiently deep to produce a desired pressure for a selected reaction using plastic film structures. Thus water as shallow as 50-200 meters could also be used.

In a body of water, such as the Persian Gulf or the North Sea, where such depths are not readily available, and depending on the bottom material, it might be feasible to excavate or dredge an artificial deep spot, given the relatively small size of the apparatus.

Possible reaction products include paraffin or other long chain waxes that are solids at normal environmental temperatures. Such paraffins can be refined using cracking processes to yield more preferred shorter chain hydrocarbons. However, such further refining need not take place in the open ocean. Once the bio methane has been converted to a synfuel, such as paraffin, it can be transported to land where subsequent refining steps can be performed using conventional land based oil refineries.

Paraffin floats on seawater. Means of transporting paraffin wax to land may include:
a. Form it into cakes and load them onto passing freighter ships,
b. Form into cakes that float and tow them to shore using conventional vessels, or
c. Form into cakes shaped like sailboats, with a keel, mast, sails, and autonomous electronic navigation gear and let them automatically sail themselves to land.

In all 3 cases we can optionally add various types of reinforcement, such as plastic or metal ribs, mesh, plates, or fibers, to provide added strength and endurance for open ocean voyaging. Also we may add chemicals (such as longer chain polymers or other fixing agents) to the paraffin to make it stiffer or more rugged, especially if its melting point is low and it is prone to break apart, due to low tensile or impact strength. In another embodiment the cakes or vessels can be covered with a sheet of plastic, or coated with ah applied coating, to improve seaworthiness.

In one embodiment, as liquid paraffin wax is brought to the surface, several sailboat molds are used to afford a continuous casting process. Such a mold may be divided in 2 sections along the keel line, and then be a) lined with plastic strips and/or edging, keel, and mast, b) poured full of molten wax, c) allowed to cool, and d) opened to separate the 2 sections along the keel line, e) the sails and other electronics and navigational equipment are installed, and f) the sailboat is released to autonomously sail itself to shore.

The boat-molding process can proceed continuously from one mold to the next. As one mold is being poured, the one before it is cooling and hardening, and the ones before that are being rigged and released. After a boat is released its mold can once again be lined with reinforcement, as needed, and then another boat cast, etc.

On the receiving end, the paraffin blocks can be either a) melted down and used as feedstock to a conventional refinery process, or b) burned directly in an electric generating station or other industrial process, where it will be an approximate replacement for very clean diesel fuel.

### 25. SUBMERGED INSULATION

### Capron, 61/341,693

Submerged processes, such as those mentioned in the PODenergy applications, will employ thermal or electrical insulation or both. The pressure at which the processes are employed, 10 to 1,000 bar, will compress typical sea-level insulation materials. The key to cost-effective submerged insulation is to produce a structure with a high percentage of gas or vacuum volume surrounded by materials that are not thermally conductive across thin cross-sections, but can resist uniform compressive force, or will allow adding compressed gas in a manner that balances the change of pressure as the structure is brought to depth.

A closed-cell porous ceramic formed in a vacuum is one example of a sub-structure with a thin cross-section and excellent resistance to uniform compression forces. Glass or ceramic spheres are another example. Glass spheres are manufactured in many sizes even down to the micro-sphere size. The largest size should be smaller than will allow convection currents to form inside the sphere. The volume inside the sphere may be a vacuum or a particularly well insulating gas, such as Nitrogen or Argon. In general, the spheres will be manufactured with the pressure inside the spheres between 0 (a vacuum) and 1 bar. The sphere constructions may have some tensile strength that will allow interior pressure higher than exterior pressures, a condition that may occur during manufacture or transportation.

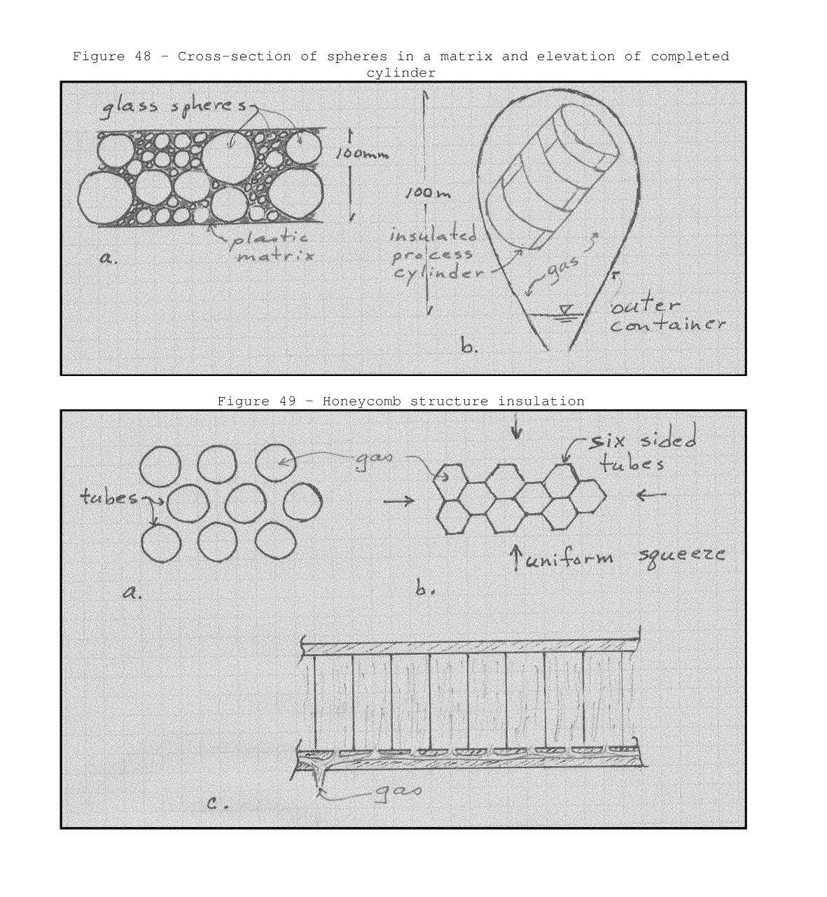

The completed spheres will be packed into a plastic matrix as shown in FIG. 48a. The type of plastic would be chosen for its structural and thermal properties. A variety of sphere diameters provides the highest percentage of gas or vacuum volume. The matrix of spheres may be molded or extruded into any desired shape of plate. The plates need not contain pressure or even conform to the overall container. For example, FIG. 48b shows the plates formed as a series of half-rings with end caps forming an insulated area within a larger structural submerged container. In FIG. 48b, the gas inside the insulated cylinder may be the same pressure as the gas outside the cylinder. The pressure is determined by the depth of the outer container and the water level inside the container. The sizes shown indicate approximate scale.

The honeycomb structure of FIG. 49 would provide both good resistance to compression and the ability to add compressed gas to support the structure as the structure is taken to depth. The construction of a structural honeycomb is prior art with many variations, One version is shown in FIG. 49. First, a collection of tubes with moderate internal gas pressure is arranged, shown as a transverse cross-section in FIG. 49a. Second, the tubes are squeezed transversely, which causes the tubes to form a six-sided honeycomb structure, shown in FIG. 49b. The tubes are bonded together and cured. After curing, the structure can be sliced transversely to make plates with open honeycomb on both sides of the plate. One then bonds sheets or plates over the ends of the open honeycomb. FIG. 49c shows a section of honeycomb with end plates.

At least one of the end plates of FIG. 49c contains small tubes which allow changing the mass of gas inside the honeycombs. That is, the gas pressure in the honeycombs could be 1 bar during manufacture and near 400 bar when the insulation is at a depth of 4,000 meters.

The honeycomb structure may be made of any combination of materials. Stronger materials would allow for a greater difference between the inside and ambient pressure. The size of the honeycomb should be sufficiently small to prevent convection currents. That size may be different when the gas is at 400 bar than when the gas is at 1 bar. The increased gas density will make it a better thermal conductor, but gas at 400 bar, confined to prevent convection currents, should still be a more cost effective insulator than a liquid or a solid at the same pressure.

### 26. SUBMERGED COMPRESSOR AND SUBMERGED REVERSE OSMOSIS

### Capron

Reverse osmosis done at ocean depths dates from at least 1989, when inventor Mark Capron worked on such methods at the Naval Civil Engineering Laboratory in Port Hueneme, Calif. However, Capron's and others' prior art does not describe the pressure resisting container of FIG. 50, which is useful as a gas compressor, and for storing gas in a pressure swing absorption (PSA) process.

Pressure swing adsorption (PSA) and gas compressors are discussed above. The structure of FIG. 50 is a relatively thin impermeable textile skin surrounding a compression resisting filler material. That material may be sand, zeolite, carbon nanotubes, ceramic particles, or plastic structures like those employed for storm water storage under parking lots.

When operating as a compressor, the valve allowing gas at a lower pressure than the surrounding seawater would open. In FIGS. 50a and 50b, the lower pressure is 1 atmosphere (1 bar). A pump removes seawater from the bottom of the container as low-pressure gas fills the voids above the lowering water level. The gas in the container is compressed when both valves are closed and water is allowed back into the container. Some of the energy used to pump the water out can be recovered as water rushes in and compresses the gas.

A steady flow of gas at a known pressure is useful in a PSA process. If one desires a steady flow of compressed gas, one allows the water to fill to the desired gas pressure. For example, filling half the gas volume slowly, so that the gas temperature does not change, would provide a gas at 2 bar pressure. One then matches the flow of water and the flow of gas through the higher pressure valve to maintain a steady flow of gas at 2-bar. One might also place the PSA material in the top portion of the container, instead of in a separate container.

The compression and PSA processes can also be adapted for gas storage. For example, CH₄ is compressed to about 4,000 psi (270 bar) for storage. Because of the structural wall thickness, the result is somewhat better than 1/100^{th} the volume. Liquefying the CH4 (−163 C) gets to 1/600^{th} the volume of 1-bar gas. A solution which works well with the FIG. 50 compressor is Peter Pfeifer's carbon briquettes with nanopores. Professor Pfeifer is with the University of Missouri-Columbia and the Midwest Research Institute in Kansas City. The carbon nanopores store CH₄ in 1/180^{th} the volume at 1/7th (about 500 psi, 33 bar, 330 meters depth) of conventional natural gas tanks. Note—In the ocean, carbon nanopore storage would be most useful in shallow (less than 500 meters deep) water. If a depth of 4,000 meters were available, one could store the gas in a balloon where the stored volume would be about 1/400^{th} of atmospheric pressure.

The carbon nanopore material does have the advantage of adding weight to resist uplift forces on the storage container. The density of CH₄ at 400 bar would be about 290 kg/m³, much less than the 1,050 kg/m³ of the surrounding seawater.

When the reverse osmosis membranes are above sealevel, they must be housed in pressure containers with significant (about 1,000 psi, 70 bar) internal pressure and atmospheric external pressure. The seawater is pumped to the high pressure and 30 to 70% of the seawater is converted to fresh water. Meanwhile, salts are concentrated. Because the required osmotic pressure increases as the seawater becomes saltier, the arrangement requires the high pressure. If the seawater could be kept nearer its typical 32,000 parts per million of salt, the osmotic pressure would remain near 310 psi (21 bar, 210 meters of depth).

The “compression filler” storage of FIG. 50 would be associated with reverse osmosis membranes. The membranes are currently provided in spiral wrapped, flat sheet, and tube structures. Any of these arrangements can be employed. FIG. 51 shows an arrangement with tube membranes.

In FIG. 51, the tube membranes are essentially loose in the sea. The thin-walled seawater tube is useful for moving water from a different depth (which may have a lower salinity and less biologic and particulate matter) and for containing low-pressure filters. The fresh water depth below sea level within the compression-filler fresh water storage depth determines the pressure across the membranes. In FIG. 51, the pressure across the membranes is about 40 bar (400 meters of seawater head). The top of the fresh water may also be below the tube membranes but would then be pulling a less than 1 atmosphere vacuum on the product water.

One could match the flux through the membranes with the fresh water pump and avoid large submerged storage. However, the large capital investment generally favors constant flux through the membranes while the demand for water and the cost for electricity to run the pumps varies during the day. The submerged storage allows constant fresh water production. The pumps may be turned off during the time of peak electrical power prices as the storage fills. The pumps would empty the storage during the time of minimum electrical power price.

### 27. MORE SUBMERGED PIPE AND STORAGE CONTAINERS

### Capron, Sudia

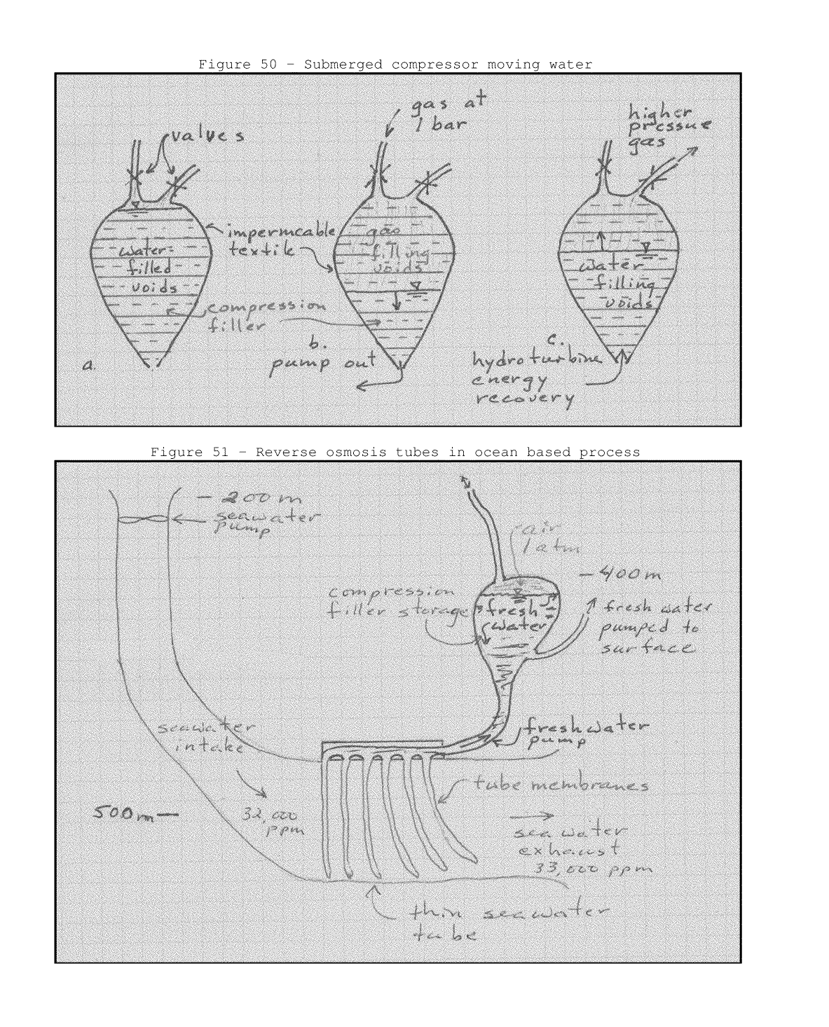

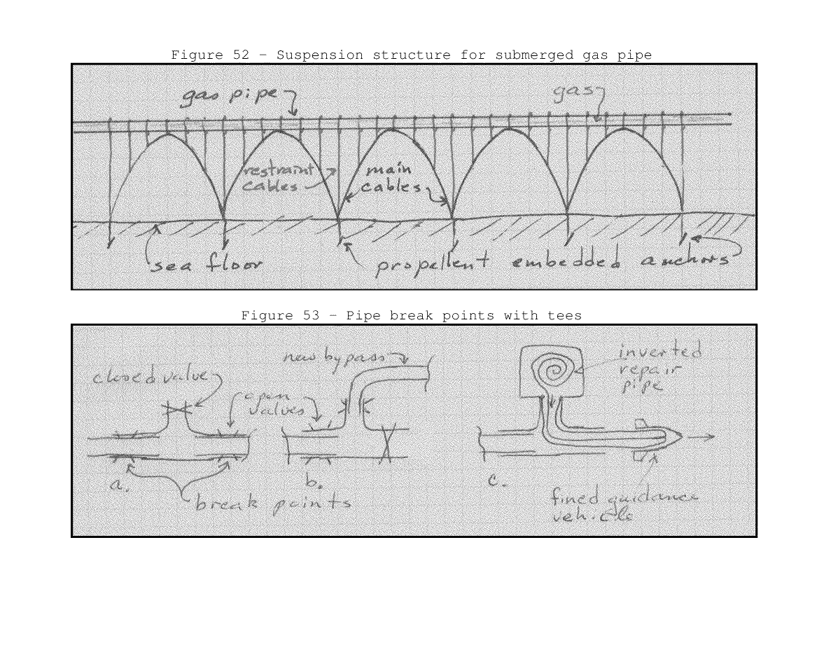

The gas pipe of previous sections will need to be restrained from rising because the gas density will be substantially less than that of seawater, even though seriously compressed. For example, at 2,000 meters deep, the CH₄ would be about 140 kg/m³, much less than the 1,030 kg/m³ of the seawater. FIG. 52 is an elevation of a submerged pipe restrained by an arrangement that is the reverse of a suspension bridge. The anchors substitute for the towers of a suspension bridge. The forces involved in restraining a pipe are relatively smaller than the typical bridge. For example, a pipe about 2 meters in diameter at 2,000 meter depth (matching internal and external pressure), flowing 4 m/sec, could convey 350 million standard cubic meters (120 million therms) of CH₄ per day. One can easily envision an inverted cable stayed bridge in the place of FIG. 52 inverted bridge.

To ease future maintenance, the pipe may be installed with “clean break points” every kilometer or so. If some huge force rips the pipeline to shreds or causes leaks, it only takes out that section. The break point may be a groove or a coupler or fitting that is just weak enough to break cleanly when a longitudinal force some fraction of the pipe longitudinal break force is applied to it. Such a coupling if it consists of two concentric cylinders one tightly fitted inside the other, with some spring clips around them, could withstand considerable surface pressures, but let go when pulled along its length. Several such connections and other aspects of container repair, including valves are drawn above.

These breakable connectors provide a nice repair paradigm. Rather than plastic bonding technologies, which may be difficult to perform in the deep ocean, entire bad sections are replaced with good sections by the robots described herein and the previous applications.

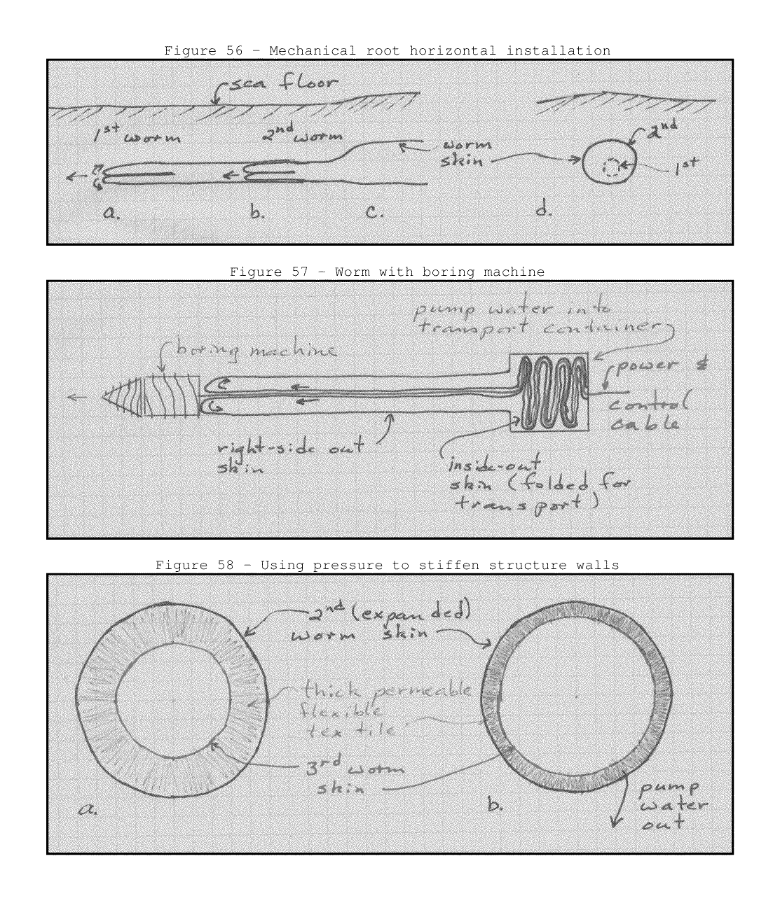

The break points may include tees with valves, FIG. 53. One could then add a bypass pipe while gas continues to flow through the damaged (or just due for replacement) pipe. Tees also allow insertion of a pipe liner, FIG. 53, using the pipe wall inversion technique described in previous applications and in FIG. 56. FIG. 53a shows the normal situation with gas flowing past a tee through a whole pipe. FIG. 53b shows a bypass installed after a section of pipe is lost or damaged. FIG. 53c shows installing a new section of pipe using the inversion technique and a fined guidance vehicle. The “free swimming” pipe inversion technique with guidance vehicle if FIG. 53c may be employed for new pipe and cable installations in water or other fluids.

However, some may consider a structure elevated above the seafloor as exposed to acts of vandalism. Those people would prefer a gas pipe buried in the seafloor ooze. A buried gas pipe would benefit from the maximum available pressure, providing maximum gas density. Increased density reduces uplift forces and moves more product at the same velocity.

FIG. 54 shows a method for installing a buried pipe using basic processes for laying terrestrial or oceanic cables. The prior art includes a ship pulling two plows. The first plow opens a trench, analogous to transverse section FIG. 54A. The cable is placed behind the first plow, FIG. 54B. The second plow covers the cable with the spoils from the first plow, FIG. 54C. The activities are one continuous movement. The prior art includes attaching segmented weights to the pipe/cable.

The actions in FIG. 54 differ from prior art several ways. First, the trench must be deeper because the covering seafloor ooze (aka spoils) will provide the weight to restrain the eventually gas filled pipe from floating. FIG. 54A shows the trench in transverse section. The additional depth and spoils may require a more active plow, represented by the ooze “snow blower.” Second, the pipe is relatively thin and flexible. It is allowed to collapse under the deep ocean pressure. (The pipe may also be maintained in a round condition by filling it with seawater to match interior and exterior pressure independent of depth and increase its density.) Third, the pipe is attached to a stiffening geoweb. The stiffening geoweb can consist of stiff transverse rods and flexible longitudinal web. That is any structure with longitudinal stiffness equal to the pipe and transverse stiffness to transfer the load from the gas-filled pipe to the covering of seafloor ooze.

If the pipe is installed in a collapsed configuration, it may be inflated after covering with seafloor ooze as shown in Sections 9B, 9C, and 9D. The initial inflation may be with seawater to avoid uplift forces before the seafloor ooze has been consolidated. The walls of the pipe and the geoweb may be stiffened to improve load transfer and resist compression forces after inflation. The stiffening could be any chemical or mechanical process, including that shown in FIG. 58. The installed and ooze covered pipe may also be employed as a permanent container for liquid CO₂.

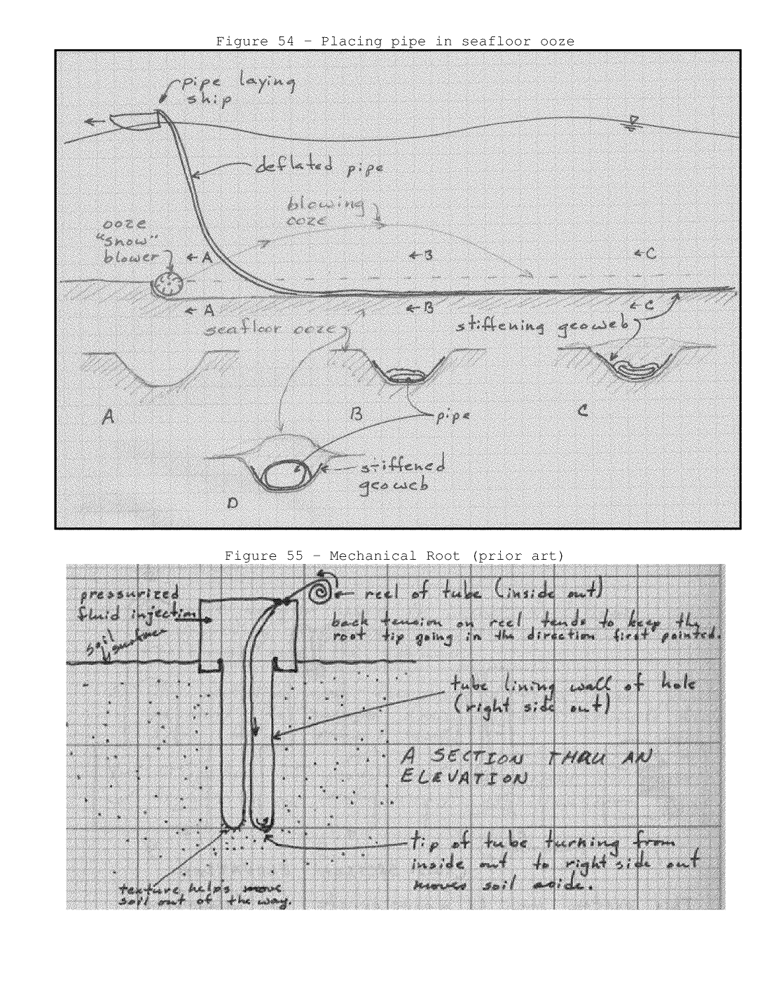

PRIOR ART: The Mechanical Root (1989). By turning a tube inside out with fluid pressure we can have a means to force a tensile strength member into the soil. (See FIG. 55) Added features include:
1. By pulling on one side of the inside out tube, it may be possible to steer the root tip.
2. If the tube is not the strength member, the end of the tube could pull through a strength member.
3. The end of the tube could pull through a power or sensing member (optical fiber).
4. Larger diameter tubes could be sent down the pilot hole (or pulled) and expanded to produce a tapered root.
5. The root may be used as a local irrigation system. A group of roots may be dispersed radially, say 6″ below the ground as a replacement for pop-up sprinklers.
6. The root may be used to inject fertilizers, bio-degrading bacteria, and other soil amending fluids into the ground.
7. The root tip may tow down a tube, which could be used to draw up and sample fluids from below ground level.
8. A system of roots could be used for beach, foundation, or embankment stabilization.

The prior art “mechanical root” shown in FIG. 55, is a different method of “directional drilling” in very soft materials, such as seafloor ooze. The mechanical root offers another method for installing flexible pipe or containers in seafloor ooze. FIG. 55 shows the mechanical root in a vertical orientation. It could as easily be deployed in a horizontal orientation, as shown in FIG. 56. The mechanical root or artificial worm consists of a tunnel-lining textile that is installed by turning a tube inside-out. The process is similar to that employed when lining sewer or water pipelines with a cured-in-place resin-saturated fabric. Because there is no movement between the outside of the textile and the ooze, except at the point of advance, the tunnel may economically extend for kilometers in the soft ooze. Note the “reel of tube” in FIG. 55 could be inside the pressure container as shown in FIG. 5 above.

FIG. 56 is a condensed view of installing a large diameter pipe or container with a mechanical root (aka artificial worm). In FIG. 56a, a small worm creates a pilot hole lined with a thin pipe. The pilot hole pipe would be complete before a larger pipe is pulled or “wormed” through the small pipe, FIG. 56b. Note the small pipe would normally have a closed end upon complete expansion. That closed end would need to be opened so that the liquid pushed by successive worm-installed pipes can escape. After the larger pipe is fully inside the small (FIG. 56a) pipe, it is inflated with liquid or gas, which bursts the small pipe as shown in FIGS. 56c and 56d. Thicker pipe walls can be built up, or leaks repaired by inserting more skins in an existing pipe.

Note the first worm requires some guidance mechanism, which may be an autonomous boring machine, a directional drilled pilot hole, or a cable powered and controlled boring machine. The power and control cable can be coiled in the worm skin as shown in FIG. 57. Employing a boring machine allows operation in stiffer, even terrestrial soils. By using the worm to pull a strong cable (Item 2) of FIG. 55) one may employ 2010 typical pipe bursting and pipe pulling operations to follow the worm installed guide hole.

FIG. 58 shows the concept of hydrostatically stabilized sand (explained in prior art and 61/355,811) applied to stiffen the walls of a structure. FIG. 58a is a transverse cross section of a cylinder consisting of an impermeable outside (2nd) and impermeable inside (3rd) skin. (FIG. 58 is a continuation of FIG. 56, where the 1st skin was a temporary pilot.) A thick permeable textile lies between the two skins. This material is as flexible as the skins, while in the FIG. 56a condition. It may be a non-woven fabric (a felt) or a woven fabric. The individual fibers may be quite stiff (glass, steel, or carbon fibers, or the like). The material is flexible because the fibers can slide past each other. FIG. 58b shows the same cylinder, but with significant water pumped out from the space between the skins. Pumping the water out causes the ocean pressure to squeeze the fibers together.

Friction prevents the fibers from sliding past each other. The material is now quite stiff allowing the cylinder to resist compression forces.

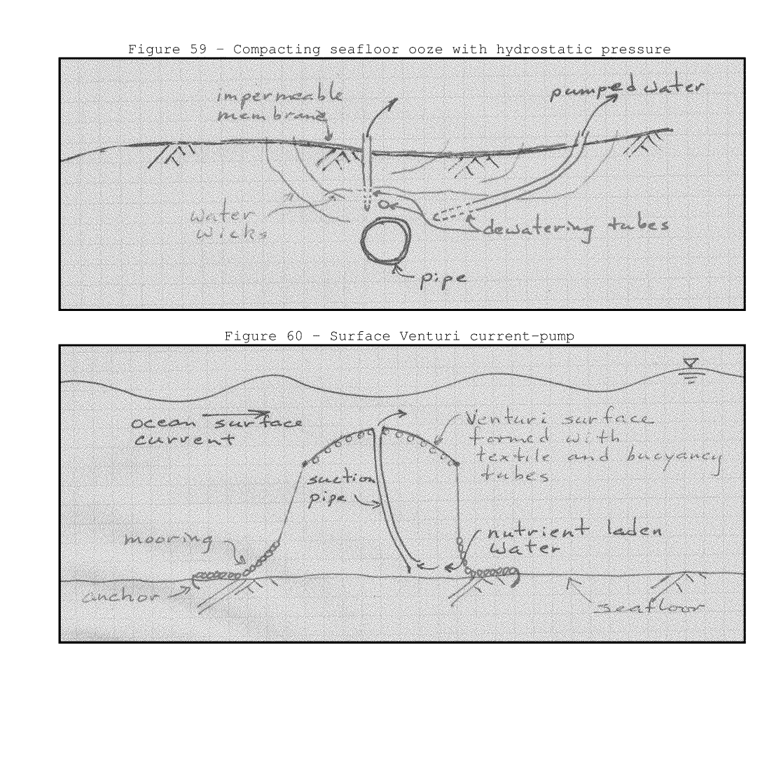

A combination of the principles of hydrostatically stabilized sand and traditional clay soil compaction techniques is shown in FIG. 59. The FIG. 59 process applies to the pipe and container installing techniques plus general seafloor foundation strengthening.

FIG. 59 is a transverse cross section of the hydrostatic compaction process performed over a newly installed pipe. At a minimum, the process involves an impermeable sheet placed over the ooze and dewatering (evacuation) tubes deep in the ooze. The dewatering tube(s) may be longitudinal if placed with the new container or pipe. They may also be installed vertically or sideways. Wicking tubes, allowing faster soil consolidation, are optional. Both wicking and dewatering tubes may be installed when installing the container or pipe. Evacuating water from beneath the impermeable sheet causes the full hydrostatic pressure of depth to force water out of the ooze (soil).

### 28. CURRENT- AND WAVE-POWER PUMPING

### Sudia

In a stiff surface or deep current, the seafloor-based current-upwelling barrier of previous applications may be replaced with a Venturi. FIG. 60 is cross section elevation of a Venturi in a surface current. The Venturi surface extends for some distance perpendicular to the current (in and out of the paper), it actually resembles an airplane wing. Long suction tubes pull water nutrient laden water from depth. The depth inverse is also possible, with two Venturi surfaces. The upper surface would employ weights to form the parabolic shape. That is the Venturi may be in a deep current and suck water from the ocean surface. The warm ocean surface water mixed with the cold deep water will be less dense. The less dense current exiting the Venturi will rise toward the surface.

The prior art wave-pumps (Salter and others) may be moored in a current, rather than drifting with a current. That way nutrient laden water moved by the wave-pumps is better dispersed in the surface water. (With the wave-pump drifting with the current, a more concentrated spot of nutrients also drifts with the current.). The Salter wave-pump is shown in previous PODenergy application drawings.

### 29. NUTRIENT RECYCLE BOATS

### Capron, Sudia

Once the ecosystems are established, we won't need as much deep-ocean nutrient recovery equipment, since we can recycle nutrients recovered from our anaerobic digestion operations.

The PODenergy ecosystem may employ sailboats to tow bladders of the high nutrient recycle water around the algae forest. The bladders may be configured to slowly “leak” nutrients like a tea bag. The sailboat may also employ a wind turbine to supply power for spray distributing the nutrients.

The sail boats may also be connected to the digester with a hose that pays out of the sailboat as if the hose were the wire of a wire-guided torpedo. The hose supplies nutrients from the digester. After the hose is all in the water, either the sailboat or the bladder would winch the hose back for subsequent reuse.

Drawings applicable to this invention appear in prior sections.

### 30. SUBMERGED SUPERCONDUCTING POWER CABLES WITH SUPERCRITICAL PIPELINES

### Capron

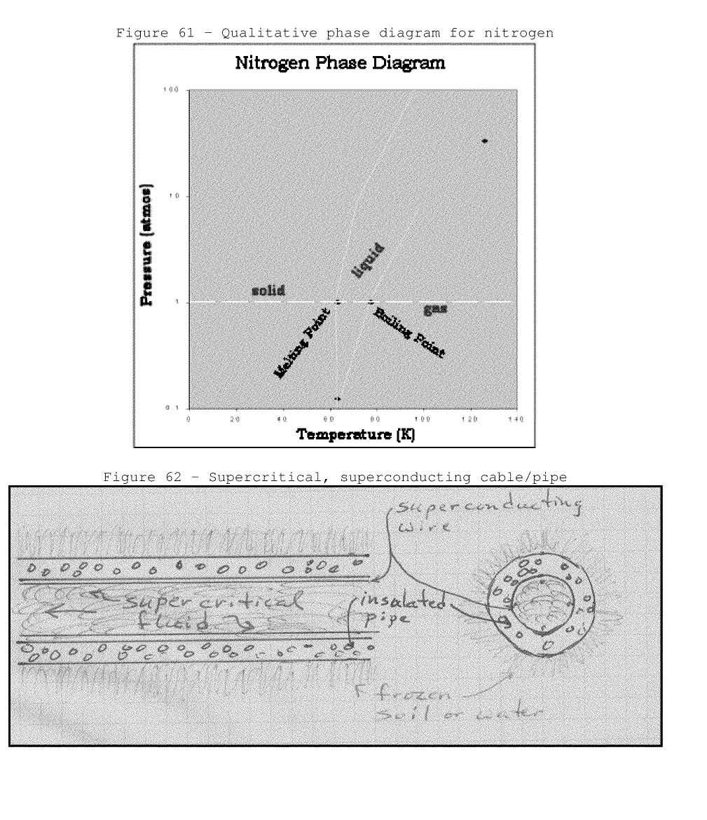

American Superconductor makes wires that are chilled to electrical superconducting temperatures with liquid nitrogen. FIG. 61 and the phase change information on liquid nitrogen is available from: http://www.astro.washington.edu/users/larson/Astro150b/Lectures/Fundamentals/fundamentals.html

FIG. 61 is a qualitative phase diagram for nitrogen. Its triple point occurs at an atmospheric pressure of 0.123 and a temperature of 63.15 K. At lower pressures, nitrogen will sublimate. The normal melting and boiling point for nitrogen (that is, at 1 atmos.) is 63.3 and 77.4 K (−320 degrees F.!) respectively.

At the 1-bar of terrestrial cable applications, the prior art includes pumping liquid nitrogen along the cable to keep it below superconducting temperature. The prior art also includes releasing liquid nitrogen as a gas when maintaining the temperature of stored liquid nitrogen below the boiling point of 77 degrees K. The heat of vaporization is 5.6 kJ/mol (5,600 J/mol), so that a little nitrogen release goes a long way relative to the specific heat of 29 j/mol-deg K (at 25 deg C.).

In the deep ocean, the temperature at which nitrogen boils or solidifies can be the appropriate temperature control for superconducting cables. Note the high pressures will have different vaporization, specific, and fusion heats. If the temperature is close to nitrogen solidification, one would maintain the fluid temperature by adding nitrogen “ice” chips to the flowing fluid. Nitrogen's heat of fusion at 1-bar is 0.72 kJ/mol (720 J/mol).

In the deep ocean, the pressure can allow common gases to be supercritical fluids at temperatures needed for superconductors. Hydrogen will be supercritical if the pressure is higher than 13 bar (130 meters) and if warmer than 33 deg K. Methane will be supercritical if the pressure is higher than 45 bar (450 meters) and if warmer than 190 deg K. Oxygen will be in a supercritical state if the pressure is higher than 50 bar (500 meters) and if warmer than 155 deg K. Methane will be supercritical if the pressure is higher than 45 bar (450 meters) and if warmer than 190 deg K. Typical ocean pressures may also allow superconducting to occur at higher temperatures. However, to date the pressures needed to make hydrogen or oxygen, for example, superconducting are several orders of magnitude higher than the 400 bar of the deep ocean.

The advantages of using a supercritical fluid for cooling a superconductor include its combination of high density and low viscosity. This allows the pumped supercritical fluid to transport heat (actually cold) along the cable with much less friction loss than is the case for a liquid. Other features may also prove beneficial such as the lack of surface tension, properties that can be tuned by adjusting pressure and temperature, and the ability to completely mix fluids (as with gases). Per Wikipedia, “All supercritical fluids are completely miscible with each other, so for a mixture a single phase can be guaranteed if the critical point of the mixture is exceeded. The critical point of a binary mixture can be estimated as the arithmetic mean of the critical temperatures and pressures of the two components, T_{c(mix)}=(mole fraction A)×T_{c}A+(mole fraction B)×T_{c}B.”

For example, a mixture of hydrogen and methane may be mixed to provide a supercritical fluid temperature matching the ˜70 deg K of American Superconductors' 2009 wires. Other mixtures would apply for future higher temperature wires. The mixture can then be pumped with very low friction loses as it cools the superconducting cable. At the point of use, the hydrogen and methane mix becomes available as a fuel. The “cable/pipe” may resemble FIG. 62.

### 31. OCEAN FLOOR CONTAINER CO2 (l) STORAGE

### Capron, 61/343,572

CO₂ is the worst greenhouse gas in terms of existing volume, ongoing emission volume, and persistence in the atmosphere. As of April 2010, Carbon capture and storage (CCS) generally refers to the capture of CO₂ from electrical power plant exhaust and sequestering the captured CO₂ underground. Industry appreciates that capture and storage allows continued use of fossil fuels while reducing CO₂ emissions. Environmentalists appreciate capture and storage more rapidly reduces CO₂ emissions and makes fossil fuels less economically competitive with renewable energy.

Industry started the discussion of CCS with the least expensive possibilities, and moved from option to option as ecological flaws were uncovered. In approximate sequence, Industry has examined:
Dissolve-in-ocean—At typical ocean pressures, tremendous volumes of CO₂ will dissolve. Unfortunately, the dissolved CO₂ kills crustaceans with increasing acidity.
Fertilize-ocean—Use sunlight and ocean biology to remove CO₂ from the air and allow the dying life forms to settle to the bottom of the ocean. Unfortunately, the dying life forms sequester important nutrients with the carbon.
Treat-ocean—Reduce ocean acidity by adding alkalinity, so the ocean can absorb more CO₂. Unfortunately, difficult to manage unknown ecologic effects, plus it is very difficult to evenly distribute the tremendous volumes of quick-lime (or other alkalinity source) evenly.
Geologic sequestration—Inject CO₂ deep in the earth. Unfortunately, difficult to know how the CO₂ will move and what the effects will be.
In-seafloor-ooze—Use the seafloor ooze as a container. Unfortunately, difficult to be certain of the engineering properties of seafloor ooze.

### Physics of CO₂ Storage:

Above critical values, CO₂'s liquid-vapor phase boundary disappears. Further, its fluid properties change with changing pressure and temperature. Supercritical CO₂ has the density of a liquid, but exhibits the diffusivity, surface tension, and viscosity of a gas. That is, a lot of it can escape through very tiny holes. It can penetrate more quickly into porous solids. Meanwhile, it has the density to be a powerful solvent. Specifically, oils and other organic liquids will dissolve in supercritical CO₂. Supercritical CO₂'s solvent power varies with changes in pressure and temperature; it can take hydrocarbons from one place and move them to another.

Our understanding of supercritical CO₂ is still evolving. There are small-scale operations and investigations using supercritical CO₂ for:
An alternative reaction medium replacing organic solvents;
A reaction medium with improved reactivity and selectivity;
New chemistry;
Improved separation and recovery of products and catalysts;
Polymerization, polymer composite production, polymer blending, particle production, and microcellular foaming;
Cleaning semiconductors; and
Producing micro- and nano-scale particles.

FIG. 28 (above) is the phase change diagram for CO₂ showing the liquid and the supercritical region. The critical temperature is 32.1° C., and the critical pressure is 73.8 bar.

Figure, tables, and background information are excerpted from page 15 of Chemical Engineering, February 2010. The Chemical Engineering article is from “Supercritical CO2: A Green Solvent,” PEP Report No. 269, SRI Consulting, Menlo Park, Calif., August 2009. Author: Susan Bell, SRI Consulting.

Because temperatures below the Earth's surface increase with depth, geologically sequestered CO₂ is either dissolved in water or in a supercritical state. The equilibrium dissolution concentration varies with pressure and temperature, meaning the CO₂ may transfer from dissolved to supercritical and back over time and space.

On the other hand, ocean temperatures and pressures guarantee the CO₂ will be a liquid with typical and known liquid properties. At a depth of about 600 meters (60-bar on FIG. 28) the ocean temperature is generally less than 15 where CO₂ is well into the liquid portion of FIG. 28.

Because CO₂ (l) is more compressible than seawater; it becomes denser than seawater at a depth of 3,000 m. Once below the seafloor, however, the geothermal gradient causes the liquid CO₂ (CO₂ (l)) to expand more rapidly than seawater. Eventually, the ambient temperature becomes hot enough that CO₂ (l) becomes less dense than the pore fluid. (Note: A linear geothermal gradient of 0.03° C.″m was assumed.)

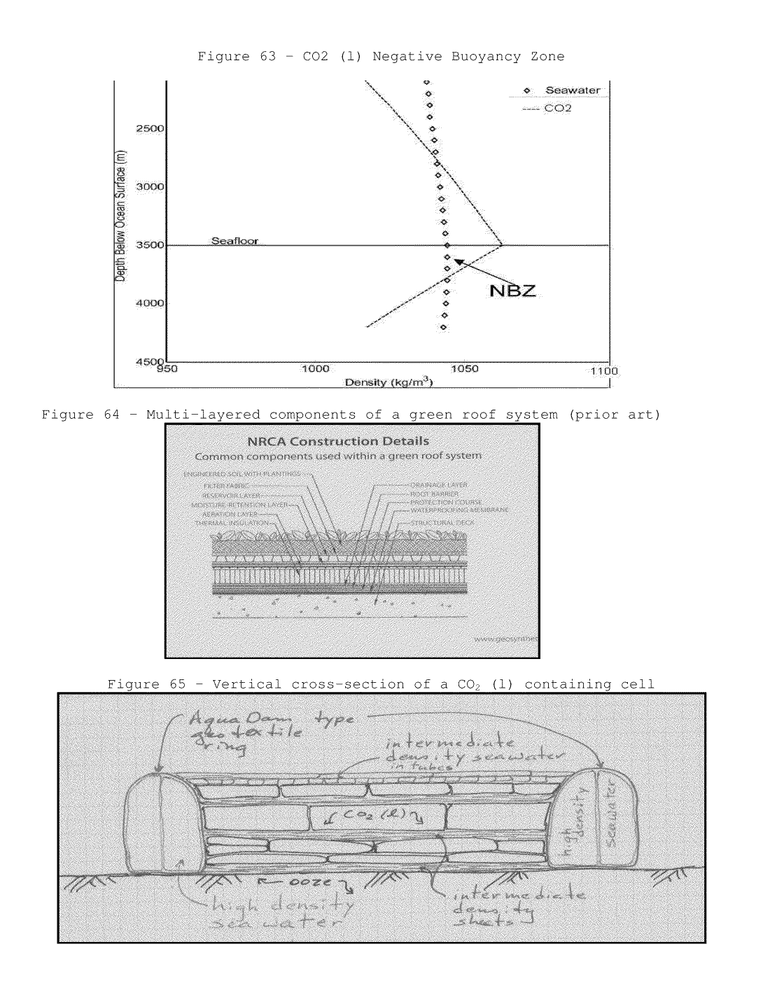

FIG. 63 and explanation are from House K. Z., Schrag D. P., Harvey C. F., and Lackner K. S., Permanent carbon dioxide storage in deep-sea sediments, Communicated by John P. Holdren, Harvard University, Cambridge Mass., Jun. 27, 2006 (received for review Nov. 10, 2005)

In FIG. 63, NBZ refers to the “negative buoyancy zone,” the zone where CO₂ (l) is denser than seawater. The Harvard, MIT, and Columbia University researchers were discussing injecting the CO₂ (l) a few hundred meters into seafloor ooze (marine sediments). It is important to note that the injection more than about 500 meters into the ooze reaches areas where the earth warmth renders the CO₂ (l) less dense than seawater. The same density relationships apply to geologic sequestration. That is the supercritical CO₂ of geologic sequestration will be less dense than surrounding liquids. It will it will not be stable. It will tend to escape back to the surface.

### Disclosure:

Placing the CO₂ (l) in a container avoids all the issues of other CO₂ storage systems. When the container is at the indicated ocean depths, the container walls are very lightly stressed, allowing for relatively inexpensive containers. Application Ser. No. 11/985,196 claims the general concept of employing a container in the deep ocean for the storage of CO₂ (l). 61/340,493 and 61/335,811 provide more details of container construction and use.

When employing flexible materials as containers, it is common to have several layers of different materials. FIG. 64 is an example of the multi-layered construction of a green roof system.

Similar layering can be employed when storing CO₂ (l) in the deep ocean. A sampling of material manufacturer's suggests options including:
Clay sandwich materials consist of a thin layer of bentonite (a special clay) sandwiched between layers of sheet or fabric. Manufacturers include gseworld.com and cetco.com. There are likely other materials (besides bentonite) which provide the desired self-sealing properties for CO₂ (l) that bentonite possesses when contacted by water.
Biocides may be embedded, attached to, or dissolved in the materials. The biocide properties may be prevented from leaching into the seawater or the CO₂ (l) by non-reactive layers that may, but need not be bonded to the biocide layer. Manufacturers include typargeotextiles.com. Note that in this situation, tiny salt particles or tiny “bubble” of fresh water may be adequate biocides as the lifeforms of the deep ocean should experience discomfort when encountering higher or lower salt concentrations.
Some materials can be primarily for strength, such as the fabrics and tubes manufactured by gseworld.com, typargeotextiles.com, maccaferri-usa.com, and prestogeo.com.
Other materials can provide strength with impervious coatings such as those made by fabinno.com.

By embedding particles in the materials, they can be made in a range of densities. That is the materials may “float” on ooze, but sink below CO₂ (l) or they could float on CO₂ (l) and sink in the surrounding seawater. Sheets of the latter density may be relatively small multi-layered pieces as an alternative construction for the “liquid skin” explained in 61/340,493. Note that the deep ocean pressure will increase the density of the materials, relative to their density at the ocean surface. This might be used to good effect by arranging a material with bubbles that collapse with depth. If the gas in the bubbles is predominantly CO₂, the resulting liquid CO₂ may be an adequate biocide when encountered by sea creatures attempting to bore through the material.

In general, the techniques and technologies employed for water-proofing roofs, water-proofing basements and tunnels, sealing landfills, sealing hazardous waste sites, protecting against soil erosion, and the like can be employed to make secure containers for CO₂ (l) in the deep ocean.

In addition to the micro-techniques of engineering the materials, the containers can be arranged to reduce the chance of leaks. For example, FIG. 65 shows a vertical cross-section of a multi-cell arrangement. In this case the arrangement consists of a bottom layer of intermediate density sheets, a layer of tubes containing CO₂ (l), a layer of sheets, a layer of CO₂ (l) containing tubes, another layer of sheets, another layer of CO₂ (l), and a layer of tubes containing intermediate density seawater (a liquid skin). In this construction the liquid skin and the intermediate density sheets may be swapped. The layers shown can be relatively thin (2-10 mil) plastic tubes (or sheets) filled to a depth of 0.1-1-meter with higher-than-CO₂ (l) density seawater.

A bottom layer of any of the above materials may be sufficient to prevent sharp objects (bones, plastic debris, etc.) from puncturing the CO₂ (l)-filled tubes. A woven or non-woven textile may have better puncture resistance when used for the bottom sheets or to armor the bottom tubes.

High-density seawater-filled tubes with roll prevention, such as AquaDams, or the roll prevention mentioned in 61/276,480 provide secondary containment walls. That is the CO₂ (l) tubes may be very thin (1-4 mil), sufficient to contain the CO₂ (l) while unsupported. The ring of strong tubes provide a completely redundant container because the CO₂ (l) will stay within the “pool” formed by the complete ring of high-density seawater filled tubes.

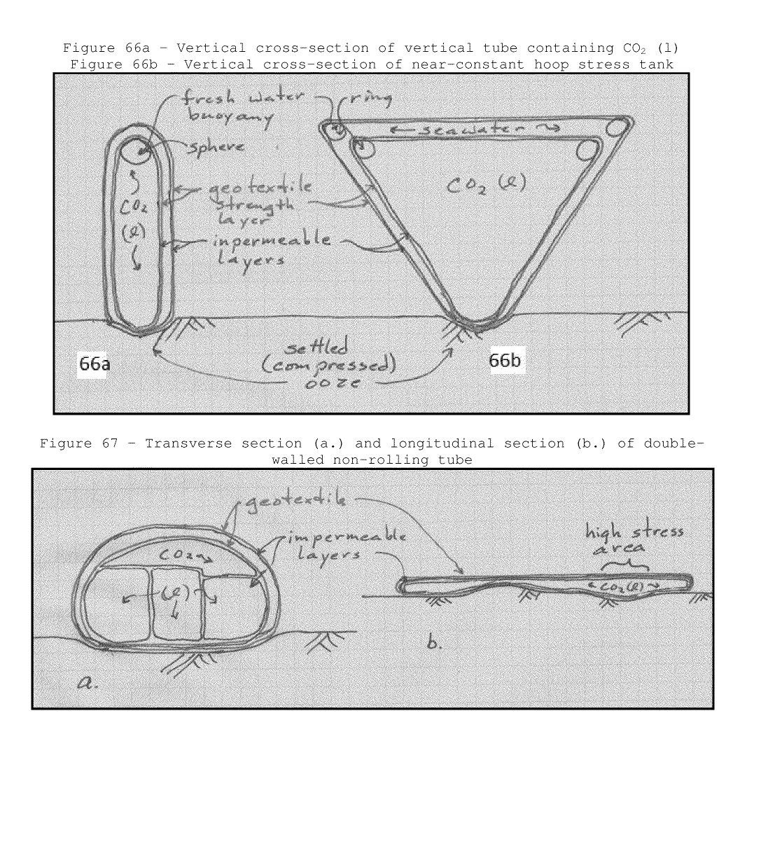

An alternative construction for the cells of FIG. 65 could employ a vertical honeycomb of CO₂ (l) tubes similar to the Typar matrix 3-D-Geotextiles and Typar Defencell. When ring of secondary containment, each vertical tube might have one thin impervious wall. The fresh water buoyancy shown in FIG. 66a would be useful for keeping the tubes “hanging” neatly during the filling process. After filling all the tubes inside a ring, they should resemble a honeycomb in plan view (prior to placing the intermediate density layer). This vertical arrangement may address the issue of differential settlement, discussed in more detail below.

Yet another alternative is shown in FIG. 66a. Each vertical tube may have secondary containment and be independently supported with a floatation component. In the vertical tube, most of the stress on the geotextile strength layer is hoop stress. The inside impervious layer (1-4 mil sheet) is supported by the inside geotextile. The only vertical stress is generated by the float, which may be volume of fresh water or any lighter than water object. A layer of ambient density seawater is between the inside and outside layers. The outside layer forms a secondary container. Because the outside layer contains ambient seawater it may be unstressed. If the seawater layer is pressurized, then the outer layer would “take over” relieve the hoop stress on the inner layer. Note that any leaks of CO₂ (l) from the inner layer will tend to accumulate at the bottom of the space between the two layers. As the leak dissolves into the layer of seawater, it will tend to form hydrate. Hydrates are even denser than CO₂ (l).

The vertical arrangement maximizes the volume of stored CO₂ (l) per surface area of ocean floor.

Because hoop stress in a vertical tube or cylindrical tank dictates the strength and expense of the fabric (textile walls) it may be advantageous to employ a configuration where the hoop stress is relatively constant. FIG. 66b shows a point-down conical shape. Because the diameter is smaller at the bottom, the hoop is more uniform with depth than would be the case with a cylindrical tank. Note that the difference in CO₂ (l) and seawater density increases with depth. Of course this arrangement competes with the traditional cylindrical tank, or the honeycomb of cells inside a secondary containment wall for cost-effective storage volume and robust stability under subsea conditions.

FIGS. 66a and 66b both address foundation issues. The seafloor ooze is a soft foundation, meaning it will be settling (compressing) underneath the container of CO₂ (l). In FIGS. 66a and 66b, the structure load is more of a point load. It would tend to settle into the seafloor ooze without differential settlement issues.

The independent double wall construction can also be applied to horizontal tubes. The double-walled horizontal tube of FIG. 67, for example. Two or more internal tubes will resist rolling and could be placed along contour lines (lines of equal depth). (The multiple internal tube principal is employed by AquaDam to prevent transverse rolling. Multiple longitudinal tubes will prevent longitudinal rolling.)

The exterior textile wall may initially be lightly stressed by inflating the space between walls with seawater. Because seawater has the same density as the surrounding water it tends toward a uniform space between inner and outer walls. (A denser fluid would tend to sink, providing more space on the lower sides and less space on the top.) Should the tube experience differential settlement along its length, the top of both tubes above high points will be more stressed longitudinally and similarly for the bottoms of both tubes above low points. Additionally, above low points as indicated in FIG. 67b, the CO₂ (l) will exert more outward pressure, which is controlled by the highest elevation (above settled seafloor) anywhere along the entire tube. In addition to fabric flexibility, the double-walled tube accommodates differential settlement by sharing the loads between the inner and the outer textile walls.

In FIG. 65, the sidewalls, because of their extra density may sink faster than the cell interior. This situation can be avoided by pre-compressing the foundation with the hydrostatic compaction explained in 61/341,693.

In all cases of double-walled containers mentioned above, the liquid between walls can function as a barrier to marine life by having unusually (to ambient life) low salinity, or high salinity, or high dissolved CO₂ concentration. Dissolved CO₂ increases water density allowing for the same density with less salt and more CO₂ or more salt and less CO₂. Different salts may also have advantages for cost, density, and biogrowth. Gels or hydrates of either CH₄ or CO₂ can substitute for a liquid between the walls.

Biologic growth may be harnessed to improve self-sealing properties. For example, including bacteria nutrients on the surface of the intermediate sheets, or the tubes, would cause them to be coated with a layer of slime. The slime layer on wall or sheet surfaces could be beneficial in preventing any leaked CO₂ from moving between the sheets or tubes.

Yet another option for Ocean Floor Container Carbon Storage (OFCCS) is produce hydrate particles and store those particles in the container. That is, store the CO₂ has a hydrate instead of as a liquid.

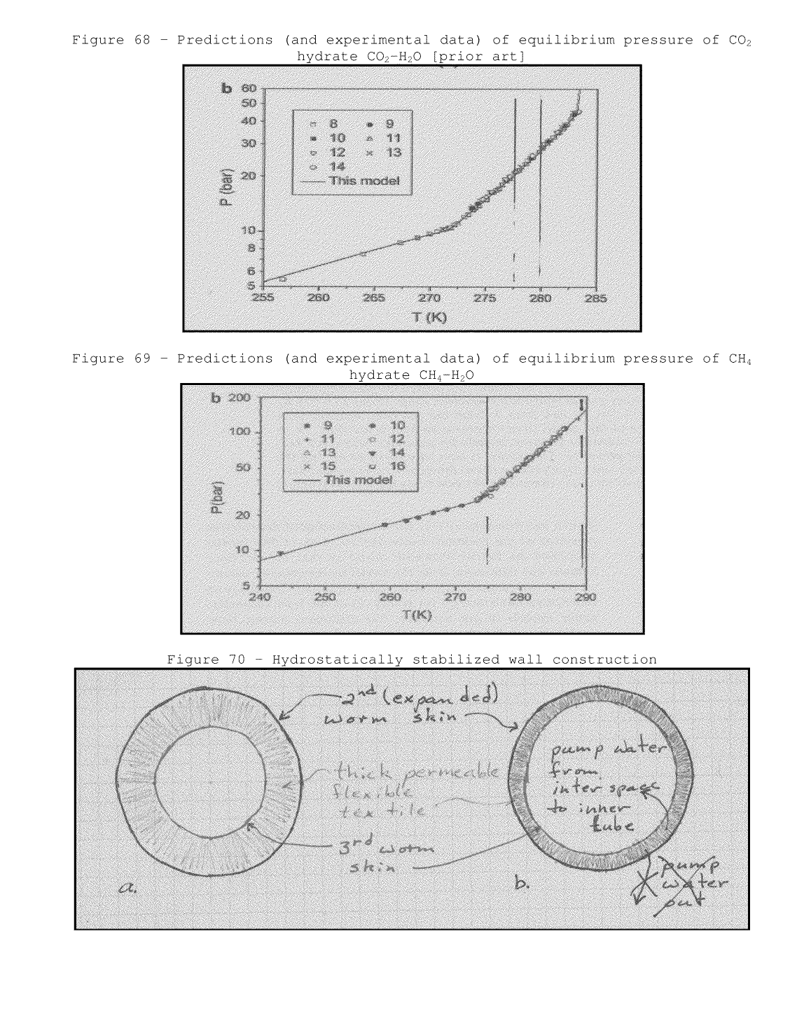

In FIG. 68, [prior art] the line of experimental data points represents the equilibrium conditions for CO₂ hydrate formation in water. The further the conditions are above and left of the line, the more CO₂ will become a hydrate. Typical deep ocean temperatures are bracketed by the vertical lines at 277.5° K (4.4° C.) and 280° K (6.9° C.). The equilibrium line is nearly vertical at 283° K from 40 bar (400 meters deep) to 100 bar (1,000 meters deep) and then continues to angle off to the upper right. That is, at the typical CO₂ (l) storage site, the 300-bar and 5° C. conditions strongly favor hydrate formation.

FIG. 68 [prior art] is taken from Rui S, Zhenhao, D, Prediction of CH4 and CO2 hydrate phase equilibrium and cage occupancy from ad initio intermolecular potentials, Geochimica et Cosmochimica Acta, Vol. 69, No. 18, pp. 4411-4424, 2005, Elesvier.

Hydrate formation can be employed in two ways:
1) When storing CO₂ (l) below about 3,000 meters the secondary containment is designed so that any CO₂ (l) escaping from the primary containment forms a hydrate that is contained between the primary and secondary containment.
2) Hydrates may be formed before, during, or after placement in the container. The CO₂—H₂O hydrate density is about 1,100 kg/m³ at the conditions of formation. That is substantially more than the 1,030-1050 kg/m³ of seawater*. Therefore, there may be ocean locations as shallow as 400 meters depth where the water temperature is always less than 9.4° C. and contained hydrate storage is stable. * Makio Honda, Jun Hashimoto, Jiro Naka, and Hiroshi Hotta, “CO2 Hydrate Formation and Inversion of Density between Liquid CO2 and H2O in Deep Sea: Experimental Study Using Submersible “Shinkai 6500”, in Direct Ocean Disposal of Carbon Dioxide, edited by N. Handa and T. Ohsumi, pp. 35-43, Terra Scientific Publishing Company (TERRAPUB), Tokyo, 1995

The advantages of storing contained hydrates (over storing CO₂ (l)) include:
1) Often a shorter distance from shore to sufficiently deep water for stable (higher density than seawater) storage.
2) Hydrates occupy less space than equilibrium saturated dissolved CO₂.
3) The hydrate formation becomes the primary container, with the impermeable membrane and textile wall forming the secondary container.

The disadvantage of hydrate storage is that it requires more volume than CO₂ (l). The hydrate will be about 152 g/mole, which is consistent with the hydrate's chemical composition of 6H₂O+CO₂.** The net result being the volume occupied by the CO₂ hydrate at 100% efficiency would be about 3.6 times the volume occupied by an equal mass of CO₂ stored as a liquid. Hydrate is formed by mixing CO₂ and water using any of numerous existing mixing, spraying, bubbling, pumping, and related technologies. ** Eric Wannamaker, “Modeling Carbon Dioxide Hydrate Particle Releases in the Deep Ocean”, Massachusetts Institute of Technology, June 2002.

Seawater with dissolved CO₂ is also higher density than seawater without dissolved CO₂. Therefore, dissolved CO₂ would be stable stored in containers on the seafloor. Suppose, for example, the storage site was at 600 meters depth and above the corresponding hydrate formation temperature of about 10° C. The maximum dissolved CO₂ concentration would be about 60,000 mg/L. That is, we would need to contain about 17 cubic meters of seawater saturated with CO₂ for every 1 cubic meter of CO₂ (l). (When calculating container size, that is 18 times the volume of the CO₂ (l).

FIGS. 65-67 and the figures in PODenergy applications 61/341,693, 61/340,493, 61/335,811, 61/280,280, 61/276,480, and U.S. application Ser. No. 11/985,196 apply to CO₂ storage in all three conditions: liquid, hydrate, and dissolved.

### 32. HYDRATE FORMATION FOR GAS OR SALT SEPARATION

### Capron

FIG. 69 [prior art] is taken from Rui S, Zhenhao, D, Prediction of CH4 and CO2 hydrate phase equilibrium and cage occupancy from ad initio intermolecular potentials, Geochimica et Cosmochimica Acta, Vol. 69, No. 18, pp. 4411-4424, 2005, Elesvier.

In FIG. 69 [prior art] the line of experimental data points represents the equilibrium conditions for CH₄ hydrate formation in water. The further the conditions are above and left of the line, the more CH₄ will become a hydrate. While 275° K (1.9° C.) is colder than many deep ocean locations, 280° K (6.9° C.) is warmer than many waters below about 2,000 meters. That is, the typical PODenergy anaerobic digestion operation will often be near water deeper than 1,000 meters and cooler than 285° K (11.9° C.), conditions that strongly favoring CH₄ hydrate formation.

The ambient conditions near PODenergy ecosystems, shown in FIGS. 68-69, allow the possibility of separating and purifying CH₄ and CO₂. Prior art includes using the formation of hydrates to purify (desalinate) seawater.

For example, the seawater that is fully saturated with dissolved CH₄ and contains a high concentration of dissolved CO₂ may be pumped to a condition where first CO₂ hydrates will form. The CO₂ hydrates are settled out of solution, before the solution is pumped to a condition where CH₄ hydrates will form and are removed from the solution. The hydrates may be stored or transported directly. Or they may be thawed and the purified gas or liquid stored or transported. Note the hydrates exist in an equilibrium condition with dissolved gas or dissolved liquid. Therefore hydrate formation will not remove all the dissolved gas. However, the opportunity remains for cycling the near saturated seawater to collect and remove gas without ever allowing the gas to come out of solution as bubbles of gas.

Alternatively, the liquid may be pumped directly to the conditions where both hydrates form. It is possible forming particles will be primarily one or the other gas. The resulting hydrates could be separated employing typical processes for separating particles of different density. Also, because of the different equilibrium situations (the CH₄ is saturated, the CO₂ is generally much less than saturated), the CH₄ may form hydrates at a higher rate than the CO₂.

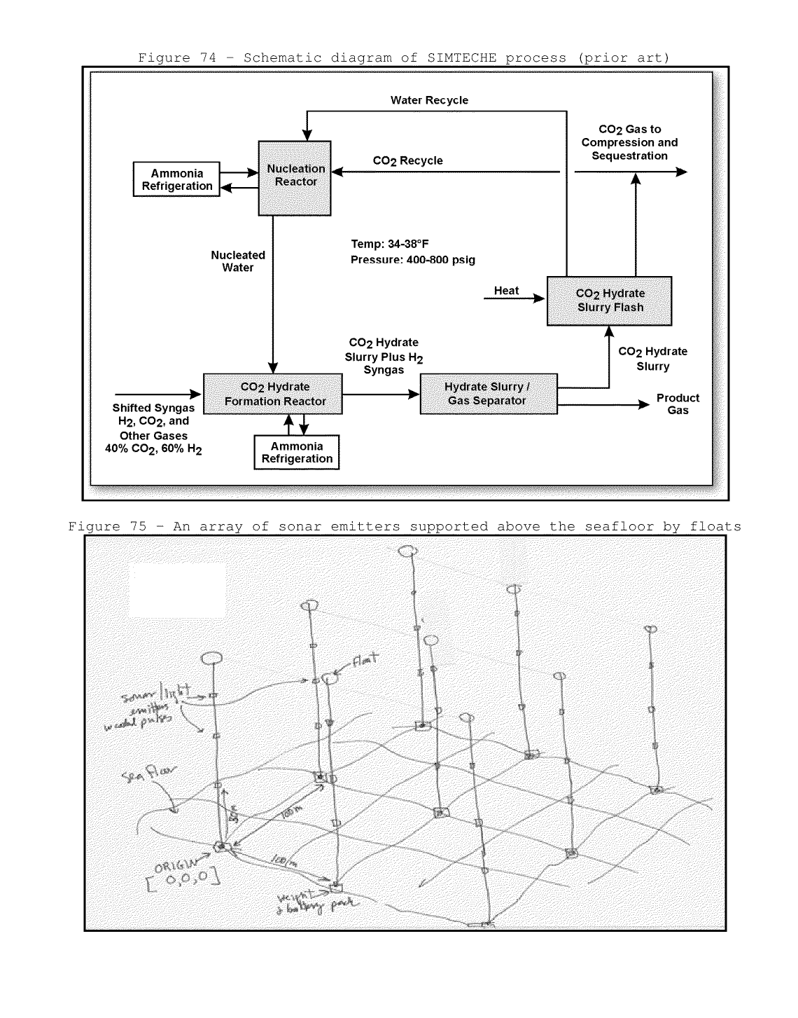

FIG. 74 with the description of the SIMTECHE process and the figures in PODenergy applications 61/341,693, 61/340,493, 61/335,811, 61/280,280 concerning gas and liquid separation apply to gas and liquid separation by hydrate formation and thawing.

### 33. ADDITIONAL CO₂ CAPTURE

### Capron

In one respect U.S. application Ser. No. 11/985,196 and the processes mentioned in provisional patent applications 61/341,693, 61/340,493, 61/335,811, 61/280,280, and 61/276,480 may not have been clear. There will be some residual dissolved CO₂ until the water from the processes mentioned in those applications off-gases at 1-bar, or lower, pressure. Therefore, it is desirable to move water from submerged processes containing dissolved gases (including CO2 and CH4) in excess of their 1-atm equilibrium concentrations to the ocean surface and then collect such residual gases as they come out of solution.

### 34. IMPROVED HYDROSTATICALLY STABILIZED WALL

### Capron

The hydrostatically stabilized wall described in 61/341,693 is more easily produced if the water trapped between the pipe walls is pumped into the interior tube, as show in FIG. 70.

The construction portrayed in 61/341,693 works well when the objective is to shrink the outer wall toward the inner wall. The construction of FIG. 70 works better when the inner wall is expanded toward the outer wall. The claims for the hydrostatically stabilized wall are unchanged.

### 35. IMPROVEMENTS TO THE MECHANICAL ROOT

### Capron

U.S. provisional application 61/341,693 and 61/343,572 describe new variations of the mechanical root intended for less expensive cable, pipeline and container installations.

The prior art includes directional drilling and boring. The distance reached with current boring directional drilling technology is limited by friction force along the bore hole when rotating or pulling pipe casing or when pulling pipe into the casing.

### Prior Art

Wikipedia Apr. 16, 2010—Survey tools and BHA designs made directional drilling possible, but it was perceived as arcane. The next major advance was in the 1970s, when downhole drilling motors (aka mud motors, driven by the hydraulic power of drilling mud circulated down the drill string) became common. These allowed the bit to be rotated on the bottom of the hole, while most of the drill pipe was held stationary. Including a piece of bent pipe (a “bent sub”) between the stationary drill pipe and the top of the motor allowed the direction of the wellbore to be changed without needing to pull all the drill pipe out and place another whipstock. Coupled with the development of “Measurement While Drilling” MWD tools (using mud pulse telemetry or EM telemetry, which allows tools down hole to send directional data back to the surface without disturbing drilling operations), directional drilling became easier. Certain profiles could not be drilled without the drill string rotating at all times.
The most recent major advance in directional drilling has been the development of a range of Rotary Steerable tools which allow three dimensional control of the bit without stopping the drill string rotation. These tools [Revolution] from Weatherford Drilling Services, Well-Guide from Gyrodata, PowerDrive from Schlumberger, AutoTrak from Baker Hughes, PathMaker from PathFinder Energy Services (a division of Smith Intl, Inc), GeoPilot & EZ-Pilot from Sperry Drilling Services/Halliburton) have almost automated the process of drilling highly deviated holes in the ground. They are costly, so more traditional directional drilling will continue for the foreseeable future.

Near-surface directional drilling, the kind for water pipe or cable installation, employs a bentonite slurry to maintain the bore hole in a three or more step process:
1. Drill the pilot bore with a drill bit that is rotated via a long string of drill pipe with an above-ground rotating motor.
2. Pull a rotating flycutter back through the pilot bore to enlarge the hole diameter.
3. Pull a rotating barrel reamer through the hole ahead of the non-rotating pipe casing.

### Disclosure:

As explained in 61/341,693, the improved mechanical root nearly eliminates the friction of long distance (many kilometers or miles). The following improvements better explain guiding the tip of the root through different substances.

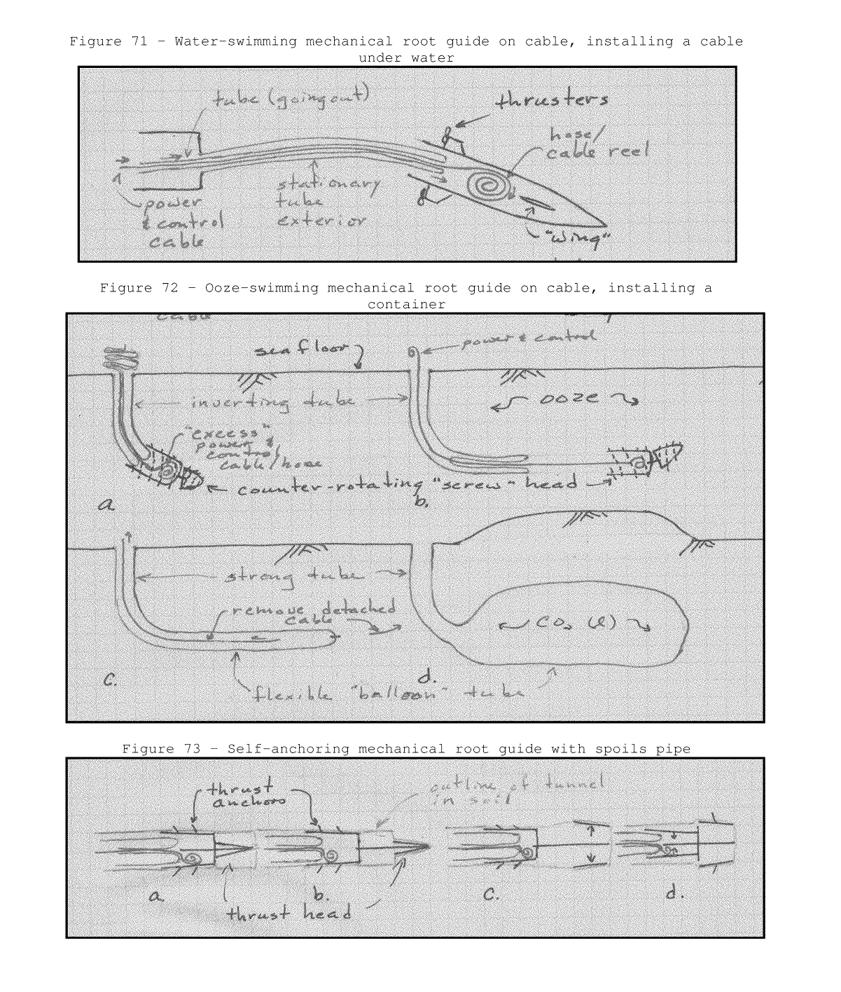

FIG. 71 shows a thruster-powered guide leading a mechanical root through water. The power for the thrusters comes from the power and control cable. A “wing” allows the guide to change depth using hydrodynamic force instead of, or in addition to, changes in buoyancy. This arrangement may employ the guide to “fly” low over the seafloor while the tube is extruded from shore or a stationary vessel. The tube either is or becomes the conduit for installing pipelines, cables, or containers.

The power and control cable is carried inside the extruding tube. Note the power and control cable is pushed through the extruding tube at twice the speed of the advance of the mechanical root. That is, the reel of cable inside the guide is collecting cable, not paying out cable. The cable is as easily folded or coiled without a reel.

FIG. 72 shows an elevation of a mechanical root system for burrowing through soft sediments, such as seafloor ooze. FIG. 72 does not show the devices which would feed the extruding tube or pressurize the finished product as those are not important to the action of the mechanical root.

In FIG. 72a the root guide (aka screw head) consists of a cone and a cylinder which are counter-rotating. The surfaces of both cone and cylinder have a raised helix such that their rotations screw the guide through the soft sediment. The axis of rotation of the cone can be adjusted to an angle different from the axis of rotation of the cylinder, thus allowing the guide to change direction.

In FIG. 72b the guide is shown separating from the advancing root tip and the far end of the extruding tube can be seen. The separation may be delayed until the end of the tube is in position. Note that during separation, the extruding pipe will be feeding power cable, but the guide will need to pull the power cable behind it, unless the guide pays out the “excess” power cable it has accumulated.

In FIG. 72c, the power cable is detached from both sides of the end of the extruded tube. The guide is not visible, having traveled back above the surface of the seafloor. The guide is retrieving the detached power cable on its side. Likewise the cable that was in the extruding tube is retrieved. A length of power cable may remain embedded in the end of the extruded pipe to prevent a weakness, should the power cable be pulled out.

In this container installation, the extruded tube has a strong section at the beginning and at the ending tip. The strong sections will not expand under pressure. The ending tip will not expand substantially into the void left by the guide. The remainder of the extruded tube is flexible and with “gathered” excess material. When liquid or slurry is pumped into the flexible volume, it expands. The expansion compresses the seafloor ooze and lifts it. Note that ooze has the characteristics of a damper. Expanding slowly over time will allow it to consolidate and lift with less force than employing a rapid increase in pressure. In FIG. 72d the “balloon” portion has been expanded and is storing CO₂ (l) inside a container that has the secondary containment of seafloor ooze. The compressed ooze will be a better secondary container of CO₂ (l) than the undisturbed ooze. Ooze creatures are undisturbed because they detect nothing unless they find the tube wall. In addition to valves (not shown), the “strong” portion of tube may be plugged with a combination of hydrate and seafloor ooze.

### 36. SUBMERGED SIMTECHE PROCESS

### Capron

The National Energy Technology Laboratory published a project fact sheet in April 2008, “Carbon Dioxide Hydrate Process for Gas Separation from a Shifted Synthesis Gas Stream.” Excerpts of the prior art fact sheet explain:
One approach to de-carbonizing coal is to gasify it to form fuel gas consisting predominately of carbon monoxide and hydrogen. This fuel gas is sent to a shift conversion reactor where carbon monoxide reacts with steam to produce carbon dioxide (CO₂) and hydrogen. After scrubbing the CO₂ from the fuel, a stream of almost pure hydrogen stream remains, which can be burned in a gas turbine or used to power a fuel cell with essentially zero emissions. However, for this approach to be practical, it will require an economical means of separating CO₂ from mixed gas streams. Since viable options for sequestration or reuse of CO₂ are projected to involve transport through pipelines and/or direct injection of high pressure CO₂ into various repositories, a process that can separate CO₂ at high pressures and minimize recompression costs will offer distinct advantages. This project addresses the issue of CO₂ separation from shifted synthesis gas at elevated pressures.
The project is concerned with development of the low temperature SIMTECHE process, which utilizes the formation of CO₂ hydrates to remove CO₂ from a gas stream. Many people are familiar with methane hydrates but are unaware that, under the proper conditions, CO₂ forms similar hydrates. In Phase 1, a conceptual process flow scheme was developed. See FIG. 74. The thermodynamic limits of such a process were confirmed by equilibrium hydrate formation experiments for shifted synthesis gas compositions, and rapid hydrate formation kinetics were demonstrated in a bench-scale flow apparatus.

Accomplishments (Prior Art):
Demonstrated the viability of low-temperature CO₂ separation from a mixed-gas stream through the formation of CO₂ hydrates.
Potential 68 percent CO₂ removal was demonstrated during once-through operation at 1000 psi without promoters.
Potential 90 percent CO₂ removal was demonstrated with promoters.
Confirmed design residence time assumptions on both a kinetic and heat transfer basis.
Engineering analysis showed that a two-stage Simteche process with a promoter and 90 percent CO₂ removal was most economic, and compared favorably with a two-stage Selexol process.

The discussion and FIG. 74 diagram indicate the SIMTECHE CO₂ hydrate formation reactor and the hydrate slurry/gas separator were operated at about 1,000 psi (68 bar, 680 meters deep) and temperature between 34-38° F. (1-3° C.). This is consistent with our understanding of equilibrium hydrate formation conditions from FIG. 68. Operating at higher pressure would allow higher temperatures, which may enable the use of ambient ocean water for cooling, instead of the ammonia refrigeration. The above discussion of hydrate storage density and volume as well as the discussion of gas separation applies here.

Both the CO₂ hydrate formation reactor and the hydrate slurry/gas separator may be constructed of relatively inexpensive thin flexible film when submerged in the ocean. The figures for the submerged SIMTECHE process are essentially identical to those provided in PODenergy's previous submerged chemical and biological process disclosures. The other submerged processes include:
Ser. No. 11/985,192—Water-supported anaerobic digestion processes
Ser. No. 11/985,192—A second container purifying the gases produced during submerged anaerobic digestion
Ser. No. 11/985,192—Separating liquid phase CO2 from other liquids
61/280,280—Separating CH4 as CO2 liquefies with a “trap” at ˜500 meters depth
61/335,811—Submerged pressure swing adsorption in thin containers with compression filler material
61/335,811—Submerged forward osmosis process
61/335,811—Submerged microbial fuel cell (MFC)
61/335,811—Submerged electromethanogenic systems (EMG)
61/335,811—Submerged MFC and EMG battery
61/340,493—Submerged supercritical CO2 processes
61/340,493—Systems for sparging dissolved gases at depth
61/340,493—A submerged heat and pressure process for removing dissolved CO2 at depth
61/340,493—Submerged process for converting CH4 to liquid or solid fuel (Fischer-Tropsch)
61/341,693—Submerged gas compressor of thin skin with compression filler material
61/341,693—Submerged carbon nanotube gas storage system
61/341,693—Ocean-based reverse osmosis employing thin skin with compression filler material
61/341,693—Solid nitrogen “ice” chips in liquid nitrogen for cooling superconducting cable
61/341,693—Superconducting cable cooled by supercritical fluid

The drawings of all above are incorporated by reference. The drawing associated with 61/340,493 “Submerged supercritical CO₂ processes” most closely matches the control of pressure and temperature which is employed in the submerged SIMTECHE process.

### 37. POWER CONSERVATION

### Sudia

Process equipment and scientific instruments require significant current flow to perform tasks and make measurements; however in deep sea operations battery power is a scarce resource. To conserve battery power, in one embodiment, care is taken to only activate current to the equipment for brief periods of time, just enough to accomplish the desired task, and no more. This is accomplished by using a low powered CPU or clock circuit in the sensor, controller, or power unit that only wakes up periodically when the next measurement is to be made and otherwise remains off. Such power management strategies can greatly extend the battery life of remotely operated instruments.

The drawings of equipment and instruments in the previous applications apply. Therefore in all cases of making measurements, of salinity, dissolved gases, water depth, etc. it is desirable to turn off equipment and instruments between activities and measurements, e.g., by means of a clock that governs the respective instrument's on cycle.

### 38. ADDITION TO METHOD OF FERTILIZING AN OCEAN REGION

### Sudia

This technological art was previously discussed in 61/340,493 above.

General Concept:

To counteract human-induced climate change it is desirable to grow large amounts of biomass to absorb and sequester CO₂ from the Earth's atmosphere. There is not enough land or terrestrial water for such biomass growth, so it must be done in the oceans, where there is ample water, open areas, and light.

It is also not enough to only grow the biomass. To attain permanent reductions of atmospheric CO₂ levels, the biomass must be harvested and have its carbon extracted and sequestered.

Growing large amounts of oceanic biomass for subsequent harvesting is a non-trivial task, due to the dynamic nature of the world's oceans, which among other things have complex currents, tides, winds, and storms. Attempts to cultivate biomass near major ocean currents are problematic because, unlike land based farming, the currents will convey the biomass far away from its original site before it matures enough to be harvested.

Also, many parts of the ocean surface are relatively sterile, while cooler waters several hundred meters down are commonly laden with nutrients, whereas only the top 10 meters or so have sufficient light for plant growth. To promote biomass growth, and related fisheries development, it is generally necessary to have some force, such as the mixing of currents, upwelling currents, or deep currents that strike obstructions such as seamounts, to drive the intermediate nutrient laden water (NLW) to rise up and mix with surface waters, to fertilize them.

Such cold upwelling currents, in addition to producing rich biomass, species diversity, and fishing grounds, commonly produce fog, which result from moisture laden air coming in contact with colder waters from the depths, as along the US Pacific coastline.

However, despite the ceaseless flux of currents in the world's oceans, there are some areas of relative surface stability, namely the 5 major oceanic gyres, and other lesser gyres. Here, although the gyre is in continual circular motion, nevertheless biomass that was planted, fertilized, and/or grown in surface waters, suitably fertilized with NLW from below 100 meters, will tend to remain localized within the oceanic gyre over long periods of time, long enough to grow to maturity and be available for economically efficient harvesting, within a reasonable proximity to fixed oceanic stations for processing it, for example via the Capron anaerobic digestion and sequestration process.

The proof of this is the presence of large quantities of plastic and other trash, especially in the north-central North Pacific Ocean, which has been called “the great garbage patch.” Thus although some organic material that was grown in the North Pacific gyre would probably escape and go floating elsewhere in one or more of the major ocean currents, large amounts of it will remain and be capable of being harvested and processed.

The ocean gyres are analogous to a photograph record (or CD). That is the PODenergy process equipment can be in a generally fixed location, like the phonograph needle. The first equipment installations might be near the gyre's “center.” Subsequent installations are farther from the center. The stations would be located around the phonograph record where roughly “equal areas in equal times” will sweep past them. (More stations at greater radii from the “center.”) Each station will harvest the biomass which started growing with a dose of nutrients from the stations before it, at approximately the same radius.

The equipment may sweep a swath perhaps 5-10 km wide. The equipment is “dragging behind” the attachment point. No energy expended to move the equipment (the energy is from the sun causing the currents). Other renewable energy wave dynamics, solar, or wind power will accomplish the work of moving and distributing nutrient laden water and harvesting biomass.

Instead of very large but passive equipment, tethered vessels may employ the current to sweep the equipment back and forth like a fighting kite employs aerodynamics or a water skier employs hydrodynamics to sweep back and forth. The vessel employs a “wing keel” to “fly” sideways in the current. This sweep may be vertical as well as horizontal. That is, the vessel may have wings for carrying loads up and down over the depth of the current.

That is, the stations all remain more or less permanently fixed, and all functions remain station based. The stations are all very similar and thus easily mass-produced. Vessel locomotion costs are small, mainly for harvesting, because the biomass comes to a station (equipment), rather than the station going to the biomass.

The phonograph record will not always rotate exactly the same. Dynamic adjustments, such as moving the stations (slowly) towards or away from the center, along the radius, may be needed to intercept regions we want to process (fertilize or harvest). One means for moving stations is discussed in 61/340,493.

In the long-term, the PODenergy ecosystem is not limited to ocean gyres. The toss & catch of biomass can be employed nearer the Equator where there is more sun and warmth. The process is not bound to any location, since NLW is everywhere below about 100 meters depth.

Also in the long-term, the PODenergy ecosystem lends itself to being the “work” or livelihood of huge floating cities in the ocean (SeaStead). People would live well eating seafood, using any of several renewable energies to distill water, enjoying moderate temperatures year round.

### Area Selection:

In a large body of water, such as an ocean or sea, identify an area that has, for at least part of the biomass growing year, a circular current circulation. Also identify its approximate center of circulation, or point of least motion, since activities performed there will tend to be the most protected from lateral movement, whereas activities performed further away, at a greater radius from this center, will experience greater circumferential motion, and greater possibility of being swept away by the surrounding currents. The approximate center of circulation (ACC) may migrate around a relatively wide area due to seasonal or other factors.

Preferably also identify a suitable point of land above sea level for use as a human base of operations, such as shown in the following Table F:

TABLE F
The Five Main Oceanic Gyres

| Oceanic Gyre | Land Near Center |
|---|---|
| North Atlantic | Bermuda |
| South Atlantic | St. Helena (UK) |
| North Pacific | Hawaii (USA) |
| South Pacific | Easter Island (Chile) |
| Indian Ocean | Ile Amsterdam (FR) |

### Fertilization of Surface Waters:

Starting with the approximate center of circulation, begin operations to a) fertilize the surface waters, such as by inducing NLW from below 100 meters to rise up and mix with surface waters, and b) seed or populate the area, if necessary or desired, with appropriate species of plants including algae, plankton, kelp or other forms of seaweed, and so on. After plant growth has attained the desired annual yield, sustainable processes which recycle the nutrients, e.g. PODenergy process, would no longer require NLW.

Work outwards from the approximate center of circulation, such as in a spiral, so that the areas developed for ocean cultivation of biomass remain well within the stagnant area of the oceanic gyre.

Any of the fertilization methods mentioned may also be employed for nutrient recycling. Methods to induce fertilization of surface waters can include any or all of the following:
1. Provision an irrigation vessel, which may be a motor craft, sailing vessel, or autonomous solar powered craft with a deep water pipe that can reach down at least 100 meters deep. This suction pipe can be dragged along behind/under the vessel, or it can be deployed episodically, pulling up the pipe when in motion to a new area, then letting it down again, sucking for a while, then pulling it up again to move to the next area.
2. Deploy a series of Salter wave pumps, which use wave action to force surface waters to or below 100 meters, where it displaces cooler NLW and causes the NLW to rise up and mix with surface waters. Such wave pumps can be modified to add remotely controlled side water jets, to provide steering, allowing a row of such pumps to traverse and fertilize a swath of ocean. However their rate of motion would be quite slow, probably under 1 mile/day.
3. Utilize other wave dynamics pumps, such as linked-jointed cylinders that ride on wave swells and generate internal mechanical power, which can be used to run an electric generator. Except in this case replace the generator with a piston or centrifugal pump that sucks water up a pipe from below depths of 100 meters.
4. Create an artificial obstruction on the sea floor (as described elsewhere in this provisional application), in the nature of an “artificial seamount,” that can disturb a portion of a deep cold current, causing eddies or upwellings above and downstream of the point of disturbance. Some oceanic gyres appear to have cold deep currents running under them from which if a small fraction was disturbed could send eddies of cold water swirling towards the surface, to a desired location.
5. Recycle the nutrients recovered from digestate water, i.e. the water remaining in an anaerobic digester according to the Capron process. This water may be the preferred source of nutrients, because it closely replaces the quantity and quality of nutrients removed from the system by biomass harvesting and digestion. Thus over the long term it may be desirable to rely on this Capron digestate return cycle, which is extensively documented elsewhere in these related disclosures, for the majority of nutrient fertilization of surface waters.
6. Disturb sea floor ooze and pump the resulting mud to the surface. To minimize harm to abyssal life, it may be preferable to first disturb the ooze, such as by plowing it with a submarine craft, wait some period of time (several hours to several days) for the abyssal life to settle back down on the bottom, then use a suction hose to vacuum up mud laden water some distance above the sea floor, such as 20-30 feet, thus reducing or mitigating damage to bottom-dwelling life.
7. In a gyre, model the ocean surface as a slowly turning phonograph record, and then anchor equipment units at various points along the path of growing material. Application 61/340,493 explains means for moving the anchored equipment. Movement allows for more accurate interception of the floating biomass.
8. Any other means of providing nutrients essential for plant growth, which could include importation of fertilizer laden water from the mouths of rivers, or the like.

Disturbance barriers are explained in 61/340,493. The disturbance barriers can be specially designed to promote upward propelled (vertical) loop eddies, like the horizontal loop eddies that are seen to break off from major surface currents, such as the Gulf Stream in the North Atlantic and the Loop Current in the Gulf of Mexico. The production of eddies in moving fluids is well known in the fields of aerodynamics and hydrodynamics. Such vertical loop eddies can be produced at such deep ocean locations that they will naturally rise up and cause mixing of nutrient laden water with surface waters in desired areas, such as in oceanic gyre surface areas.

In an alternative embodiment the barrier can also be engineered to expose the deep current to an irregular surface to promote mixing. However in all cases preferably care should be taken to disturb only a fractional portion of the deep current, since the deep ocean conveyor belt currents are critical to maintaining world climate and any major disturbance could result in undesired climate, changes.

When employing a Salter pump for NLW distribution, rather than individual point-like pumps, envision 2 (or more) craft spaced at (say) 1 km (or 0.5 km) intervals, steaming in direction X. Each craft having a pump that can suck deep water up a pipe, and strung between each of them is 1 km (or 0.5 km) of fertilizer “irrigation” pipe with holes in it, say every 0.5 m, held from sinking by floats every 10 m. Each craft pumps up deep water, but rather than just dump it over the side, where it might rapidly sink back below the 10 meter depth. The water is instead sprinkled gently over a long width. The long width generates a large area where the NLW mixes with surface waters. Additional dragging objects could be employed to improve surface mixing.

The long width approach absolutely guarantees 1) big & uniform area coverage, and 2) adequate surface mixing with no chance of the cold/dense water sinking back below 10 meters deep.

Employing a multitude of remotely operated valves controlling the discharge at points along the fertilizer pipe can 1) assure pressure equalization midway between the craft and 2) allow dispensing the fertilizer water in a pattern. The pattern may match the areas of low biomass growth identified by remote and local sensing.

Horizontal drag on the deep suction pipe may be minimized by configuring it like a very deep keel. A heavy weight at the bottom and a lozenge-like cross section would allow a reasonable speed, say 0.5-5 knots, without concern that the suction pipe will rise up and drag behind, loosing contact with NLW. The design of deep keels on sailing craft is a well-known art. The keel can be instrumented with pressure, temperature, and velocity gauges, to assure it remains correctly positioned, even if the keel pipe is made of relatively cheap plastic.

The keel must endure considerable force as the vessel plows through the water. That force may be supported with one or more cables attached to the prow of the vessel. The prow would be elongated and have adequate buoyancy so that the force on the keel is supported primarily by the buoyancy and compression, rather than bending moments.

The vessel can be long thin monohull sailboats relying on the keel for stability with tremendous wing-sails. The vessels may employ hard wings, instead of fabric, for better survivability. The hull might be wide because speed is not as important. The hull may even be the container for a sleek version of the Salter wave pump. One big check valve in the front of the vessel would “scoop” the wave crests into the hull and pump water down.

If the long keel or the supporting wire catches sargassum, they would employ knife edges. The wire would be made as a cutting ribbon (band saw).

Wind energy may replace or substitute for wave pumps. The vessels may have wind turbines instead of wave pumps. Once ecosystems are established the vessels can be converted from NLW to nutrient recycle by removing the keels and configuring them for operations mentioned in PODenergy's US provisional patent applications of Apr. 2, 2010, 61/340,493, 61/335,811, 61/280,280, and 61/276,480, and U.S. application Ser. No. 11/985,196.

### Control of Operations:

The Sudia-Capron method to grow and harvest ocean biomass complements the PODenergy process to digest biomass. The growing and harvesting requires wide-ranging equipment.

Fertilizer distribution and harvesting should be satellite-guided. To start, NLW irrigation equipment is sent areas that seem suitably stagnant and low in chlorophyll. Harvesting equipment is sent to areas that seem teeming with biomass. Once we start recovering digestate water from the PODenergy anaerobic digestion process, our equipment will move and disperse it near the digester.

The objective is to establish a cyclical pattern of irrigation and harvesting that is timed to the growth cycle of the biomass. That is, if the biomass replenishes itself in 90 days, we send the irrigation (and seeding) equipment into areas on day X, and then the harvesting equipment follows on day X+90, at the location of the biomass on day X+90. The biomass growth areas are sized to keep the equipment busy, while allowing some of the growth to increase ocean species diversity, generate food for humans, and avoid the “dead zone” effect of biomass that dies and decomposes before it can be harvested.

Conventional farming makes much use of cornrow patterns; the equipment can cover roughly square or circular areas by tracking down adjacent parallel lines in alternate directions. However, the GPS system also allows any pattern because moving equipment (or stationary equipment in a current) can act like an inkjet printer. It is possible to grow biomass in a pattern visible to passing aircraft as inspirational messages, iconic figures, and commercial advertising.

The equipment can operate at night, either using GPS based on imagery from the preceding day, or possibly even using nighttime IR (infra red) satellite imagery. Chlorophyll is mainly detected by its IR signature.

The operating model is to start near each approximate gyre center and build outwards, using daily satellite (chlorophyll) imagery to drive fertilizer and harvester equipment. The operation can include a predictive current model (like weather forecasting) that tells if some apparently fleeing biomass will likely come back around, so waiting is the best action. Once the PODenergy system is operating in multiple gyres, one can collect biomass that escaped from another gyre.

The operation can involve the release of cheap free-floating GPS beacons to track physical surface currents. If the beacons float too far off the “edge” of a megafarm (large biomass area) they may be collect and reposition, or just let them go—if the cost of doing so is less. Any ocean or beach equipment can be employed to perpetually collect current beacons from outward locations, replace batteries (if they are not solar powered), and redeploy them.

In most cases, the equipment will be employing global satellite up-dn link services, in addition to remote sensing. Both are readily available, for some price.

The drawings of ocean biomass equipment are included herein by reference of PODenergy provisional patent applications of Apr. 2, 2010, 61/340,493, 61/335,811, 61/280,280, and 61/276,480, and U.S. application Ser. No. 11/985,196.

Fog over fishing grounds results from cold water rising to the surface. Rather than fertilize large areas at once, the fertilization would be “spotty,” progressively over an extended area, so the inevitable fog will be of limited extent (at any one time) and not shroud the entire growing area.

The equipment will generally be submerged, or designed for submergence to below 100 meters upon several hours' notice. Submerging avoids storm waves, wind, and shallow surface currents of even the largest storms. In some cases, the growing biomass will submerge. For example, application 61/340,493 includes a kelp forest with adjustable root depth. The presence of perennial trash & sargassum gyres suggests ocean biomass is not substantially moved by storms.

After the storm passes, and all the craft resurface, new satellite images will show if and where the biomass has moved. Equipment with damaged transponders can also be found by satellite image. Models predicting biomass movement during storms will be developed and improved with each storm. The models would allow for the subsurface movement of the PODenergy equipment during the storm such that the equipment pops to the surface within working distance of the biomass as soon as the storm ends.

Existing internet sites, such as www.oceanweather.com will provide increasingly accurate wave height and direction data and forecasting. The existing information can be used to select equipment characteristics—length, width, draft, freeboard (if any), hydrodynamics, etc.

In some cases, it will be desirable to capture “escaped” biomass, even if doing so entails a cost. For example, suppose escaped biomass threatens to engulf Tahiti beaches finds with decaying biomass and ecologically diverse sea snakes. The biomass will be tracked via satellite and suitably equipped buoys, allowing the airdrop harvesting and digesting equipment in its path.

### 39. ADDITION TO ROBOT REPAIRS

### Sudia, Capron

Application 61/340,493 above discusses and includes a drawing of underwater robots employing a three-dimensional grid of sonar signal emitting devices.

If the work site is on the sea floor, this 3D sonar grid can take the form of a series of ropes, each with one end attached to the sea floor, and the other held aloft by a float. At intervals along each rope, such as every 20 meters, a sonar emitter with a unique frequency or pulse pattern is attached. A battery is provided which sits on the sea floor. Normally the sonar transmitters are off to conserve battery power. When activated, such as upon human input, by a pre-programmed timer, or by the presence of autonomous craft, the emitters “wake” up and start emitting a distinctive sonar signal.

To minimize cacophony, the emitters are programmed or timed to emit sonar pulses only intermittently, such as every 60 seconds, and to do so in sequence, like a set of Christmas lights. At the time the pulse is emitted, or shortly after, each device may also emit a brief flash of light, for further orientation.

Many such ropes with a weight and battery on one end, a float on the other, and emitters in between at intervals of 20 meters, can be placed along the sea floor, at the vertices of a grid, such as a set of squares each 100×100 meters, thus placing a beacon with a unique signature signal at every vertex within a 3 dimensional solid volume. Quite possibly the bases of these vertical lines will be at different heights, due to aberrations in the sea floor, however this can be mitigated by either a) adjusting the rope height, possibly with a small motorized winch, to cause all its beacons to be more level with those of other ropes, or b) causing the autonomous craft to calibrate and allow for their corrected 3D positions in its computer model of the job site.

The emitters may include accelerometers and pressure sensors which would enable deactivating or correcting their signal, should they be jostled by currents, creatures, or equipment. Similar to GPS systems, one or more seafloor fixed transponders would continually compare its known location with its sonar calculated location. This correction may be necessary because sound waves are often refracted or reflected in ocean water. As sound waves travel through the ocean, they encounter changing water density. Seawater density varies with temperature, pressure, salinity (and other dissolved constituents). The changing density changes the speed of sound. Should the calculated location drift off, the transponder would broadcast a correction factor or cause the errant emitter to shut down. The correction factor would be “local” to each transponder.

FIG. 75 shows a section of sea floor (at a water depth 200-10,000 meters) according to the present invention. The sea floor work area has been marked off into a grid of squares 100 meters on a side, and at every intersection an attachment point or weight with an associated battery pack anchors a rope. The rope rises up some distance, say 200 meters, held aloft by the buoyancy of a float on the top end. Sonar/light emitters are attached to the vertically aligned rope at intervals of say 50 meters. The battery pack at the rope's base can power such emitters, or each emitter can have its own battery. The emitters emit pre-determined (and possibly unique) encoded pulses that can allow an autonomous robotic craft to determine its position in and near the 3-dimensional grid. The emitter stations can be numbered using a system of Cartesian coordinates, including an “origin” (0,0,0) as shown at lower left. The presence of a current (if any) on the sea floor can be mitigated, to some extent, by using more highly buoyant floats and accelerometers.

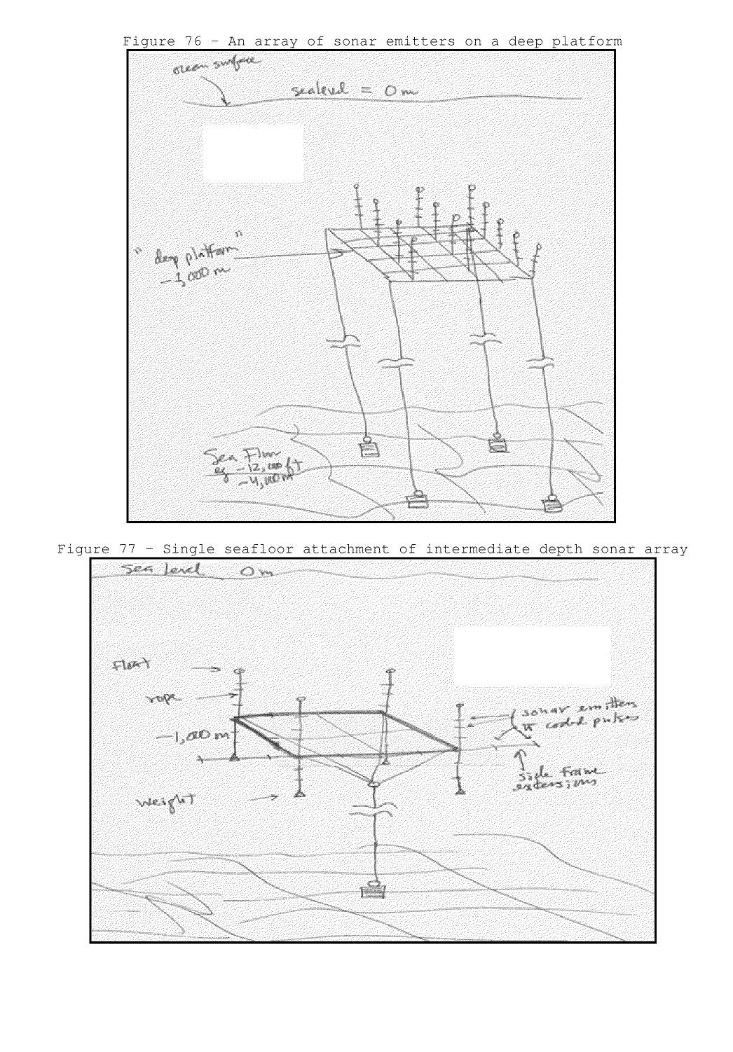

FIG. 76 shows a 3D sonar grid platform of the present invention at an intermediate depth of perhaps 1,000 meters with the seafloor at 2,000 meters deep. Here instead of being individually anchored to the sea floor, a 2-dimensional square lattice grid provides a plurality of bottom attachment points for ropes, held aloft by floats, bearing a series of sonar emitters at fixed intervals. All other details are similar to FIG. 75. This provides a 3D grid of sonar emitters, each emitting pre-determined (unique) encoded pulse that can allow an autonomous robotic craft to determine their position in the 3-dimensional grid work area.

FIG. 77 shows a 3D sonar grid platform similar to the one in FIG. 76, except that a) the intermediate depth grid is anchored to the sea floor by a single attachment point, with a cable coupler provided some distance below it to anchor the 4 corners of the grid while keeping it horizontal, b) additional ropes are attached to the grid in the down direction held down by small weights, which also may have sonar emitters spaced at regular intervals, and c) the frame may be provided with horizontal side extensions with additional sonar emitters as shown.

There is no requirement that any grid frames shown herein be square or rectangular. They could also be circular, triangular, parallelograms, random, or any other configuration that can provide support and anchoring for a 3 dimensional array of coded sonar emitters. Regular spacing of the sonar emitters is not required; however regular spacing is preferred since it simplifies the calculations the craft must continually perform to determine its position in the 3D grid volume. Dense spacing of the sonar emitters is not required, as they may be spaced as far apart as economically feasible while still allowing reasonably accurate 3D positioning. This will depend on the number of obstructions in the grid area, which may be caused by tanks or other components. In a sparsely populated work area, it could be sufficient to provide half a dozen or so sonar emitters above or around the site, in the manner of GPS satellites, to permit adequate 3D aqua-location. The system can also work on land or in the air, (e.g.) using emitters held aloft by balloons. For example autonomous lighter-than-air craft could construct a building within such a grid.

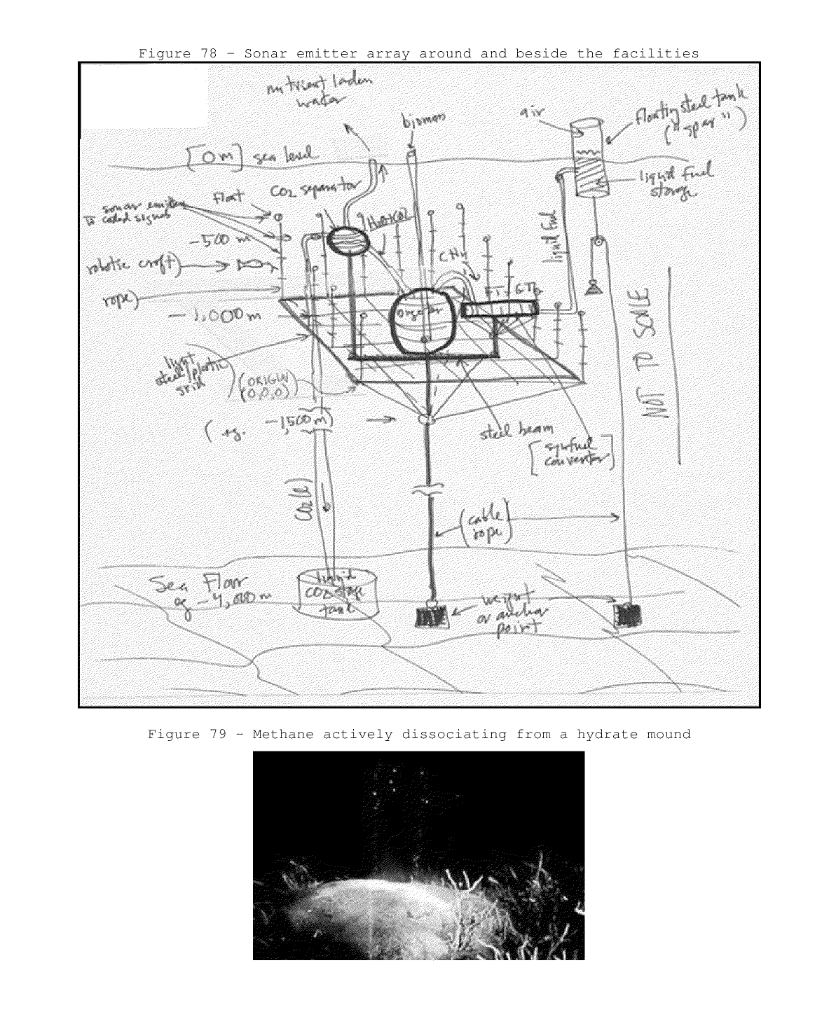

FIG. 78 shows a more complete embodiment of the sonar grid system showing its use for construction and maintenance of an underwater chemical processing facility of the Capron system of anaerobic digestion of biomass. Two major sets of components are shown: 1) the sonar grid array of the present invention and within it 2) an example of Capron's underwater chemical processing facility (UCPF). The sonar grid is suitable for aiding any underwater activities, including the construction and maintenance of a UCPF or other structures, or the examination of any 3D site such as a shipwreck by autonomous craft. Refer to provisional patent applications 61/341,693, 61/340,493, 61/335,811, 61/280,280, and 61/276,480, and U.S. application Ser. No. 11/985,196 for drawings of assorted UCFP. (The applications do not use the term UCPF. Instead they either mention a “PODenergy process” or a specific process to be carried out while submerged.)

All components at intermediate depths can be anchored to the sea floor at a single attachment point (which can itself be mobile). Anchoring force can be distributed among multiple large components of potentially substantial buoyancy via one or more steel beams, like an “inverted mobile” artwork. All components can be held aloft by floats (not all shown) as needed. In the figure only the float ropes along the edges are shown. Other float ropes can be attached at intermediate points inside the grid, possibly at every grid intersection, or more sparsely a) to accommodate the objects (e.g., UCPF equipment) being managed, or b) as needed to provide adequate 3D location services for the robotic craft.

FIG. 78 also shows a “spar” (floating vertical tank) at the upper left for storing liquids such as hydrocarbon fuel or other chemical products at sea level. The spar is a tank designed to withstand ocean storms while remaining anchored. The “Brent Spar” in the North Sea decommissioned by BP is an example of such offshore oil storage technology. Unlike the Brent Spar, which was thought to be contaminated with heavy metals, the fuels generated by the Capron biomass to methane and GTL (gas to liquid) systems are largely free of such impurities.

The robotic craft of 61/340,493 are equipped with sonar listening devices that can determine the approximate orientation and distance of a given sonar signal with a given signature. As the 3D grid of sonar or light emitters emits signals, the craft's sonar listening devices receive, decode, and generate a position and distance for each signal, which they then use to update their location on a computer model of the 3D grid in the craft's memory.

The robotic craft may also be equipped with sonar emitters, to help other such craft locate them, avoid collisions, and perform any cooperative tasks. The craft may also have portable emitter devices that they use to “mark” locations as needed to facilitate their construction and maintenance projects.

The position of the robotic craft can be mathematically specified as follows:
X meters from origin
Y meters from origin
Z meters from sea floor, or origin

The orientation of the robotic craft can be mathematically specified as follows:
Pitch: 0-360 degrees
Yaw: 0-360 degrees
Roll: 0-360 degrees

The velocity of the robotic craft can be mathematically specified as follows:
X direction meters per second
Y direction meters per second
Z direction (vertical) meters per second

The “origin” is a pre-determined point that forms a lower corner of the underwater 3D sonar emitter grid. If the craft is outside the pre-defined grid area, or below its “floor” depth level, its position can be given in negative numbers.

### 40. UNDERWATER CONSTRUCTION VIA 3-D PRINTING

### Capron

The three dimensional (3-D) sonar navigation and the 3-D motion and lifting possible in the ocean allow the robots to inkjet “print” facilities much easier than is postulated for land-based construction. Construction engineers have been experimenting for several years with the concept of building facilities much like the way inkjet printers “build” ink on a page, but in 3-D. There are already computer fabrication tools that will build devices from little dabs of plastic or by cutting small pieces from a solid piece of material.

In the ocean, the supporting fluid (seawater) allows each “inkjet” head, or milling device, or fully dexterous robot complete 3 dimensional freedom. Plus, the sites are more nearly the same, so that one good computer model of an ocean facility can be replicated again and again. Terrestrial construction has many more substantial variations in foundations, topography, vegetation, climate, and storm conditions.

In the ocean situation, the surrounding fluid allows the individual robots to carry large rolled or folded constructions to any location in the 3-D space. Therefore, the tasks at each location may be more complex than deploying a dab of plastic. The tasks may be to deliver, connect, unroll, and inflate a pre-fabricated tube such that the tube is precisely positioned after it is inflated.

Drawings for 3-D construction include FIGS. 75-78 and U.S. provisional patent applications 61/341,693, 61/340,493, 61/335,811, 61/280,280, and 61/276,480, and U.S. application Ser. No. 11/985,196.

### 41. OCEAN FLOOR CONTAINER CARBON STORAGE DETAILS

### 61/400,075, Capron, Stewart

Carbon capture and storage (CCS) generally refers to the capture of CO₂ from exhaust from power plants, cement plants, etc. and sequestering the captured CO₂. Industry appreciates that capture and storage allows continued use of fossil fuels while reducing CO₂ emissions. Environmentalists appreciate capture and storage more rapidly reduces CO₂ emissions and could makes fossil fuels less economically competitive with renewable energy sources.

The natural conditions of pressure and temperature for containers on or buried in the seafloor are ideal for safe long-term (millennia) storage of carbon dioxide:

### Advantages of Ocean Floor Storage

Placing the CO₂ (in liquid or hydrate form) in impervious containers removes the major concern of deep ocean storage: that the CO₂ will dissolve back into the surrounding seawater.
The ambient conditions ensure carbon dioxide will be a liquid denser than the surrounding seawater at depths below about 3,000 meters. [1]
Where the water temperature is reliably less than 9° C. and below about 1,000 meters, ambient conditions ensure a carbon dioxide hydrate will be a solid denser than seawater.
The hydrate will occupy about 4 times the volume of pure liquid carbon dioxide. [2, 3, 4]
There is no question of available safe storage volume. The oceans cover 70% of Earth's surface with an average depth of 3,700 meters. All pre-2010 human-produced carbon dioxide could be safely stored as a liquid in containers covering 100 km×150 km (15,000 km2) or 0.004% of the ocean floor. The liquid carbon dioxide contained layer would be 100 meters thick. If the carbon dioxide were stored as a hydrate, the same area would be covered with hydrate “ice” filled containers in a layer 400 meters thick.
There are many possible materials and arrangements of materials to provide multiple barriers preventing either the liquid or the hydrate from escaping and dissolving into the surrounding seawater for thousands of years.
There are ambient materials (ooze and marine snow) available and dropping out of the water for secondary (or tertiary) containment. [1]
Physics ensures that container failures cannot be catastrophic. Either liquid or hydrate will dissolve slowly creating a plume of easily detected carbon dioxide saturated seawater that is denser than the surrounding seawater.
Container failures can be easily and quickly detected. Sensors are available for detecting minute changes in adjacent seawater pH that would accompany even tiny leaks.
Technology can permit relatively easy repair or replacement, should a container leak.
Insurance agencies can set rates for long-term maintenance based on the above.

Containers on the ocean floor provide safe CO₂ storage with:
Ease of Monitoring—Sonar scans and sound locating beacons can be employed to constantly verify the quantity of stored CO₂ remaining in the authorized location.
Quick Leak Detection—Ocean floor storage can detect leaks exceeding 0.01% of the stored volume of CO₂ outside the authorized location within two days of the leak starting.
Quick Recovery—Ocean floor storage can include mechanical means to recover at least 99.9% of any leaked CO₂ before the leaked CO₂ pollutes the environment.
Perpetual Care—Ocean floor storage can include insurance to finance monitoring and maintenance for at least 1,000 years.

### Potential Container Materials

The deep ocean is a low energy environment: no sunlight, little oxygen, and low temperature. There is some biologic activity by organisms adapted to the conditions. This suggests that chemical and biologic reactions will proceed slowly. There are likely to be many materials that will maintain structural integrity in this environment.

The deep-sea environment should be relatively consistent in that a material which performs well in one location is very likely to perform well everywhere at the same or deeper depth, as long as the temperature is the same. We note there are places with unusual temperatures near undersea vents or volcanoes. There are also places with challenging foundation conditions in subsea canyons or steep slopes, but there are ample locations where containers can be safely placed.

The best way to start is to test some small containers of liquid and hydrate carbon dioxide on the seafloor and monitor their performance. There is every reason to expect we will find some economical materials which exceed the life expectancy of engineered geotextiles used for road construction, retaining wall reinforcement, and landfill lining. The life expectancy of water-tight high-density polyethylene films in landfills exceeds 3,000 years when the liner temperature is always below 30° C. [5]

### Potential Material Arrangements

When employing engineered geotextiles as containers, it is common to have several layers of different materials. FIG. 64 is an example of the multi-layered construction of a green roof system. Note that the different layers have different functions, some to support the soil for the plants, others to prevent water leakage, while still others provide bottom protection.

If necessary, similar layering can be employed when storing liquid CO₂ in the deep ocean. Some potential options include:

The basic materials provide strength with impervious coatings such as the fabrics and tubes manufactured by layfieldgeosynthetics.com, fabinno.com, gseworld.com, maccaferri-usa.com, prestogeo.com, typargeotextiles.com and others.

For additional protection, clay sandwich materials consisting of a thin layer of bentonite (a special clay) could be sandwiched between layers of sheet or fabric. Manufacturers include gseworld.com and cetco.com. (There are likely other materials besides bentonite that provide the desired self-sealing properties for liquid CO₂ that bentonite possesses when contacted by water.)

If necessary, biocides could be embedded, attached to, or dissolved in the materials. The biocide properties may be prevented from leaching into the seawater or the liquid CO₂ by non-reactive layers bonded to the biocide layer. Manufacturers of biocide geotextiles include typargeotextiles.com. Note that in the deep ocean situation, tiny salt particles or tiny “bubbles” of fresh water may be adequate biocides, as the life forms at these depths should experience discomfort when encountering higher or lower salt concentrations.

A woven or non-woven textile may be included for better puncture resistance for the bottom sheets or to armor the bottom tubes.

By embedding particles in the materials, they can be made in a range of densities. For example, the bottom sheet to protect the CO₂ containers from rocks could be less dense than the ooze, so it could “float” on ooze, but be denser than seawater or liquid CO₂ so it would remain flat as the CO₂ containers are put in place. The top protective sheet could be less dense than liquid CO₂ but be denser than seawater so it would remain in place. Note that the deep ocean pressure will increase the density of the materials, relative to their density at the ocean surface. This might be used to good effect by arranging a material with bubbles that collapse with depth. If the gas in the bubbles is predominantly CO₂, the resulting liquid CO₂ may be an adequate biocide when encountered by sea creatures attempting to bore through the material.

In addition to carefully engineering the materials, the containers can be arranged to reduce the chance of leaks. For example, FIG. 65 shows a vertical cross-section of a potential multi-cell arrangement of an enclosure for containers that would be filled over time. In this case the arrangement consists of a bottom layer of appropriate density sheets, intermediate between the density of the ooze and liquid CO₂. On top of this would be a layer of tubes containing liquid CO₂. When that layer is full, a protective sheet could be put in place, then a layer of tubes of liquid CO₂, followed by another layer of sheets, another layer of liquid. Note that the structure of FIG. 65 could be hundreds of meters high and a kilometer or more in diameter.

### REFERENCES CITED

### In this Section

1. House K. Z., Schrag D. P., Harvey C. F., and Lackner K. S., Permanent carbon dioxide storage in deep-sea sediments, PNAS, Aug. 15, 2006, vol. 103, no. 33, p. 12291-12295.
2. Rui S, Zhenhao D, Prediction of CH4 and CO2 hydrate phase equilibrium and cage occupancy from ad initio intermolecular potentials, Geochimica et Cosmochimica Acta, Vol. 69, No. 18, pp. 4411-4424, 2005, Elsevier Ltd.
3. Makio Honda, Jun Hashimoto, Jiro Naka, and Hiroshi Hotta, “CO2 Hydrate Formation and Inversion of Density between Liquid CO2 and H2O in Deep Sea: Experimental Study Using Submersible “Shinkai 6500”, Direct Ocean Disposal of Carbon Dioxide, edited by N. Handa and T. Ohsumi, pp. 35-43, Terra Scientific Publishing Company (TERRAPUB), Tokyo, 1995
4. Eric Wannamaker, “Modeling Carbon Dioxide Hydrate Particle Releases in the Deep Ocean”, Massachusetts Institute of Technology, June 2002 (dspace.mit.edu/bitstream/handle/1721.1/16814/50617268.pdf).
5. R. K. Rowea and M. Z. Islam, “Impact of landfill liner time-temperature history on the service life of HDPE geomembranes” Waste Management, 29, 2689-2699, October 2009, and R. K. Rowe, et al., Ageing of HDPE geomembrane exposed to air, water and leachate at different temperatures, Geotextiles and Geomembranes, 27, 137-151, April 2009

### 42. FORMING HYDRATES IN SEAFLOOR CONTAINERS

### 61/518,293, Capron

Previous applications discussed storing CO₂ on the seafloor in containers. When the CO₂ is a hydrate, it may be useful to form the hydrate inside the container. The CO₂ is likely to be transported as a liquid. The liquid CO₂ will be less dense than seawater unless it is deeper than about 3,000 meters. Hydrates will form as shallow as about 500 meters deep. At depths between 500 to 3,000 meters it is useful to ensure the container with contents remains denser than seawater as the liquid CO₂ is introduced to the container.

The products of seawater, water with dissolved CO₂ and hydrates, are both denser than seawater. The brine formed as salts are excluded from the hydrate formation will also be denser than seawater.

Also, the reaction producing the hydrate is exothermic. It gives off heat. If the temperature increases too much, hydrates will not form or will “melt.” Hydrate formation is a function of both temperature and pressure. Thus the heat that can be tolerated will vary.

Introduce the liquid CO₂ at the bottom of a water filled container slowly and via a diffuser. The diffuser may be similar to the fine bubble air diffusers used at wastewater treatment plants. The small bubbles of liquid CO₂ will form hydrate shells as they rise through the seawater. The “bubble” density may increase to where they sink. If any liquid CO₂ remains, it will be at the top of the container and have an interface with seawater. Hydrate will form at the interface and sink, exposing new interface for continued hydrate formation.

Options for keeping the tube(s) and diffusers of liquid CO₂ on the bottom of the container include:
Glue or weld them to the container floor.
Glue or weld them to the outside/underside of the container floor and make holes through the floor into the tube(s).
Make the tube(s) out of a material which is sufficiently denser than seawater.

It may be desirable to produce a “dry” hydrate presuming there is normally some “leftover” high-salt brine and high dissolved CO₂ water. The dry hydrate would have better structural properties than would a slush with the brine and dissolved CO₂.

Produce a dry hydrate by forming the hydrate inside a double-walled container. The inside container wall is relatively porous to water with dissolved minerals (CO₂ and salts). The outside container wall is impervious. Between the two walls is a drainage material. After most of the hydrate is formed, suck the liquid from the space between the walls. The suction will also pull any un-reacted liquid from inside the porous container. The suction creates a pressure that “squeezes” the container dry, improving the structural properties of the hydrate. The improved structural properties should persist after the suction is released. Refer to other's SANDISLE publications to see an explanation for how loose sand acquires the strength of concrete when the sand is confined under pressure.

### 43. SAFELY REPLACING CH4 HYDRATES WITH CO2 HYDRATES

### 61/541,755, Capron

The US Department of Energy had the following discussion of methane hydrates posted on the web as of Sep. 13, 2011.

### The National Methane Hydrates R&D Program [Prior Art]

Methane hydrate, much like ice, is a material very much tied to its environment—it requires very specific conditions to form and be stable. Remove it from those conditions, and it will quickly dissociate into water and methane gas (See FIG. 79). A key area of basic hydrate research is the precise description of these conditions so that the potential for occurrence of hydrates in various localities can be adequately predicted and the response of that hydrate to intentional, unintentional, and/or natural changes in conditions can be assessed.

Our current understanding of naturally-occurring methane hydrate indicates that the fundamental controls on hydrate formation and stability are (1) adequate supplies of water and methane, (2) suitable temperatures and pressures, and (3) geochemical conditions. Other controls, such as sediment types and textures, may also exist.

Modes of Formation: Hydrates can form in several ways. In the arctic, there is a growing belief that many hydrate accumulations represent pre-existing free gas accumulations that have been converted to hydrate by subsequent change in environmental conditions (onset of arctic climate post-dated the migration of gas into shallow sandstone “traps”. In the marine environment, hydrate is often considered to have formed from solution, as methane is generated by in-situ microbial processes to the point where the water becomes saturated with methane and hydrate growth begins. There is also a high likelihood that methane hydrate could accumulate in coarser-grained marine sediments by the migration of gas from deeper, warmer zones, up through various pathways such as faults, and into water-bearing shallow sediments where it is then converted to methane hydrate.

Methane is formed in two ways. First, biogenic methane is the common by-product of bacterial ingestion of organic matter (as described in the equation below):

(CH₂0)₁₀₆(NH₃)₁₆(H₂PO₄)→53CO₂+53CH₄+16NH₃+H₂PO₄

The above equation describes how methane is produced in shallow subsurface environments through biological alteration of organic matter (with original ratio of Carbon:Nitrogen:Phosphorus of 106:16:1). The equation summarizes multiple successive stages of oxidation by oxygen and reduction by nitrates, sulfates, and carbonates (from Sloan, 1990).

The same process that produces methane in swamps, landfills, rice paddies, and the digestive tracts of mammals occurs continually within buried sediments in geologic environments all around the globe. Biogenic processes are capable of producing vast amounts of methane, and are considered to be the dominant source of the methane trapped in hydrate layers within shallow sea floor sediments.

Second, thermogenic methane is produced by the combined action of heat, pressure and time on buried organic material. In the geologic past, conditions have periodically recurred in which vast amounts of organic matter were preserved within the sediment of shallow, inland seas. Over time and with deep burial, these organic-rich source beds are literally pressure-cooked with the output being the production of large quantities of oil and natural gas. Along with the oil, the gas (largely methane, but also ethane, propane and other larger molecules) slowly migrates upwards due to its buoyancy relative to water. If sufficient quantities reach the zone of hydrate stability, the gas will combine with local formation water to form hydrate.

### Temperatures and Pressures:

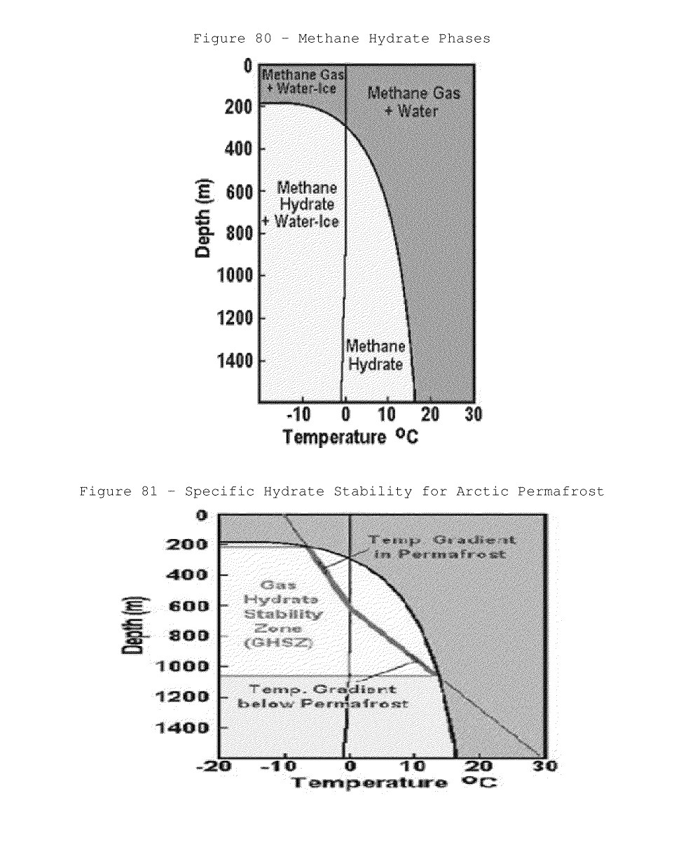

FIG. 80 shows the combination of temperatures and pressures (the phase boundary) that marks the transition from a system of co-existing free methane gas and water/ice solid methane hydrate. When conditions move to the left across the boundary, hydrate formation will occur. Moving to the right across the boundary results in the dissociation (akin to melting) of the hydrate structure and the release of free water and methane. In general, a combination of low temperature and high pressure is needed to support methane hydrate formation

### Geochemical Conditions:

In addition to temperature and pressure, the composition of both the water and the gas are critically important when fine-tuning predictions of the stability of gas hydrates in specific settings. Experimental data collected thus far have included both fresh water and seawater. However, natural subsurface environments exhibit significant variations in formation water chemistry, and these changes create local shifts in the pressure/temperature phase boundary (higher salinity restricts hydrate formation causing the phase boundary to shift to the left). Similarly, the presence of small amounts of other natural gases, such as carbon dioxide (CO₂), hydrogen sulfide (H₂S) and larger hydrocarbons such as ethane (C₂, H₆), will increase the stability of the hydrate, shifting the curve to the right. As a result, hydrates that appear to be well above the base of hydrate stability (from pressure-temperature relationships) may actually be very close to the phase boundary due to local geochemical conditions. These local variations may be very common, as the act of forming hydrate, which extracts pure water from saline formation waters, can often lead to local, and potentially-significant, increases in formation water salinity.

### Simplified Examples of Hydrate Stability:

Commonly, methane hydrate phase diagrams are presented with pressure being converted to depth to place the diagram in a geologic perspective. In addition, the natural geothermal gradient is shown to indicate the range of temperatures expected to exist as depth (i.e. pressure) increases. The range of depths in which the temperature gradient curve is to the left of the phase boundary indicates the Gas Hydrate Stability Zone (GHSZ). This zone only delineates where hydrates will be stable if they form. Local conditions and a region's geologic history will determine where and if hydrates actually occur within the GHSZ (see our Geology of Methane Hydrates section for more information).

The phase diagram in FIG. 81 illustrates typical conditions in a region of arctic permafrost (with depth of permafrost assumed to be 600 meters). The overlap of the phase boundary and temperature gradient indicates that the GHSZ should extend from a depth of approximately 200 meters to slightly more than 1,000 meters. (Note that both the permafrost thickness and pressure/temperature gradients in the chart are examples and can vary with locality, so specially-tailored diagrams must be made before site-specific predictions of hydrate stability can be attempted.)

The phase diagram in FIG. 82 shows a typical situation on deep continental shelves. A seafloor depth of 1,200 meters is assumed. Temperature steadily decreases with water depth, reaching a minimum value near 0° C. at the ocean bottom. Below the sea floor, temperatures steadily increase. In this setting, the top of the GHSZ occurs at roughly 400 meters—the base of the GHSZ is at 1,500 meters. Note, however, that hydrates will only accumulate in the sediments or as mounds on the seafloor over point sources of methane release.

From the phase diagram in FIG. 82 for oceanic settings, it would appear that hydrates should accumulate anywhere in the ocean-bottom sediments where water depth exceeds ˜400 meters. However, very deep (abyssal) sediments are generally not thought to house hydrates in large quantities. The reason is that deep oceans lack both the high biologic productivity (necessary to produce the organic matter that is converted to methane) and rapid sedimentation rates (necessary to bury the organic matter) that support hydrate formation on the continental shelves.

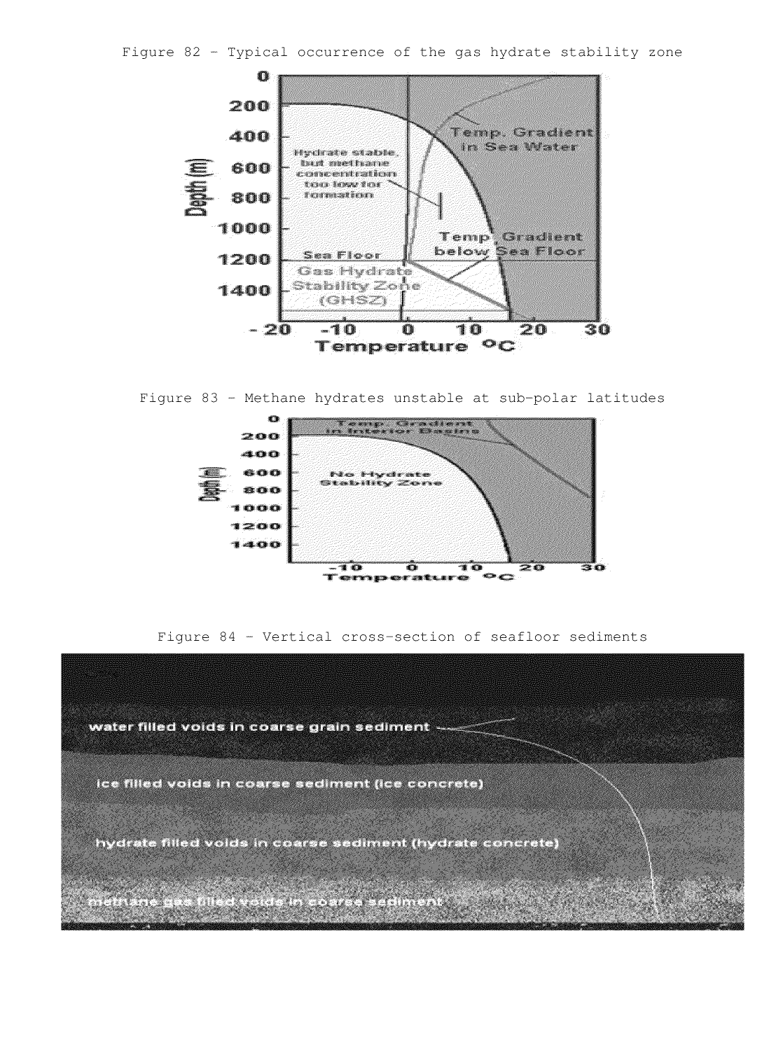

The final phase diagram in FIG. 83 illustrates why no hydrates are found in interior basins at sub-polar latitudes. At every depth (pressure), subsurface temperatures are too high for methane hydrate to be stable.

### Description of Invention

Methane hydrates are a grave concern for Climate Change. Methane is between 20 and 100 times more potent than CO₂ as a global warming gas. The range of potency depends on the time span of one's concern. Whereas CO₂ remains in the atmosphere for a millennium, CH₄ converts to CO₂ in a decade or so. Melting permafrost and warming oceans is causing the relatively quick release of methane.

As may be seen in the above US DOE description of methane hydrates, they often exist in the spaces between soil particles. This is analogous to a frozen aquifer. FIG. 84 is a schematic vertical cross-section showing a typical situation. The arrangement may be under land or under water. Starting from the top we have: 1) a layer of sea water, 2) a layer of un-frozen seawater in sediment, 3) a layer of frozen water (ice) in sediment, 4) a layer of methane hydrate in sediment, 5) a layer of methane gas in sediment, and 6) a layer of seawater in sediment. There may be any of several permutations of the sediment layers. For the purposes of this invention the important concepts are:
The methane gas can be under pressure and could rise explosively, if the strength or weight of the overlaying sediments is reduced. Removing the methane hydrate will substantially reduce the sediment strength. The methane hydrate will disassociate if temperature is increased or pressure is decreased.
The sediments are already unstable. Sinkholes, landslides, and subsea landslides occur when ice or hydrates melt and sometimes from other causes.

The invention concept employs the principles of hydrostatic sand to make layers of sediment strong even though the voids are filled with gas. Hydrostatic sand structures are described by Dowse, “New Developments in the Use of Sand for Construction of Deep Water Offshore Structures,” Oceanology International 1975. They work because the active earth pressure of dry sand inside an impermeable membrane is less than the confining hydrostatic pressure. A vertical sided SANDISLE column has a bearing capacity equal to 3.4 times the hydrostatic pressure. This assumes a wet sand density of 1800 kg/m³ (110 lbs/cuft) and an angle of internal friction of 33°.

FIG. 85 shows the steps for removing ice and safely harvesting gas hydrates or clathrates, in this case CH₄-hydrates. This process may be termed, “hydrostatic hydrate harvesting (HHH).”
a. Spread an impervious geomembrane over the selected gas hydrate harvest area.
b. Seal the edges of the geomembrane in a manner which prevents fluids from flowing through the sediments into or out of the area under the geomembrane. The figure shows freezing the seawater in the sediments as one option for making the seal.
c. Pump liquid out from under the geomembrane. The act of pumping the liquid out converts all the sediment under the geomembrane to a hydrostatic structure. Not shown, but we may want to add a gas at the desired pressure while we remove water; otherwise some water will vaporize to fill the vacuum. The desired pressure is as much less than the ambient seawater pressure as needed for the desired strength.
d. Cycle warm gas through the voids between the sediment particles. FIG. 86 shows one of several gas warming and circulating systems which may be arranged as several radii in plan view. Gas enters the void area warm and exits the void area cold. The combination of warm gas and low gas pressure will melt ice and hydrates. As the ice and hydrates melt, they absorb heat. Melting seawater ice will be a few degrees below 0° C. FIG. 80 indicates the typical range for melting hydrates under these conditions can be interpolated from −40° C. to 20° C. When melting hydrates, it may be useful to keep the in-voids gas pressure and temperature above the freezing point of the water released by the hydrate, i.e. 0° C. The circulating gas can be adjusted for best fit of hydrostatic strength, hydrate formation and disassociation temperature, and mass density.
e. The objective is for the water released by melting or disassociation to drain back (counter to the gas flow) to the drain point. The warmed gas, the melting, and the draining serve to increase the volume of sediments which derive strength from the hydrostatic effect even as they lose the ice and hydrate which previously cemented the sediment grains. FIG. 86 shows the situation prior to melting into the hydrates. Once into the hydrates, one would collect the generated gas from the gas warming and recirculating system.

After we have removed as much hydrate as desired, we will have a large volume of hydrostatically strengthened sediments. This is not a good permanent situation because leaks in the geomembrane would quickly drop sediment strength far below the original ice and hydrate concrete strength. Therefore we employ the ice or CO₂-hydrate replacement process shown in FIG. 87. This process may be termed, “hydrostatic hydrate concrete construction (HHCC).”
a. Inject a layer of water to spread across the top of the remaining ice-hydrate concrete formation. The injected water may be freshwater, seawater, or an emulsion including liquid droplets of CO₂.
b. Circulate a water-freezing or hydrate-forming gas at the appropriate temperature and pressure through the sediment in the same manner as was done for the HHH process, but with cold gas. The gas may be CO₂.
c. By water-freezing or hydrate-forming in successive layers, we rebuild the sediment strength. As can be seen in FIG. 88, for typical pressures and when temperatures are below 10° C., the CO₂-hydrate remains stable until it is several degrees C. warmer than a stable CH₄-hydrate. That means the CO₂-hydrate can survive warming oceans much better than CH₄-hydrate.

FIG. 88 suggests pressures and temperatures of the liquid and the gas for the HHCC process. For example, we may operate the void pressure near 50-bar (500 meters depth), provided the pressure exterior to the geomembrane is sufficiently above 50-bar to maintain hydrostatic structure strength.

50-bar pressure allows the injected liquid to be an emulsion of liquid CO₂ droplets at just above 10° C. In this condition, the droplets would remain liquid (not form hydrates) and not dissolve, after the water is saturated with CO₂. We might inject the emulsion at 10° C. or chill the emulsion using ambient seawater to perhaps 4° C. before injection. A pre-chilling operation would rely on hydrate formation requiring more time than the time for the emulsion to spread into a level surface. In either case, we inject gas CO₂ at less at about 0° C. in order to complete the hydrate formation. Every few layers, we may inject CO₂ at less than −3° C. for a time to freeze any free seawater.

We may encounter CH₄ gas filling the sediment voids below the hydrate filled voids. In this case the CH₄ is a gas because the sediments are too warm (from the earth's core temperature) to form hydrates. Such gas is often displacing brine which has pressurized the gas such that the impervious and structurally strong layer of sediment, ice, and hydrates concrete is restraining the gas. Because HHH maintains sediment strength while harvesting the methane hydrates, HHH can proceed. However, it may be best to perform at least some of the following steps before starting HHH.
a. Drill and release the gas pressure below the hydrates. Releasing pressure may allow hydrates on the underside of the hydrate layer to disassociate. However, without additional heat the disassociation would be slow.
b. We may pump seawater or CO₂ into the voids as we extract CH₄ gas to maintain pressure. When we have extracted all the CH₄ gas, the seawater will have filled up to the bottom of the hydrate-filled voids. Because seawater is a good thermal conductor, we may leave an insulating layer of gas CO₂ between the seawater filled voids and the hydrate concrete. However, one should also consider that the CO₂ would have a low partial pressure of CH₄ in contact with the CH₄-hydrate, causing more CH₄ to disassociate into a mixed CH₄ and CO₂ gas.
c. If we wish to sequester more CO₂, we might drain our earlier injection of seawater while we add more CO₂.

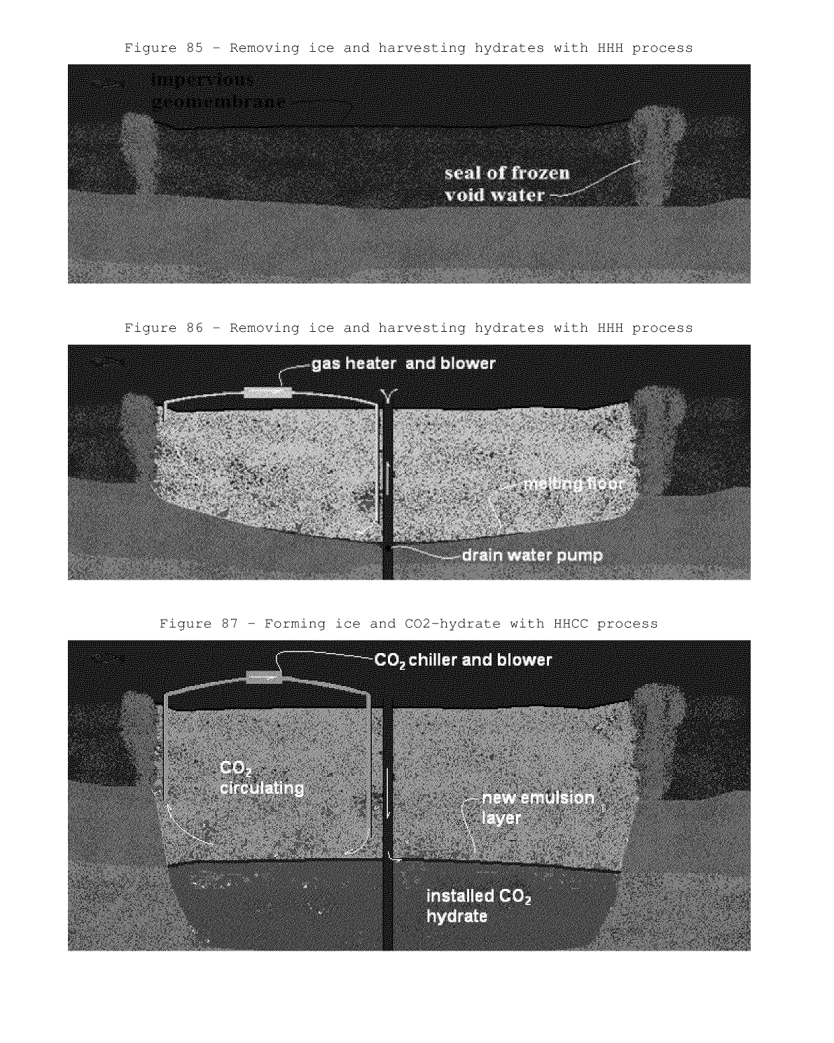

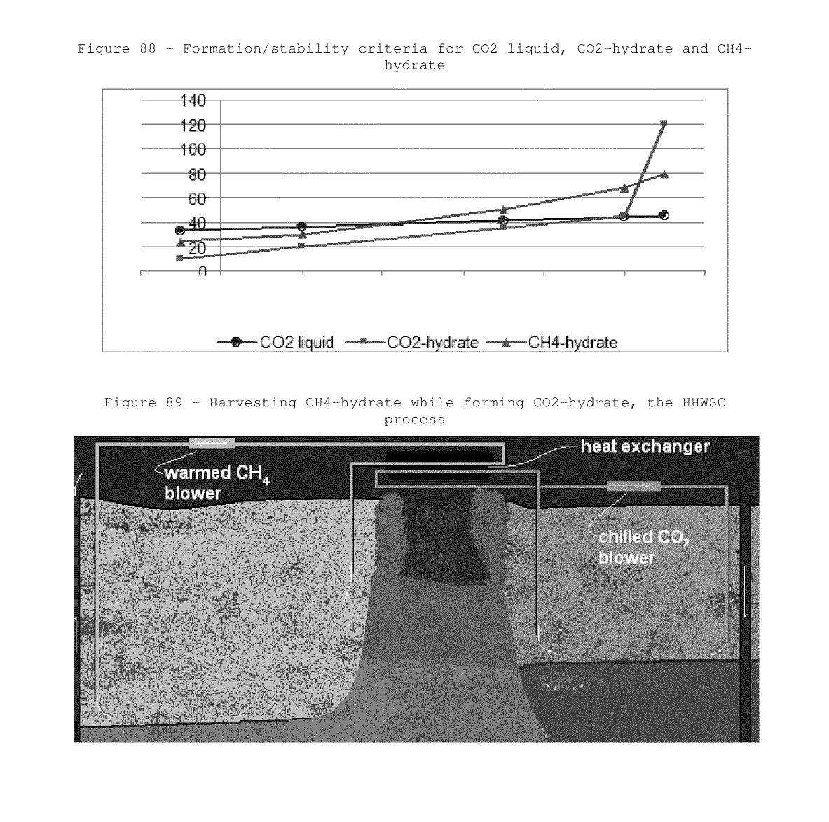

One of the objectives of this invention is to replace CH₄-hydrate-sediment concrete and ice-sediment concrete with CO₂-hydrate-sediment concrete. FIG. 89 is a schematic representation for the replacement process termed, “harvesting hydrate while storing carbon (HHWSC).” It starts by transitioning a HHH operation to a HHCC process and commencing a nearby HHH operation.

When injecting an emulsion on the HHCC side, it may be about six moles of H₂O per mole of CO₂. The temperature of CO₂-hydrate formation varies with pressure as shown in FIG. 88. The hydrate heat of formation is about 60 kJ/mol of CO₂. The water liquid to solid heat of formation is about 6 kJ/mol of H₂O. The heat capacity of water is about 0.08 kJ/mol/° C. The heat capacity of gaseous CO₂ is about 0.04 kJ/mol/° C. The heat capacity of CH₄ is about 0.04 kJ/mol/° C. The latent heat of CO₂ vaporization is about 25 kJ/mol. The heat of melting CH₄-hydrate is about 50 kJ/mol of CH₄. It also has about six moles of H₂O per mole of CH₄. The temperature at which CH₄ hydrate disassociates is shown in FIG. 88.

The ambient seawater pressure above the geomembrane must be higher than the void pressure. If seawater were 400 meters deep, and the gas pressure in the voids 30-bar, the bearing capacity of the hydrostatic confined sediment would be (40-bar−30-bar)*3.4=34 bar (500 psi). By comparison sidewalk Portland cement concrete has a bearing capacity of about 210 bar.

If we were operating the HHWSC of FIG. 89 with the CH₄ void pressure equivalent to 200 meters deep, and the CO₂ void pressure equivalent to 300 meters deep, the following temperatures are possible:

### Injection CH₄: 4° C.; Exhaust CH₄: 0° C.; Injection CO₂: 1° C.; Exhaust CO₂: 5° C.

Note that seawater may also be employed for heating or cooling. Seawater may be as low as 2° C. on the seafloor, or as cold as −3° C. on the Arctic ocean surface, or as warm as 30° C. on the tropical ocean surface.

The void pressure of 30-bar (300 meters depth equivalent) would not support liquid CO₂ droplets in a water emulsion at the available temperatures. However, the pressure-temperature is not far from equilibrium leaving the possibility of forming the emulsion at higher pressure and temperature. The injected emulsion may have time to spread to nearly level within the void space before all the CO₂ droplets convert to gas. As droplets convert to gas, they will absorb heat cooling the emulsion and the gas.

More likely, the injected liquid will be fresh or sea water which is pre-saturated with dissolved CO₂. As the layer of water settles to level, cold gaseous CO₂ cools it and provides the additional CO₂ needed to form the hydrate. The gaseous CO₂ exiting the exothermic HHCC process will be warmer. It is cooled in a counter-flow heat exchanger with the cold CH₄ from the endothermic HHH process. The cold CH₄ is warmed by the CO₂. Cold CO₂ and warm CH₄ return to their respective processes.

As we complete operations, we move sideways, gradually replacing all the threatening-to-melt CH₄ hydrates with relatively stable CO₂ hydrates.

Processes Applied with Cohesive (Impermeable) Sediments

In cases where there are cohesive sediments above the coarse sediments, the cohesive sediments may substitute for the geomembrane, if they are sufficiently impermeable. While the coarse sediment voids are maintained at lower-than-ambient pressure, the cohesive sediments will slowly compress at whatever rate water can drain out of the cohesive sediments. The compressed cohesive sediments will be much stronger, even though thinner than they were before compression.

If the cohesive sediments rest directly upon coarse sediments filled with ice or hydrates, there will be no initial void space which can be drained. No initial drainage means no “dry” void space to conduct the flow of warm gas. Where the cohesive sediments rest directly on “frozen” coarse sediments, one either removes the cohesive sediments or directionally drills through the “frozen” coarse sediments. After directionally drilling, pass warm gas through the drill hole(s). Heat rises. The gas will tend to melt upward and spread the “melt zone” along the bottom of the cohesive soil. Thereafter the warm gas injection and draining proceeds as in the described HHH process.

Processes Applied without Sealing the Edges of Water-Filled Voids

If the coarse sediments with water-filled voids are relatively thick, we can substitute time and distance instead of a physical seal for the edges of the methane harvest zone. This works particularly well with an adequate layer of cohesive sediment over a large area. As when dewatering for terrestrial excavations in areas with a high water table, the area around the drainage well will develop a “cone of depression.” An array of surrounding wells can keep the ground water surface lowered indefinitely over a large area.

Near the cone of depression, the pressure in the water-filled voids near the “dry” voids will also drop. Some of the hydrates in the hydrate-filled voids under the area of lowered pressure will disassociate into water and gas. However, the disassociation will be limited because it is endothermic. Some of the freshwater released by disassociation may freeze providing the desired seal. Also, we do not expect a large release of gas from the hydrates unless we can supply heat at a temperature higher than indicated by the pressure-temperature curve, FIG. 88. Therefore we can limit the area of gas production to the vicinity of warm gas in contact with hydrate. The above mentioned processes may proceed without a physical seal.

### 44. HYDROSTATIC SAND INSULATING STRUCTURES

### Capron

Hydrostatic sand structures are described by Dowse, “New Developments in the Use of Sand for Construction of Deep Water Offshore Structures,” Oceanology International 1975. They work because the active earth pressure of dry sand inside an impermeable membrane is less than the confining hydrostatic pressure. A vertical sided SANDISLE column has a bearing capacity equal to 3.4 times the hydrostatic pressure. This assumes a wet sand density of 1800 kg/m³ (110 lbs/cu ft) and an angle of internal friction of 33°.

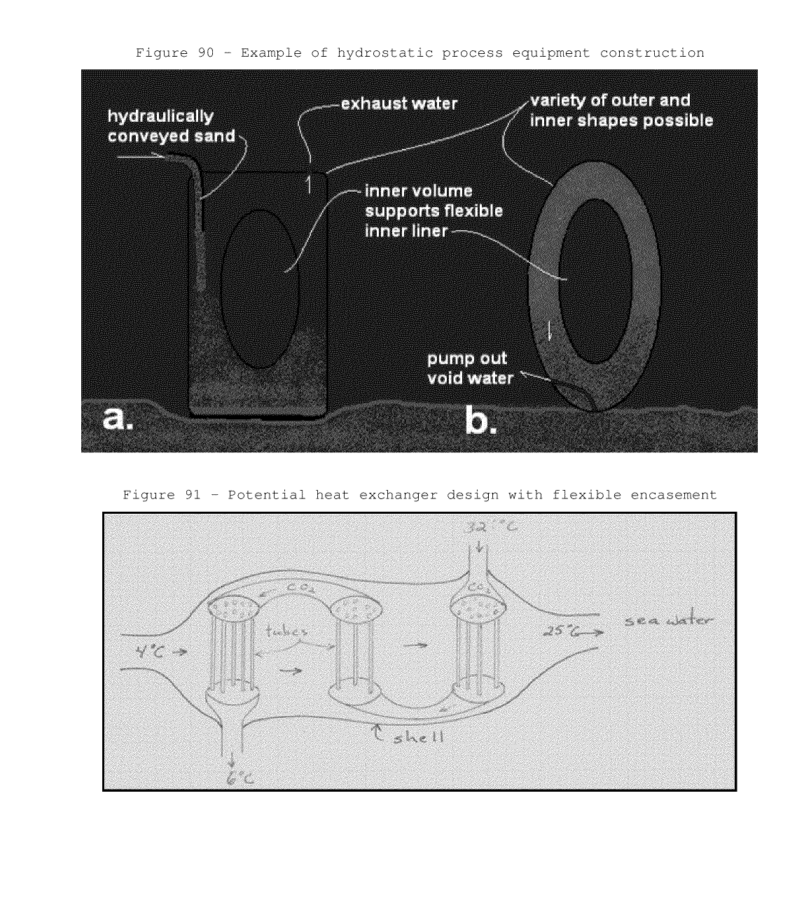

We can use this principle to make ocean process equipment from flexible geomembranes and “sand” where the pressure of the process is less than the ambient seawater pressure. The sand may be any granular material, including specially made insulating hollow glass spheres or ceramics. If the process is too hot for the inside to be a flexible geomembrane, a relatively thin liner will suffice. The thin liner may be made from any material suitable for the temperature and corrosive properties: unreinforced Portland cement concrete, or ceramic, or metal. FIG. 90 shows examples of hydrostatic process equipment construction.
a. Initially, pump water into an exterior geomembrane shape. The geomembrane need only be strong enough to support the shape when it is filled with hydraulically conveyed sand. Insert the interior process liner and inflate it with water. The interior vessel liner need only be strong enough to support the pressure difference between the fill water and the hydraulically placed sand. The hydraulically placed sand behaves like a liquid denser than seawater. During filling, the sand pressure on the outside of the liner will increase. Upper portions of the liner, not yet covered by sand will require higher water pressure in order to maintain the desired shape. Fill the exterior geomembrane shape with hydraulically placed sand. Water pressure inside the inner volume will support the water-sand mixture in the desired process shape.
b. Pump the water out of the void between the liner and the exterior. One might add a gas as one is pumping the water in order to avoid pulling a vacuum and vaporizing the water.
One may now conduct any process inside the liner with the process pressure less than the ambient seawater pressure and more than the gas pressure in the void space. The “excess” pressure depends on the thickness of the hydrostatically supported walls and the relative pressure difference. For example, if the process vessel were a cylinder 1,000 meters deep (100 bar) and 100 meters interior diameter, unreinforced hydrostatic sand walls about 20 meters thick would be sufficient to support interior processes operating between 50 to 100 bar. Higher internal pressures are possible, but will stress the geomembranes.

The equipment may be constructed with several different layers of impermeable and granular materials to satisfy different needs for temperature stability, corrosion resistance, thermal energy transfer, structural strength, puncture resistance, etc.

### Plastic Heat Exchangers:

While metals are good thermal conductors, they corrode in seawater and are relatively expensive. Ambient ocean pressures allow us to make extremely large plastic heat exchangers.

For example, the overall efficiency of a submerged supercritical CO₂ Ocean Thermal Energy (OTEC) process might be better than the 2.5% of ammonia OTEC. That means we must move 61,000 m³/hr of liquid CO₂ to transfer 4,000 MW of heat and generate 100 MW of electricity. Because the top and bottom heat exchangers experience little differential pressure the plastic can be thin. Tables G and H suggest the properties of shell and tube heat exchangers sized for an OTEC plant producing 100 MW. For both tube sizes, the CO₂ velocity inside the tube is about 0.2 m/sec.

TABLE G
Example tube geometry in shell & tube heat exchanger

| | | | | tube | | |
|---|---|---|---|---|---|---|
| | | | tube | wall | | |
| | thermal | wall | inside | unit | tube | # of |
| | conductivity | thickness | dia | area | length | tubes |
| Material | watts/m-K | m | m | m²/m | M | each |
| HDPE, | 0.45 | 0.0005 | 0.1000 | 0.3142 | 300 | 8,000 |
| 10 cm | | | | | | |
| HDPE, | 0.45 | 0.0002 | 0.0100 | 0.0314 | 100 | 95,000 |
| 1 cm | | | | | | |

TABLE H
Other properties of HDPE shell & tube heat exchanger

| | Overall | | | | | |
|---|---|---|---|---|---|---|
| | HX | | | | material | |
| | section | outside | inside | | stress | Total cost |
| | area | pressure | pressure | delta P | lbs/sq | of tubes |
| Material | m² | bar | bar | psi | in | $ |
| HDPE, | 82 | 300 | 301 | 15 | 1,465 | $360,000,000 |
| 10 cm | | | | | | |
| HDPE, | 10 | 300 | 301 | 15 | 377 | $14,000,000 |
| 1 cm | | | | | | |

In Table H, the “Overall HX section area” refers to the cross-section area of the shell. It is sized to allow the surface-to-surface distance between tubes to be equal to the tube diameter. The shell is a geotextile with a film lining. The shell and seawater conveying pipes may have insulation properties as explained in “Submerged Insulation.” The heat exchanger will have some friction losses. Overcoming the friction losses will define the maximum hoop stress and therefore the material stress in the tube wall. HDPE will support about 4,000 psi in tension.

While FIG. 91 shows a shell and tube, other arrangements such as spiral or plate are equally possible. The shell and tube may be the easiest construction to “roll up” for transportation and “inflate” during installation. While the liquid CO₂ will be the same pressure as the seawater, it will generally be less dense. (When operating at or below 3,000 meters, CO₂ can be denser than seawater depending on temperature.) Positioning the tubes with their vertical axis aligned with the CO₂ flow (the flow of CO₂ is straight up or down), simplifies their support system.

The HDPE will be in ideal long-life conditions of no sunlight and cool temperatures. The tubes and pipes full of CO₂ will not foul on the inside. The plastics in direct contact with seawater may have embedded biocides tuned to exactly the steady conditions of pH, temperature, pressure, and fouling species. It is easier to prevent long-term erosion, corrosion, and biofouling with plastics than with metal, ceramics or concrete.

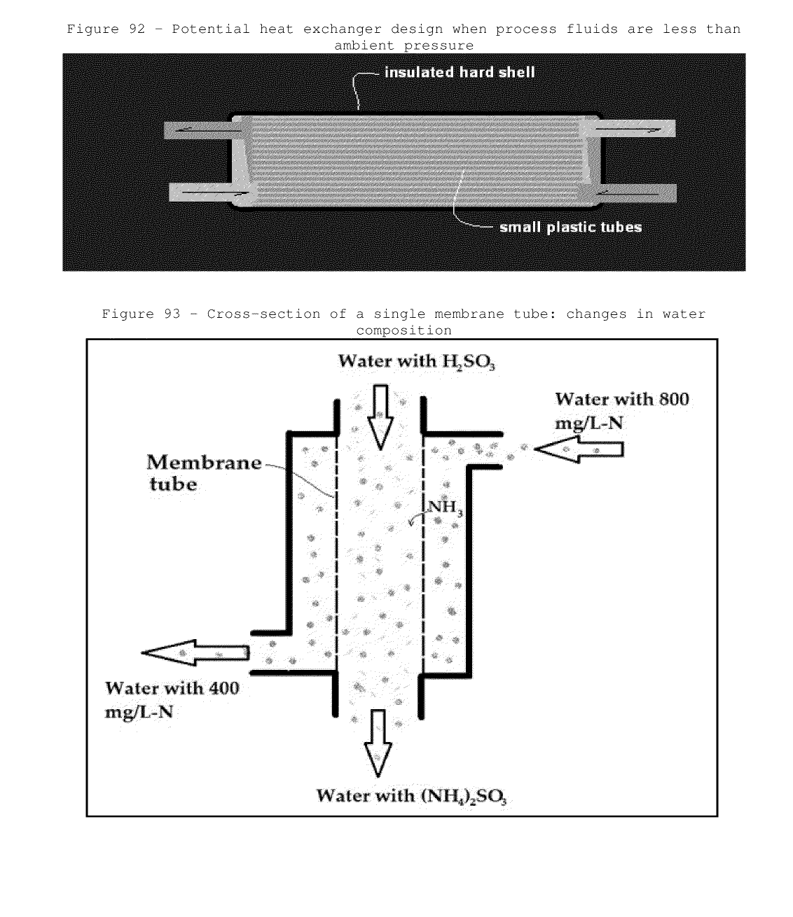

FIG. 92 is another heat exchanger arrangement with thin flexible parallel tubes somewhat like the tubes in a reverse osmosis tube bundle. When squeezed circumferentially, a collection of fluid filled tubes will form a honeycomb in cross-section. The tube walls can be without tensile or collapsing stress if both gases are at the same pressure. Without stress, the tubes can be very thin, perhaps less than 1 mil.

When the ambient pressure surrounding the heat exchanger is higher than the pressure of the fluids in the heat exchanger, the heat exchanger shell may be a hydrostatic sand insulating structure.

### 45. MEMBRANE AMMONIA REMOVAL/CONCENTRATION

### 61/673,483, Capron, Stewart

### Background:

Some wastewater treatment plants have permits limiting the total nitrogen in their effluent. One annoying source of nitrogen is the ammonia returning from dewatering sludge after anaerobic digestion.

Most existing water desalting technologies have two outputs: one fresh water (total dissolved solids less than about 500 mg/L) and brine with total dissolved solids 5 to 20 times more concentrated than the source water. If the source water is treated municipal wastewater, it may contain ammonia/ammonium which becomes concentrated in the brine. (Note that most 2012 municipal wastewater treatment plants convert ammonium to nitrate and agricultural runoff would be mostly nitrate with little ammonium. However, the most livestock and some future municipal wastewater treatment will employ anaerobic digestion because of its energy (biogas) recovery. After anaerobic digestion, all the organic nitrogen is ammonium/ammonia.)

If seaweed is digested anaerobically in seawater, the resulting ammonia solution would be too salty for use as terrestrial fertilizer unless the ammonia can be concentrated without the sea salt. The suggested standard for salt in potable water is less than 500 mg/L of total dissolved solids (TDS). The City of Ventura delivers water that has 1,100 mg/L TDS. Fresh water may have total dissolved solids up to about 2,000 mg/L before it is unsuitable for most terrestrial agriculture. In contrast, ocean water is about 32,000 mg/L TDS. Water between about 1,000-10,000 mg/L TDS may be considered brackish.

Ammonium Sulfate may be used as the ammonia supply for Cloramination disinfection. In the example below, a wastewater treatment plant would install a day or two storage/blending tank, say 10,000 gallons. Having passed through a membrane, the produced material is very clean and the production process should allow for producing a consistent concentration, even if the ammonia concentration in the filtrate varies.

Ammonium Sulfate is agricultural fertilizer suitable for addition to recycled irrigation water. Some treatment plants producing recycled water for irrigation are also operating nitrogen removal processes to meet their permits for occasional discharge to a stream. Converting the filtrate to clean ammonium sulfate makes it economically feasible to store the filtrate ammonia during periods of no recycled water demand.

### Prior Art:

There are several markets for ammonia removal:
1. Wastewater treatment plants, which generally use a biologic process to convert the ammonia in filtrate into nitrate and thence to nitrogen gas. ANITA™ Mox is one such process. A treatment wetlands is another. There are also a few chemical processes, such as Ostara which recover and concentrate ammonia in struvite, but only in amounts equal to the phosphate. It is not clear if any wastewater treatment plants have employed a Liqui-Cel (or other gas membrane) to remove and concentrate ammonia.
2. Industrial processes involving ammonia. Some industries employ Liqui-Cel membranes (or other gas membranes) and concentrated sulfuric acid to remove and concentrate ammonia from their wastewater. As of this filing, is not clear if the use of sulfur burners in conjunction with gas membranes is prior art for either industry or wastewater treatment.
3. The nutrient removal process for desalting brine include the biologic processes, such as the modified Ludzak-Ettinger process and treatment wetlands. The Ostara process may be appropriate for chemical removal. The authors have not found prior art for any process which separates and concentrates the organic nitrogen from a brine so that the harvested organic nitrogen is available for terrestrial plants. The authors speculate that there is no prior art using a gas membrane to remove ammonium/ammonia from desalination brine because current world processes have nitrate (not ammonium/ammonia) in source waters.
4. In waters with excessive nutrients (lake and ocean dead zones), humans have been limited to removing the algae to a distance where the decaying organic matter does not leak back to the water body. If the water is more than about 2,000 mg/L of total dissolved solids, the algae must be washed with fresh water before it can be applied for terrestrial agriculture. If the salt-water algae is anaerobically digested in a container with salt-water, the liquefied nutrients cannot return to terrestrial agriculture.

### How Liqui-Cel Membranes Work:

Filtrate or concentrate contains ammonia in two forms: ammonium and ammonia, in equilibrium. Ammonium is an ion. Ammonia is a dissolved gas. If you remove the ammonia, more of the ammonium converts to ammonia. Higher pH favors a higher ammonia concentration. Lower pH favors a higher ammonium concentration.

The Liqui-Cel membrane is designed to allow the gas (ammonia) to pass while denying the ammonium, water, and salts. One side of the membrane is filtrate. The other side is mostly water with some sulfuric acid (H₂SO₄ the prior art) or sulfurous acid (H₂SO₃ one aspect of the invention). When the ammonia crosses the membrane, it immediately becomes ammonium in the form of either ammonium sulfate (NH₄)₂SO₄ or ammonium sulfite (NH₄)₂SO₃.

Because there is no ammonia on the “inside” of the membrane, osmotic pressure keeps ammonia moving through the membrane. FIG. 93 is a cross-section of a single membrane tube inside a container. The actual containers are often lengths of pipe perhaps a foot in diameter with a thousand membrane tubes.

Each membrane tube may be a millimeter in diameter. The membrane container has been an off-the-shelf item for years. The actual membranes continue to improve rapidly.

In FIG. 93, the brown-dot water represents the water from the anaerobic digestion process flowing around the outside of the membrane tube. It contains ammonium and ammonia in equilibrium. Typical anaerobic digestion concentrations are shown for the influent and effluent. The blue-dot/line water represents the dilute sulfurous acid flowing in the center of the membrane tube. Upward (counter-flow) of the acid may be more effective.

The following explanation from Wikipedia, Jul. 12, 2012 is a long way of saying that alkalinity will be consumed and the pH will drop as the ammonium continues converting to ammonia within the brown-dot water:
The ammonium ion is generated when ammonia, a weak base, reacts with Bronsted acids (proton donors):

H⁺+NH₃→NH₄⁺
The acid dissociation constant (pKₐ) of NH₄⁺ is 9.25. The ammonium ion is mildly acidic, reacting with Brønsted bases to return to the uncharged ammonia molecule:

NH₄⁺+B⁻→HB+NH₃
Thus, treatment of concentrated solutions of ammonium salts with strong base gives ammonia. When ammonia is dissolved in water, a tiny amount of it converts to ammonium ions:

H₃O⁺+NH₃ [symbol] H₂O+NH₄⁺
The degree to which ammonia forms the ammonium ion depends on the pH of the solution. If the pH is low, the equilibrium shifts to the right: more ammonia molecules are converted into ammonium ions. If the pH is high (the concentration of hydrogen ions is low), the equilibrium shifts to the left: the hydroxide ion abstracts a proton from the ammonium ion, generating ammonia.
Formation of ammonium compounds can also occur in the vapor phase; for example, when ammonia vapor comes in contact with hydrogen chloride vapor, a white cloud of ammonium chloride forms, which eventually settles out as a solid in a thin white layer on surfaces.
The conversion of ammonium back to ammonia is easily accomplished by the addition of strong base.

### Acid Source:

The prior art process employed by Liqui-Cel, and perhaps others, involves buying 98% concentrated sulfuric acid for about $7 per delivered and stored gallon ($1/kg of acid or $0.014/mole of acid). The concentrated acid allows for quick one-pass extraction of ammonia from the filtrate. If half the ammonia is removed from 100,000 gallons of filtrate that leaves the press at 500 mg/L-N, the annual cost of sulfuric acid would be about $120,000 and the daily production of ammonium sulfate would be about 1,000 lbs or 1,200 gallons. The daily consumption of concentrated sulfuric acid would be about 50 gallons.

One portion of the invention involves producing the sulfurous acid on site with a sulfur burner. Sulfur is relatively easy to transport and store. Sulfur burners are typically used in agriculture and by golf courses to reduce the pH of irrigation water. A sulfur burner will produce relatively dilute sulfurous acid. If half the ammonia is removed from 100,000 gallons of filtrate that leaves the press at 500 mg/L-N, the annual cost of acid would be about $40,000 (including the burner), but not including the recirculation equipment. The daily production of ammonium sulfite/sulfate might be 1,000 lbs or 6,000 gallons.

The 6,000 gpd is based on an estimated 2% ammonia as ammonium sulfite 20,000 mg/L-N. Liquid Ammonium Sulfate (LAS) is sold commercially as a 38-40% solution which is about 10% ammonia. Trials of the recirculation process are necessary to establish the limits of concentrating the ammonium sulfate. If commercial concentrations were achieved, the daily volume would be about 1,000 gallons.

A sulfur burner produces sulfurous acid relatively inexpensively. Our overall reaction from sulfur burner to ammonium sulfite is:

2NH₃+SO₂+H₂O→(NH₄)₂SO₃

Neither sulfurous acid or ammonium sulfite are stable. They will convert to sulfuric acid or ammonium sulfate over time. More equipment may be employed to speed the conversion, if the conversion is essential for the intended use. For example, at the typical concentrations employed for irrigation water, sulfite is acceptable for most soils. However, if the product is to be used as the ammonia source for treated wastewater disinfection, one would convert to sulfate in order to avoid oxygen depletion in the treated and disinfected water. One adds oxygen to water by spraying through the air, or trickling filter, or blowing air bubbles into the water.

### System Description:

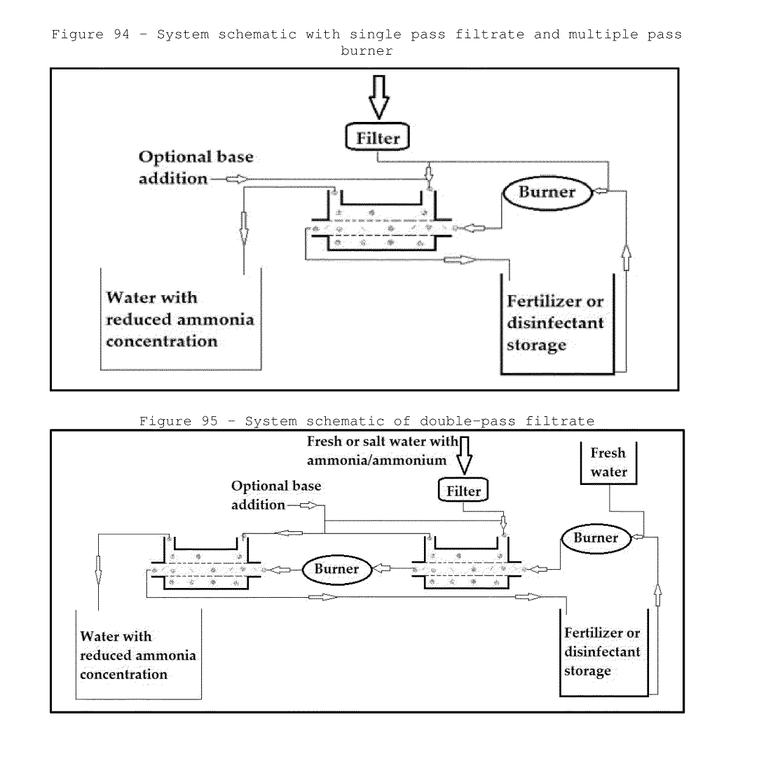

FIG. 94 shows the system circulating the fertilizer solution through the sulfur burner and the membrane unit several times in order to concentrate the ammonium fertilizer. The recirculation compensates for the limited acid concentration achieved during each pass by the sulfur burner. Dissolved oxygen may be added after each pass through the burner or at the end when the acid/fertilizer is in storage.

In the wastewater treatment application, the acid water is initially the same filtrate. When there is water with less than the maximum amount of ammonium in storage, that water is passed through the burner and the membrane to further increase the ammonium concentration (with or without freshly filtered water passing through the burner).

This recirculation arrangement allows increasing the concentration (more fertilizer or disinfectant in less volume) even though the sulfur burner produces relatively dilute acid with each pass.

In the seawater application, the storage tank would initially be a ship or barge filled with fresh water. As the fresh water is circulated through the burner and the membrane unit, it concentrates ammonium. The anaerobic digestion water with reduced ammonium would be spread to grow more seaweed forest.

FIG. 95 shows a system schematic of a similar system design using a double-pass filtrate arrangement. FIGS. 94 and 95 are simplified for clarity. For example, the pumps are not shown and the optional spray or fine bubble aeration in the storage tank are not shown. Also, the pipes could be arranged for either or both liquids to circulate through one burner and one membrane unit several times. The equipment list is as follows:
1) Pumps to move the liquids through the equipment, optional base addition, recirculation, and optional aeration.
2) A filter or clarifier removing materials which may plug the membrane. Note that water is not passing through the membrane and there is no pressure difference across the membrane. The situation means filtering is less important than it would be for a membrane bioreactor or reverse osmosis membrane.
3) The membrane bundle. For descriptive purposes the liquid with excess ammonia/ammonium is shown on the outside of the membrane tubes and the acid is on the inside.
4) It may be useful to add a base to the liquid to counteract the tendency of alkalinity depletion and lowering pH to limit the fraction of ammonium converting to ammonia.
5) An optional struvite (phosphate) removal process.
6) A sulfur burner with sulfur.
7) Fresh water for concentrating the ammonium sulfite.
8) A spray, trickling filter, or other such oxygen dissolving means for converting either sulfurous to sulfuric or sulfite to sulfate.

We have the option of including a struvite recovery process in with the ammonia recovery. Struvite (magnesium ammonium phosphate) is a phosphate mineral with formula: NH₄MgPO₄.6H₂O Phosphate is a limited resource in demand for terrestrial agriculture. Struvite sometimes plugs pipes and other solids handling equipment at wastewater treatment plants. The ideal location would be after adding base and cooling the liquid. For struvite recovery, magnesium hydroxide (Mg(OH)₂ or milk of magnesia) would be a particularly effective base, although hard to dissolve. Existing struvite recovery processes include Ostara Nutrient Recovery Technologies.

### 46. ARTIFICIAL GEOLOGIC SEAFLOOR STORAGE OF CO2

### 61/718,155, Sudia, Capron

### Background:

Humans are storing carbon dioxide (CO₂) in order to minimize the effects of a geologically sudden increase in atmospheric CO₂ concentrations caused by humans burning of fossil fuels. Technologies for storing CO₂ include:
a) Geologic Storage where the CO₂ is either a gas, a supercritical fluid, or dissolved in saline aquifers several kilometers below the surface of the earth or the seafloor;
b) Near sub-seafloor storage, proposed by House, et al. (2006) where the CO₂ is either a liquid or a hydrate perhaps 100 meters below the seafloor for a combined depth in excess of 3 kilometers;
c) Solid snow, proposed by Agee, et al. (2012) where the CO₂ is a frozen solid “landfill” in Antarctica;
d) Containers of dissolved, hydrate, or liquid CO₂ in the ocean.

FIG. 96 charts approximate densities for the materials involved. These densities vary with temperature in addition to depth. Also, the equilibrium condition for dissolved CO₂ becomes nearly constant with depths below about 500 meters.

Technology d) represents a hydrogeologic reservoir for CO₂ that has more potential storage volume than basalts, shales, and coal. Researchers have examined and most have given up on denser-than-seawater liquid CO₂ pools or hydrates. Both dissolve and disperse in the ocean. However, researchers have not examined storage in inexpensive geotextile containers made of materials similar to those used to line landfills and encapsulate hazardous waste that is the April 2011 version of Technology d). Technology d) is important because:
The world needs at least one CO₂ storage technology for CO₂ sources that are closer to deep ocean water than they are to locations for technologies a)-c).
Placing the CO₂ (in liquid or hydrate form) in impervious containers removes the major concern of deep ocean storage: that the CO₂ will dissolve back into the surrounding seawater.
The ambient conditions ensure carbon dioxide will be a liquid denser than the surrounding seawater at depths below about 3,000 meters. [1]
Where the water temperature is reliably less than 9° C. and below about 1,000 meters, ambient conditions ensure a carbon dioxide hydrate will be a solid denser than seawater.
The hydrate will occupy about 4 times the volume of pure liquid carbon dioxide. [2,3,4]
There is no question of available safe storage volume. The oceans cover 70% of Earth's surface with an average depth of 3,700 meters. All pre-2010 human-produced carbon dioxide could be safely stored as a liquid in containers covering 100 km×150 km (15,000 km2) or 0.004% of the ocean floor. The liquid carbon dioxide contained layer would be 100 meters thick. If the carbon dioxide were stored as a hydrate, the same area would be covered with hydrate “ice” filled containers in a layer 400 meters thick.
There are many possible materials and arrangements of materials to provide multiple barriers preventing either the liquid or the hydrate from escaping and dissolving into the surrounding seawater for thousands of years.
There are ambient materials (ooze and marine snow) available and dropping out of the water for secondary (or tertiary) containment.^{1 [}1]
Physics ensures that container failures cannot be catastrophic. Either liquid or hydrate will dissolve slowly creating a plume of easily detected carbon dioxide saturated seawater that is denser than the surrounding seawater.
Container failures can be easily and quickly detected. Sensors are available for detecting minute changes in adjacent seawater pH that would accompany even tiny leaks.
Technology can permit relatively easy repair or replacement, should a container leak.
Technology d) (and full-scale monitoring) can be demonstrated with small volumes. The small volume greatly reduces the cost of trials and minimizes any risks of CO₂ escaping during or after a demonstration.
Technology d) can be applied to other nations' exclusive economic zones and in international waters.
Technology d) has no effect on fresh water resources, nor any property rights and other issues associated with land-based sequestration.
Insurance agencies can set rates for long-term maintenance based on the above.

Artificial geologic layers on the ocean floor provide safe CO₂ storage with:
Ease of Monitoring—Sonar scans and sound locating beacons can be employed to constantly verify the quantity of stored CO₂ remaining in the authorized location.
Quick Leak Detection—Ocean floor storage can detect leaks exceeding 0.01% of the stored volume of CO₂ outside the authorized location within two days of the leak starting.
Quick Recovery—Ocean floor storage can include mechanical means to recover at least 99.9% of any leaked CO₂ before the leaked CO₂ pollutes the environment.
Perpetual Care—Ocean floor storage can include insurance to finance monitoring and maintenance for at least 1,000 years.

### Prior Art:

The first published discussion mentioning containers on the seafloor was limited to liquid CO₂ at depths below about 3,000 meters. [5] Their presentation discusses both an unconfined “lake” of liquid CO₂ at depths below about 3,000 meters and flexible containers of liquid CO₂ (also below 3,000 meters depth). At the time, most scientists hoped that hydrates forming on the “lake” surface would prevent dissolution of the CO₂. That is not the case. In fact, hydrates sink after forming because hydrates higher density than liquid CO₂ down to perhaps 7,000 meters depth. Even if hydrates did not sink, the hydrate will disassociate slowly when in contact with water that is not saturated with dissolved CO₂.

As best we can tell, the first discussion of geosynthetics for containing CO₂ on the seafloor was in April 2011. This was one of the proposals for DE-FOA-0000441: Small Scale Field Tests of Geologic Reservoir Classes for Geologic Storage. It suggested an on-site test of Ocean Floor Container Carbon Storage (OFCCS). The U.S. Department of Energy considered the OFCCS's proposal to test storing less than 100 kg of CO₂ hydrate in geosynthetic containers on the ocean floor below about 500 meters as “non-responsive.” The Department of Energy wanted to test storing more than 20,000,000 kg of CO₂ injected deep below the terrestrial ground surface per Technology a).

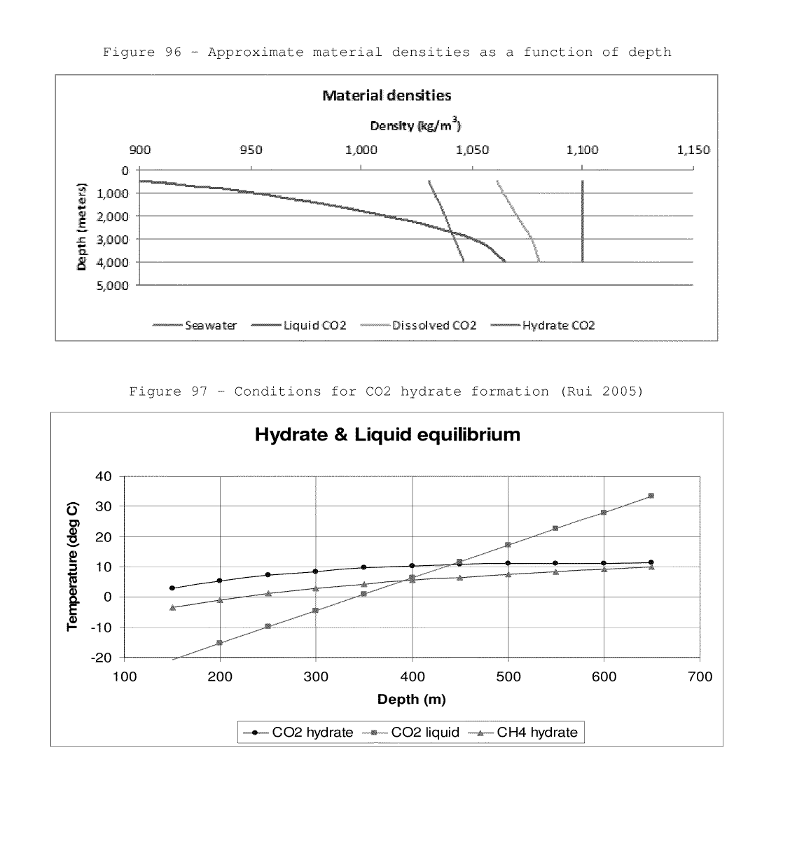

The OFCCS “target formation” is the seafloor, in any ocean location below the depth of H₂O—CO₂ hydrate formation. FIG. 97 is a graph that shows that depth can be as shallow as 500 meters deep, if the seawater at that depth and location is reliably less than about 11° C. The pressure of seawater is about 1-bar for every 10 meters of depth; therefore 50-bar is equivalent to 500 meters deep.

The dark green shading added to Rui's [2] figure indicates hydrate formation under conditions expected anywhere; the light green area only applies to areas with colder ocean temperatures, such as the West Coast and the north Atlantic Coast.

Below 500 meters is also a good minimum depth for storing dissolved CO₂, although a mole of dissolved CO₂ occupies about 17 times the volume of liquid CO₂. Per FIG. 33, above, there is relatively little change in dissolved CO₂ concentration below about 500 meters depth. This may be expected, as any additional CO₂ added into a solution below about 500 meters depth becomes (or remains) either a hydrate or a liquid.

The hydrate consists of six water molecules for each CO₂ molecule (5.75 mol CO₂ per mol H₂O). The hydrate occupies about 4 times the volume of liquid CO₂. Its density is about 1,100 kg/m³. Seawater at the target depths will be 1,030 to 1,040 kg/m3. Between 500 to 1,000 meters depth the ocean water temperature varies depending on location with warmer water in the tropics and colder water at the poles. This location-specific variation would be considered when siting hydrate storage facilities.

Although the hydrate occupies more volume than liquid CO₂, it might be less expensive to sequester permanently because it is heavier than seawater at much shallower depths. In addition, if some unforeseen event opens a hole in the manufactured containment, the hydrate remains immobile. It cannot flow out the opening. Only that small part of the hydrate structure that can dissolve into unsaturated seawater will slowly escape into the ocean. The hydrate has structural strength allowing more volume per surface area of the container than when storing a liquid.

Salts are excluded during hydrate formation. If society eventually finds a better way to store or recycle CO₂, it is possible to recover fresh water from the stored CO₂ hydrate that was made with seawater.

The IEA Report (2004) predicts the equilibrium concentration of CO₂ at the surface of pure hydrate at deep seabed temperature conditions will be about 4% wt (40,000 ppm mass fraction). This corresponds to a local pH of about 3.5. We conclude the seawater inside a hydrate-filled container may have pH as low as 3.

### Containment:

Because of the small difference in density between the contained material and seawater, tensile strength of the container appears to be less important than providing a barrier against punctures. However, differential settlement might cause some stress. There is also the possibility of adding a biological secondary barrier.

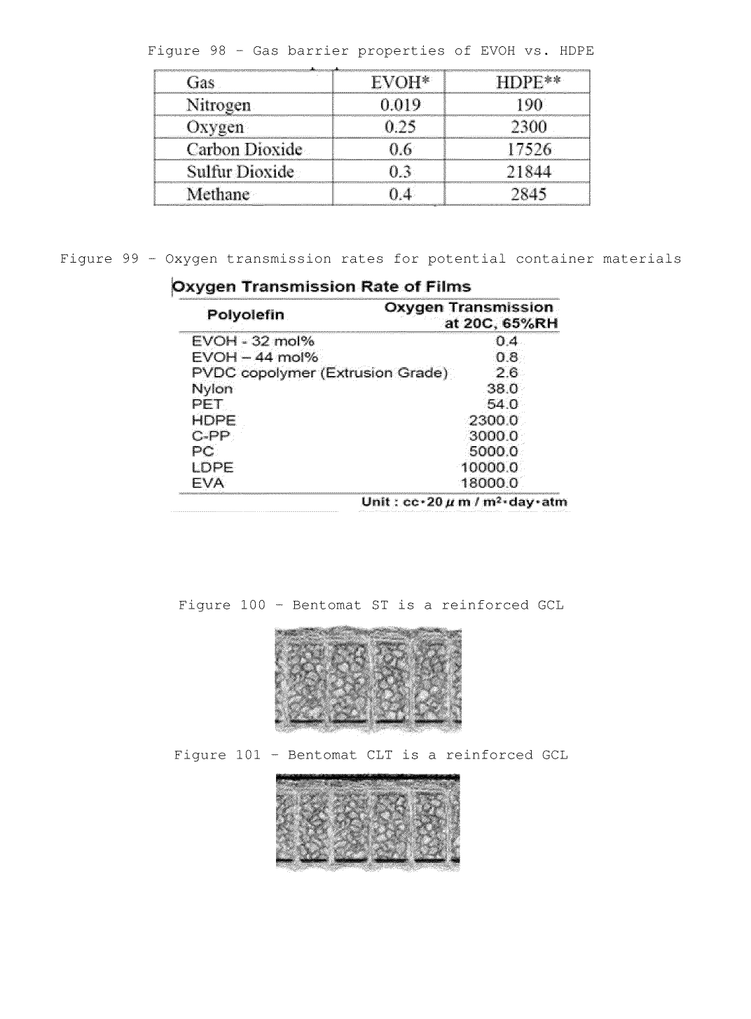

Permeability of potential container materials is important. Dr. Kerry Rowe, Queen's University, suggests considering a co-extruded geomembrane with high-density polyethylene (HDPE) or linear low-density polyethylene (LLDPE). (Rowe, 2010) Either polyethylene would be on the outside and a layer of ethylene vinyl alcohol copolymer (EVOH) on the inside. The polyethylene keeps the water and salt contained while the EVOH is vastly superior as the CO₂ barrier (see FIG. 98). Queen's University has been working with co-extruded material as a vapor barrier for benzene, toluene, ethylbenzene, and xylenes (BTEX), and it is excellent. Still other materials are available, some of which are listed in FIG. 99 (Armstrong, et al. 2009). The team will provide more tables of pertinent parameters during Task 2. Also, some materials may become much stiffer, stronger, less permeable, or more penetration-resistant when compressed with 50-bar (750 psi, 500 meters deep) pressure (even though the pressure differential across the material will be negligible).

In FIG. 98 the permeability is reported as a permeation rate in cc 20μ/m²·day·atm, which is the volumetric flow (cubic centimeters) through a defined thickness (20 μmeters) and over a unit area (m²) under a constant driving force of one atmosphere pressure over the course of 24 hours.

For the first 1-10,000 years of storage, the containing formation can be the mass-produced quality-controlled geotextile. The PODenergy team plans at least two designs for the model reservoirs. One container construction may be a 30-mil co-extruded layer of whichever material is most likely to survive both the low pH on the inside and potential sea creature attack from the outside. It will have the flexibility necessary for transportation as a folded and rolled tube and good resistance to low pH. Even if the final container were 100 meters “high,” the relative pressure differential exerting hydrostatic force or driving dissolved CO₂ out through the membrane would be small (a fraction of a bar but depending on depth, temperature, and hydrate structural properties)

Another container construction may be a multi-layer fabrication such as: 15-mil LLDPE-EVOH con-extrusion, a 4 oz. fabric, a 1-cm thick net, a 4 oz. fabric, and an outside layer of 15-mil reinforced polypropylene. The interior liner needs to resist low pH and water being drawn in by osmotic pressure or CO₂ being pushed out by the small pressure difference. Netting covered by geotextile fabric could maintain a 0.5 to 1 cm space filled with pure water. Pure water would be a biocide in this environment. If any creatures tunnel into the pure water, osmosis will expand their cells, which could seal potential leaks. The outer layer would contain only the pure water.

This storage approach does not rely solely on the manufactured reservoir. The seafloor is constantly accreting. It generally consists of ooze, the biological detritus that has fallen through the water column as marine snow. The seafloor ooze is very light, easily disturbed, and constantly accumulating. Although the ooze in certain locations may be so soft that the manufactured containers will settle into and be covered by it immediately, a hard seafloor location will be selected for this initial demonstration to ensure visibility. This research will consider the potential for full-scale containers to be partly in seawater and partly in ooze.

Other existing technologies related to artificial geologic seafloor storage include mats of sodium bentonite clay including those made by CETCO. Cross-section pictures are from the CETCO website http://www.geo-synthetics.com/geosythetic_clay_liners_cetco.html. Bentomat® ST [FIG. 100] is a reinforced GCL w/high internal shear strength for use on medium grade slopes, while Bentomat® CLT [FIG. 101] is a reinforced GCL w/a textured laminate for use on steep slopes w/high hydraulic head.

Both products are sold in 15-foot wide rolls, unrolling to 150 feet long, 2,250 square feet per roll, 15 rolls per truck load. The total thickness of each roll is between 5-30 millimeters. Bentonite clays are often used as self-healing landfill liners. If the clay-filled geosynthetic structure is punctured or cut, water contact causes the clay to swell and seal the opening thereby preventing leaks. Also, the clay-filled liner need not be field welded to create leak-tight seams. The mats need only be overlapped. Although some designs use a more open cross-section of clay as a “gasket” in the overlap area. Some designs skip the overlap and butt-weld a geomembrane.

Similar products filled with Portland cement concrete are available. The Portland cement filled rolls cure to fiber-reinforced concrete (rock) when exposed to water.

### Description of Inventions

Artificial geologic seafloor storage (AGSS) is possible with all three forms of CO₂: dissolved, hydrate, and liquid. “Layer” and “container” are often one and the same. Horizontal examples (floor or roof) can as easily be vertical examples (walls).

### Old Layer, New Application

Part of this invention is a new combination of processes and materials where the “container” may be prior art, but its use to store any of the three forms of seafloor CO₂ is new. Examples:

### EXAMPLE 1

Arranging the geosynthetics in layers of different materials. FIG. 64 is an example of the multi-layered construction of a green roof system. Note that the different layers have different functions, some to support the soil for the plants, others to prevent water leakage, while still others provide bottom protection. Artificial geologic CO₂ storage systems can have this same “layers of materials with differing properties and purposes.” Layering options include: leak-proof membranes, drainage and leak detection structures between dual leak-proof membranes, insulation structures, bio-repellant or bio-attracting netting, structural fabrics, filters, etc.

The basic materials provide strength with impervious coatings such as the fabrics and tubes manufactured by layfieldgeosynthetics.com, fabinno.com, gseworld.com, maccaferri-usa.com, prestogeo.com, typargeotextiles.com and others.

For additional protection, clay sandwich materials consisting of a thin layer of bentonite (a special type of clay) could be sandwiched between layers of sheet or fabric. Manufacturers include gseworld.com and cetco.com. (There are likely other materials besides bentonite that provide the desired self-sealing properties for liquid CO₂ that bentonite possesses when contacted by water.)

A woven or non-woven textile may be included for better puncture resistance for the bottom sheets or to armor the bottom tubes.

### EXAMPLE 2

If necessary, biocides and bio-attractants could be embedded, attached to, or dissolved in the materials. The biocide properties may be prevented from leaching into the seawater or the liquid CO₂ by non-reactive layers bonded to the biocide layer. Manufacturers of biocide geotextiles include typargeotextiles.com. Note that in the deep ocean situation, tiny salt particles or tiny “bubbles” of fresh water may be adequate biocides, as the life forms at these depths should experience discomfort when encountering higher or lower salt concentrations.

Particularly with the silicate and pH raising materials described for mineral-efficient artificial geologic formations, bio-attractants could encourage shellfish to colonize the artificial geologic layers with deep sea corals.

It may be the last place you'd expect to find corals [8], up to 6,000 m (20,000 ft) below the ocean's surface, where the water is icy cold and the light dim or absent. Yet believe it or not, lush coral gardens thrive here. In fact, scientists have discovered nearly as many species of deep-sea corals (also known as cold-water corals) as shallow-water species.

Like shallow-water corals, deep-sea corals may exist as individual coral polyps, as diversely shaped colonies containing many polyps of the same species, and as reefs with many colonies made up of one or more species.

Unlike shallow-water corals, however, deep-sea corals don't need sunlight. They obtain the energy and nutrients they need to survive by trapping tiny organisms in passing currents. When it comes to size, the range among deep-sea corals is tremendous. Scientists have discovered single polyps as small as a grain of rice, tree-like coral colonies that tower as tall as 10 m (35 ft), and massive coral reefs that stretch for 40 km (25 ml). But the ocean is a vast realm. There may be even bigger deep-sea corals out there still to be discovered.

### EXAMPLE 3

By embedding particles in the materials, they can be made in a range of densities. For example, the bottom sheet to protect the CO₂ containers from rocks could be less dense than the ooze, so it could “float” on ooze, but be denser than seawater or liquid CO₂ so it would remain flat as the CO₂ containers are put in place. The top protective sheet could be less dense than liquid CO₂ but be denser than seawater so it would remain in place. Note that the deep ocean pressure will increase the density of the materials, relative to their density at the ocean surface. This might be used to good effect by arranging a material with bubbles that collapse with depth. If the gas in the bubbles is predominantly CO₂, the resulting liquid CO₂ may be an adequate biocide when encountered by sea creatures attempting to bore through the material.

### EXAMPLE 4

In addition to carefully engineering the materials, the containers can be arranged to reduce the chance of leaks. For example, FIG. 65 shows a vertical cross-section of a potential multi-cell arrangement of an enclosure for containers that would be filled over time. In this case the arrangement consists of a bottom layer of appropriate density sheets. (The sheets may be geosynthetics or composites with minerals in the Bentomat® mat style. Hollow glass microspheres may be necessary for the mineral mat to be intermediate between the density of the ooze and liquid CO₂.) On top of this would be a layer of tubes containing liquid CO₂. When that layer is full, a protective sheet could be put in place, then a layer of tubes of liquid CO₂, followed by another layer of sheets, another layer of liquid.

In FIG. 65, intermediate and high density seawater refers to seawater with added salt. The intermediate density would be just sufficient extra salt for the tube to “float” on the CO₂ (whatever form) but “sink” in ambient seawater at ambient temperature. High density seawater may be replaced with pumped-in fiber reinforced cement concrete at any time during or after construction for a more “geologic” formation. (The structure of FIG. 65 could be hundreds of meters high and a kilometer or more in diameter.)

### EXAMPLE 5

Build “artificial rock” structures. That is overlapping arches and domes with multiple cut-off walls so that most of the overall structure could survive a direct hit by a large sinking ship or dragging anchor. Each layer can be a collection of parallel arch-section tubes. Successive layers of tubes run at 45° to 90° (viewed from above) angles to the layer below them.

If the tube walls are relatively thin geosynthetic constructions, each layer of arches would be filled and topped with a “geologic” material (Portland cement concrete, sand, gravel, reinforcing fibers or end-cushioned steel rods, ground silicate minerals, Class C fly ash, ooze, etc.) The same filling and topping material may be necessary to make a level and firm foundation.

If the tube walls are geologic in themselves, the foundation may be necessary, but we could fill the space between the self-supporting arches with stored CO₂. A “geologic” tube wall could be made employing the Bentomat® mat style but filled with Portland cement or silicate minerals. That is, the tubes are unrolled, inflated, and the tube walls harden into a rock similar to the hardened (but epoxy carbon fiber) tubes in an inflatable bridge http://www2.umaine.edu/aewc/images/stories/web_uploads/pop_sci.pdf.

### Mineral-Efficient Artificial Geologic Formations:

Silicate minerals (olivine or serpentine) react with CO₂ to form carbonates (limestones and dolomites). Both minerals are abundant. The reaction is extremely slow (millennia for gravel size particles) but can be sped-up by grinding the minerals into a fine powder. Grinding requires energy. (Sea life can supply grinding energy.) If the energy to grind the minerals into a fine powder is supplied by fossil fuels, the carbon debt limits the net CO₂ absorption.

The following discussion of employing silicates to absorb CO₂ is from “Carbon Dioxide Sequestration by Aqueous Mineral Carbonation of Magnesium Silicate Minerals” [9]

Aqueous mineral carbonation reactions take advantage of the natural alteration of ultramafic rocks called serpentinization. When formation waters contact ultramafic rocks, usually at high pressure and moderate temperatures, alteration to the hydrated magnesium silicate, serpentine, occurs (eq. 1). When these waters contain dissolved CO₂, magnesite may form as a secondary alteration mineral.

2Mg₂SiO₄+CO₂(g)+2H₂O→Mg₃Si₂O₅(OH)₄+MgCO₃16.5 Kcal (1)

By increasing the CO₂ activity it is possible to form magnesite and no serpentine (eq 2).

Mg₂SiO₄+2CO₂(g)→2MgCO₃+SiO₂10.3 Kcal (2)

It is also possible to form calcite by a similar reaction (eq. 3).

CaSiO₃+CO₂(g)→CaCO₃+SiO₂10.6 Kcal (3)

Several important conclusions can be drawn from these equations. All of the reactants and products of equation 1 (olivine, serpentine & magnesite) can be found in significant quantities in nature and thus under the proper conditions are stable for geologic periods of time. However, both magnesite and serpentine are at a lower thermodynamic state than olivine. Over geologic time most olivine is eventually converted into serpentine and magnesite, and thus serpentine is more prevalent than olivine. Once magnesite has formed, CO₂ can be stored indefinitely. This is an important point because, given the very large amount of CO₂ that will have to be stored, even a small re-release of CO₂ (leak rate) will quickly equal the release from burning fossil fuels. Finally these are geologic reactions and have geologic reaction rates. The challenge is to speed the reaction rate up many orders of magnitude to the point where it can take place in a traditional chemical plant and to do this at minimal capital and energy expense.

Reaction rates can be accelerated by decreasing the particle size, raising the reaction temperature, increasing the pressure, changing the solution chemistry, and using a catalyst.

The most common forms of carbonate are calcite or calcium carbonate, CaCO₃, the chief constituent of limestone (as well as the main component of mollusk shells and coral skeletons); dolomite, a calcium-magnesium carbonate CaMg(CO₃)₂; and siderite, or iron(II) carbonate, FeCO₃, an important iron ore. (Wikipedia, September 2012)

This invention replaces (or adds to) the bentonite or Portland cement in a construction such as Bentomat® with a silicate mineral. This is initially a flexible blanket of silicates. Dissolved CO₂ contacting the silicate minerals will slowly convert to solid carbonates. This process may be assisted by shell-forming sea life.

There are several ways to arrange the silicate minerals: a) As a very fine powder encased in geomembrane such that the silicate minerals are not exposed to water unless the geomembrane is punctured. Only after puncture, do the minerals react with CO₂ in the water. That reaction continues CO₂ storage, and may seal the puncture with the new minerals. b) As a powder or granules in a geosynthetic weave this becomes a solid layer of carbonate under, beside, or over the geomembrane-contained CO2.

Mineral-efficient artificial geologic formations use a tiny amount of minerals to permanently store large volumes of CO₂, instead of employing about the same amount of minerals as CO₂. The minerals preparation (grinding, catalysts coatings, etc.) is much less expensive per unit of CO₂ stored. The U.S. Department of Energy was hoping for a reaction time less than a hundred hours. We do not have the higher temperatures, but we do have higher pressures and can afford reaction times less than a few centuries.

### Mineral Conversion

CO₂ hydrates form with H₂O, and tend to exclude the dissolved minerals in seawater. After making hydrate in a container, there will be a remainder of water and minerals in higher concentrations than that of seawater. The situation is not unlike reverse osmosis or the processes in salt water fish intestines.

Wilson et al. [10] explain that all bony saltwater fish concentrate carbonates and other ions in their intestines while passing less-salty water into their bodies. The resulting carbonate precipitates are generally formed with calcium and magnesium. The calcium carbonate is produced in the chemical reaction:

Ca²⁺+2HCO₃⁻→CaCO₃+CO₂+H₂O

With the exception of the dissolved CO₂ at equilibrium, mineral concentration similar to that in fish intestines happens as CO₂ hydrate forms. But the equilibrium dissolved CO₂ creates an acidic environment preventing carbonate formation.

We might add a base (magnesium hydroxide, calcium hydroxide, sodium hydroxide, lime, etc.) in the same container with the hydrate, but that may be counter-productive to hydrate formation. If the base is counter-productive, then we pump the non-hydrate brine into a second container. Sucking the brine from the hydrate should make the hydrate more structurally sound (S and Isle effect [11]). Then add the base into the second container. Many minerals will precipitate out, including many carbonates in this second container.

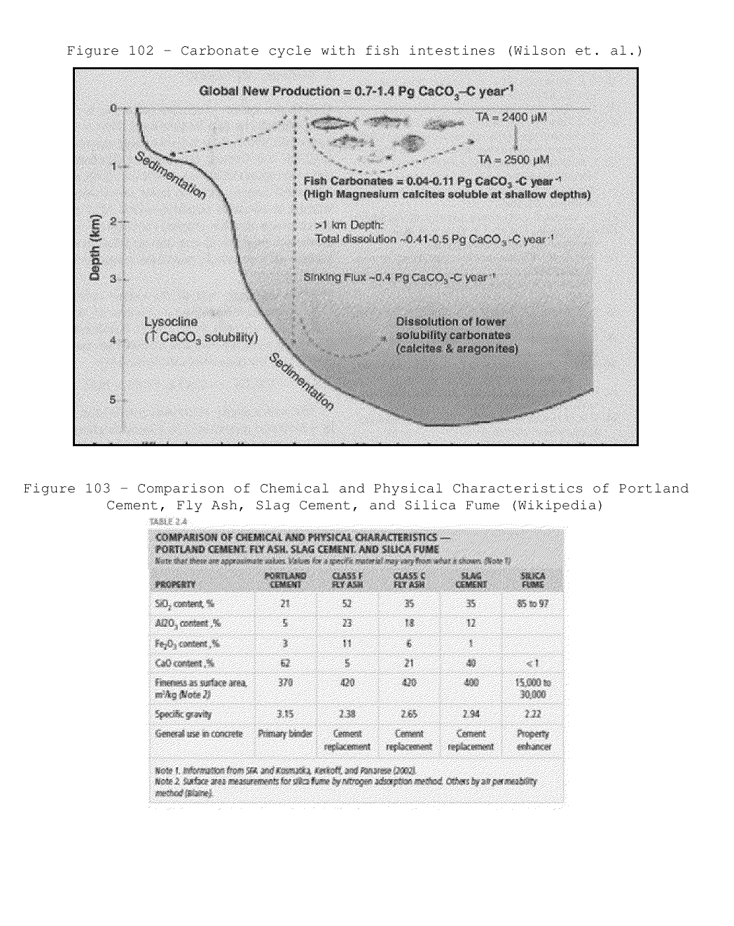

Per FIG. 102, most of the precipitated minerals will be stable should they ever be exposed to seawater at depths above about 1,000 meters. At depths below 1,000 meters, high magnesium calcites dissolve in seawater while others are stable to near 4,000 meters depth.

Mineral conversion is more cost-effective CO₂ storage. We have used relatively little chemical base to store CO₂ in two forms: a) geologically stable and structurally sound hydrate and b) precipitated minerals.

### Mineral Recovery:

When CO₂ hydrates form the remnant is concentrated brine, not unlike reverse osmosis. Seawater is typically 2% Cl, 1% Na, 0.1% Mg, 0.09% S, 0.04% Ca, 0.04% K, 0.007% Br, and every other known element in very small concentrations. The deeper (higher pressure) and the colder the hydrate formation occurs, the more concentrated the non-hydrating brine and the equilibrium dissolved CO₂ concentration.

The following explanation of a mineral recovery process is from “Zero Discharge Seawater Desalination: Integrating the Production of Freshwater, Salt, Magnesium, and Bromine” [12].

The pretreated seawater passes through the RO (reverse osmosis membrane) where about half of the water is removed as permeate.

The reject stream from the RO, having about twice the ionic concentrations of seawater, is fed to the ED (electrodialysis) stack, which produces a concentrate stream with about 20% dissolved salts (primarily NaCl) and a diluate stream with about the same salinity as seawater. The ED can be fine-tuned to produce a diluate with the same density as seawater so that the diluate can be returned to the sea without provisions for mixing. (For a true zero discharge process, a portion of the ED diluate would be processed for magnesium (Mg) recovery and then evaporated to dryness, and the remainder would be recycled to the RO feed.)

The ED stack contains special ion-exchange membranes that are selective to the transport of monovalent ions, in contrast to conventional membrane that selectively transport divalent ions. The predominant monovalent ions and their relative transport through the special membranes are Na⁺: 1, K⁺: 0.8, Cl⁻: 1, Br: 3.8 and HCO₃⁻: 0.5. The predominant divalent ions and their relative transport through the special membranes are Mg⁺⁺: 0.05, Ca⁺⁺: 0.11, and SO₄=: 0.03.

Because of the strong rejection of divalent ions, the 20+ percent (%) brine produced by ED has considerably higher NaCl purity than brine produced by RO. Evaporation of the ED brine precipitates high-purity NaCl that can be processed and sold for commercial use. The potential value of the NaCl suggests that this portion of the ZDD process should be designed to maximize the quality and quantity of the NaCl product.

Most of the bromide from the seawater is concentrated in the ED brine and can subsequently be recovered from the bittern that remains after the NaCl is precipitated. The reasons for this movement of bromide are as follows:
1. Bromide ions are rejected by RO membranes.
2. The RO reject is treated by ED where the Br— (along with NaCl) becomes further concentrated. The anion-exchange membranes used in ED for salt recovery have Br/Cl selectivity of about 4/1; this will be discussed further later.
3. Bromide salts (NaBr) are substantially more soluble than chloride salts (NaBr is three times more soluble than NaCl). Therefore, sequential evaporation of the ED brine precipitates the NaCl first and leaves a bittern with highly concentrated Br— ions that have the potential to be converted to Br₂ and recovered for sale.

A less capital-intensive approach would be to recover crude bromide salts from the bittern and sell them as a raw material to a chemical company (e.g., Albemarle or Great Lakes Chemicals) that processes bromine.

Many other processes exist for removing minerals from concentrated seawater. Like in the mineral conversion process, we are most likely to pump the brine into a second container. Then we have the option of sending the brine to a chemical company per the Bureau of Reclamation study, or processing it on the seafloor. Seafloor processing has higher pressures available without energy cost. (The higher-than-seawater density of the brine means energy could recovered as it drops from a typical hydrate storage depth of 800 meters to 4,000 meters depth (400 atm pressure). In contrast, the Department of Energy study was conducted at 120 atm.

### Waste Recycled to Artificial Geologic Layers

Industry produces minerals as waste products such as coal ash. The waste products are not in sufficient quantities to make much of a dent in CO₂ emissions when reacted directly with CO₂. However, they might be economically employed as artificial geologic layers. For example, coal ash includes minerals which can be converted into artificial geologic seafloor CO₂ storage layers. See below two tables of fly ash chemical and physical characteristics.

Both FIG. 103 and the following discussion of various types of fly ash are taken from Wikipedia, September 2012:
Depending upon the source and makeup of the coal being burned, the components of fly ash vary considerably, but all fly ash includes substantial amounts of silicon dioxide (SiO2) (both amorphous and crystalline) and calcium oxide (CaO), both being endemic ingredients in many coal-bearing rock strata.

| Fly Ash | | Sub- | |
|---|---|---|---|
| Component | Bituminous | bituminous | Lignite |
| SiO2 (%) | 20-60 | 40-60 | 15-45 |
| Al2O3 (%) | 5-35 | 20-30 | 20-25 |
| Fe2O3 (%) | 10-40 | 4-10 | 4-15 |
| CaO (%) | 1-12 | 5-30 | 15-40 |
| LOI (%) | 0-15 | 0-3 | 0-5 |

Toxic constituents depend upon the specific coal bed makeup, but may include one or more of the following elements or substances in quantities from trace amounts to several percent: arsenic, beryllium, boron, cadmium, chromium, chromium VI, cobalt, lead, manganese, mercury, molybdenum, selenium, strontium, thallium, and vanadium, along with dioxins and PAH compounds.
Fly ash material solidifies while suspended in the exhaust gases and is collected by electrostatic precipitators or filter bags. Since the particles solidify rapidly while suspended in the exhaust gases, fly ash particles are generally spherical in shape and range in size from 0.5 μm to 300 μm. The major consequence of the rapid cooling is that only few minerals will have time to crystallize and that mainly amorphous, quenched glass remains. Nevertheless, some refractory phases in the pulverized coal will not melt (entirely) and remain crystalline. In consequence, fly ash is a heterogeneous material. SiO2, Al2O3, Fe2O3 and occasionally CaO are the main chemical components present in fly ashes. The mineralogy of fly ashes is very diverse. The main phases encountered are a glass phase, together with quartz, mullite and the iron oxides hematite, magnetite and/or maghemite. Other phases often identified are cristobalite, anhydrite, free lime, periclase, calcite, sylvite, halite, portlandite, rutile and anatase. The Ca-bearing minerals anorthite, gehlenite, akermanite and various calcium silicates and calcium aluminates identical to those found in Portland cement can be identified in Ca-rich fly ashes.
The above concentrations of trace elements vary according to the kind of coal combusted to form it. In fact, in the case of bituminous coal, with the notable exception of boron, trace element concentrations are generally similar to trace element concentrations in unpolluted soils.
Two classes of fly ash are defined by ASTM C618: Class F fly ash and Class C fly ash. The chief difference between these classes is the amount of calcium, silica, alumina, and iron content in the ash. The chemical properties of the fly ash are largely influenced by the chemical content of the coal burned (i.e., anthracite, bituminous, and lignite).

Class F Fly Ash:
The burning of harder, older anthracite and bituminous coal typically produces Class F fly ash. This fly ash is pozzolanic in nature, and contains less than 20% lime (CaO). Possessing pozzolanic properties, the glassy silica and alumina of Class F fly ash requires a cementing agent, such as Portland cement, quicklime, or hydrated lime, with the presence of water in order to react and produce cementitious compounds. Alternatively, the addition of a chemical activator such as sodium silicate (water glass) to a Class F ash can lead to the formation of a geopolymer.

Class C Fly Ash:
Fly ash produced from the burning of younger lignite or subbituminous coal, in addition to having pozzolanic properties, also has some self-cementing properties. In the presence of water, Class C fly ash will harden and gain strength over time. Class C fly ash generally contains more than 20% lime (CaO). Unlike Class F, self-cementing Class C fly ash does not require an activator. Alkali and sulfate (SO₄) contents are generally higher in Class C fly ashes.
At least one US manufacturer has announced a fly ash brick containing up to 50% Class C fly ash. Testing shows the bricks meet or exceed the performance standards listed in ASTM C 216 for conventional clay brick; it is also within the allowable shrinkage limits for concrete brick in ASTM C 55, Standard Specification for Concrete Building Brick. It is estimated that the production method used in fly ash bricks will reduce the embodied energy of masonry construction by up to 90%. Bricks and pavers were expected to be available in commercial quantities before the end of 2009.

The CaO (lime) is a base and Class C fly ash is self-cementing. One could hydraulically fill any of the “high-density seawater” filled AquaDam components of FIG. 3 with a mixture of Class C fly ash and other materials (Portland cement, additional lime, silicate minerals, fiber reinforcing, etc.) Or use the above mixture as the fill for a Bentomat® style layer.

### REFERENCES AND NOTES

1. House K. Z., Schrag D. P., Harvey C. F., and Lackner K. S., Permanent carbon dioxide storage in deep-sea sediments, PNAS, Aug. 15, 2006, vol. 103, no. 33, p. 12291-12295.
2. Rui S, Zhenhao D, Prediction of CH4 and CO2 hydrate phase equilibrium and cage occupancy from ad initio intermolecular potentials, Geochimica et Cosmochimica Acta, Vol. 69, No. 18, pp. 4411-4424, 2005, Elsevier Ltd.
3. Makio Honda, Jun Hashimoto, Jiro Naka, and Hiroshi Hotta, “CO2 Hydrate Formation and Inversion of Density between Liquid CO2 and H2O in Deep Sea: Experimental Study Using Submersible “Shinkai 6500”, Direct Ocean Disposal of Carbon Dioxide, edited by N. Handa and T. Ohsumi, pp. 35-43, Terra Scientific Publishing Company (TERRAPUB), Tokyo, 1995
4. Eric Wannamaker, “Modeling Carbon Dioxide Hydrate Particle Releases in the Deep Ocean”, Massachusetts Institute of Technology, June 2002 (dspace.mit.edu/bitstream/handle/1721.1/16814/50617268.pdf).
5. Palmer, A., Keith, D., and Doctor, R. Ocean Storage of Carbon Dioxide: Pipelines, Risers, and Seabed Containment, OMAE 2007-29528 (a conference in June 2007)
6. From ASTM D1434 measurements: 32 mol % EVOH, by Armstrong, R., and Chow, E. (2009)
7. From Massey, L. K. (2003)

8. Ocean Portal, Smithsonian National Museum of Natural History, ocean.si.edu/ocean-news/corals-cold-water/coral-gardens-deep-sea
9. S. J. Gerdemann, D. C. Dahlin, W. K. O'Connor & L. R. Penner, Albany Research Center, Office of Fossil Energy, US DOE
10. R. W. Wilson, F. J. Millero, J. R. Taylor, P. J. Walsh, V. Christensen, S. Jennings, M. Grosell in “Contribution of Fish to the Marine Inorganic Carbon Cycle,” Science, Volume 323, Jan. 16, 2009
11. Hydrostatic sand structures are described by Dowse, “New Developments in the Use of Sand for Construction of Deep Water Offshore Structures,” Oceanology International 1975. They work because the active earth pressure of dry sand inside an impermeable membrane is less than the confining hydrostatic pressure. A vertical sided SANDISLE column has a bearing capacity equal to 3.4 times the hydrostatic pressure. This assumes a wet sand density of 1800 kg/m3 (110 lbs/cuft) and an angle of internal friction of 33°.
12. Desalination and Water Purification Research and Development Program Report No. 111, University of South Carolina Research Foundation, U.S. Department of the Interior, Bureau of Reclamation, May 2006.

We claim:

1. An apparatus for restraining the uplift force of an underwater gas pipeline, such apparatus comprising an inverted bridge structure. [Figure 52]

2. An apparatus as in claim 1 wherein said inverted bridge structure is an inverted catenary suspension bridge.

3. An apparatus as in claim 1 wherein said inverted bridge structure is an inverted cable stay suspension bridge.
